(19) United States
(12) Patent Application Publication
(10) Pub. No.: US 2026/0177941 A1
(43) Pub. Date: Jun. 25, 2026

(54) IMAGE FORMING APPARATUS AND DEVELOPING DEVICE

(71) Applicant: CANON KABUSHIKI KAISHA, Tokyo (JP)

(72) Inventors: SHUNSUKE MIZUKOSHI, Tokyo (JP); ISAMU TAKEDA, Tokyo (JP); TOMOO AKIZUKI, Kanagawa (JP)

(21) Appl. No.: 19/425,450

(22) Filed: Dec. 18, 2025

(30) Foreign Application Priority Data
Dec. 19, 2024 (JP) 2024-224599

(51) Int. Cl. G03G 15/01; G03G 15/00

(52) U.S. Cl. CPC G03G 15/0173; G03G 15/50

(57) ABSTRACT

An image forming apparatus includes a rotatable image bearing member, a developing device including a developing container and a rotatable developer carrying member, a supplying mechanism including a supplying member, driving portion, and a controller. The supplying member is changeable in state between a first state and a second state in which at least a part of the supplying member closer to the surface of the developer carrying member than in the first state, and urges toner, accommodated in the developing container, toward the surface of the image bearing member by being changed from the first state to the second state.

### BACKGROUND

### Field of the Technology

The present disclosure relates to an image forming apparatus, such as a printer, a copying machine, a facsimile machine, or a multi-function machine having a plurality of functions of functions of these machines, using an electrophotographic type or an electrostatic recording type, and relates to a developing device used in this image forming apparatus.

### Description of the Related Art

The image forming apparatus using the electrophotographic type or the electrostatic recording type forms an electrostatic latent image on an image bearing member such as a photosensitive drum, and develops the electrostatic latent image by supplying toner to the electrostatic latent image by the developing device, thus forming a toner image on the image bearing member.

As the developing device, for example, a developing device using a non-magnetic one-component developer as a developer is known (Japanese Laid-Open Patent Application No. Hei6-301281). This developing includes a developing roller (developer carrying member) for conveying the toner toward the image bearing member while carrying the toner, a supplying roller for supplying the toner, and a regulating member for regulating an amount of the toner conveyed toward the image bearing member while being carried on the developing roller. As the supplying roller, a sponge roller provided with a porous sponge layer at a periphery of a core metal (metal core) is widely used.

The toner accommodated in the developing device is changed in characteristic such as chargeability and flowability by repetitively using the developing device.

As a factor of such a change in character of the toner, it is possible to cite that the toner receives a load such as frictional sliding in a contact portion between the developing roller and the supplying roller, or in the like portion.

In order to alleviate the change in characteristic of the toner as described above and to downsize the image forming apparatus, it would be considered that the developing device is not provided with the supplying roller.

However, it is difficult to stably supply the toner to a surface of the developing roller without providing the supplying roller to the developing device. For example, in a constitution in which the supplying roller is simply removed from the developing device, depending on an image to be formed, density non-uniformity or a white void occurs during development of an electrostatic latent image into an image for one page in some cases.

### SUMMARY

Accordingly, the present disclosure is directed to enable that toner is stably supplied to a surface of a developer carrying member without providing a supplying roller to a developing device.

This is achieved by an image forming apparatus and a developing device according to the present disclosure.

According to an aspect of the present disclosure, there is provided an image forming apparatus comprising: a rotatable image bearing member configured to bear a toner image; a developing device configured to form the toner image on a surface of the image bearing member, the developing device including a developing container for accommodating toner and including a rotatable developer carrying member which forms a developing portion in contact with the surface of the image bearing member and which is for conveying the toner, accommodated in the developing container, toward the image bearing member while carrying the toner; a supplying mechanism including a supplying member which is changeable in state between a first state and a second state in which at least a part of the supplying member is closer to the surface of the developer carrying member than in the first state and which urges the toner, accommodated in the developing container, toward the surface of the developer carrying member by being changed from the first state to the second state; a driving portion capable of operating the supplying mechanism so as to change the state of the supplying member to the first state and the second state; and a controller configured to control the driving portion, wherein a timing when a leading end of an image forming region, in which a toner image for one page is formable, on the image bearing member with respect to a rotational direction of the image bearing member reaches the developing portion is defined as a first timing, a timing having a predetermined relationship with a timing when a trailing end of the image forming region with respect to the rotational direction of the image bearing member finishes passing through the developing portion is defined as a second timing, and a period between the first timing and the second timing is defined as a predetermined period, and wherein the controller controls the driving portion so that an operation of the supplying mechanism for changing the state of the supplying member in a direction from the first state toward the second state in at least a part of a period of the predetermined period is performed, and so that the operation of the supplying mechanism for changing the state of the supplying member in a direction from the second state toward the first state in the predetermined period is not performed.

According to another aspect of the present disclosure, there is provided a developing device comprising: a developing container configured to accommodate toner; a rotatable developer carrying member configured to carry the toner accommodated in the developing container; a flexible sheet which is provided so that a first direction thereof extends along a rotational axis direction of the developer carrying member and which is held in a first portion thereof on one end portion side thereof and a second portion thereof on the other end portion side thereof with respect to a second direction crossing the first direction; and a holding member configured to hold the second portion of the sheet and rotatable about a rotational axis along the first direction, wherein the sheet is changeable in state between a first state and a second state in which at least a part thereof is closer to the surface of the developer carrying member than in the first state by rotation of the holding member, and wherein the sheet urges the toner, accommodated in the developing container, toward the surface of the developer carrying member by being changed in state from the first state to the second state.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic sectional view of an image forming apparatus.

Parts (a) to (d) of FIG. 2 are schematic sectional views for illustrating an operation of a developing rotary.

Parts (a) and (b) of FIG. 3 are schematic sectional views for illustrating an exchanging method of a toner cartridge.

FIG. 4 is a schematic block diagram for illustrating a control constitution of the image forming apparatus.

FIG. 5 is a schematic sectional view of a developing unit.

FIG. 6 is a schematic perspective view showing a part of the developing unit.

FIG. 7 is a schematic perspective view of a supplying mechanism.

Parts (a) and (b) of FIG. 8 are schematic sectional views of a driving constitution of the supplying mechanism.

Parts (a) to (c) of FIG. 9A are schematic sectional views for illustrating a stirring operation of toner.

Parts (d) to (f) of FIG. 9B are schematic sectional views for illustrating the stirring operation of the toner.

Parts (g) to (i) of FIG. 9C are schematic sectional views for illustrating the stirring operation of the toner.

FIG. 10 is a schematic sectional view of the developing unit.

FIG. 11 is a schematic view for illustrating circulation of the toner in the developing unit.

FIG. 12 is a schematic sectional view of a developing unit in a comparison example.

FIG. 13 is a schematic view for illustrating circulation of toner in the developing unit in the comparison example.

FIG. 14 is a schematic sectional view of a developing unit in the comparison example.

FIG. 15 is a schematic sectional view of a developing unit in the comparison example.

FIG. 16 is a schematic sectional view of a developing unit in the comparison example.

FIG. 17 is a schematic sectional view of the developing unit for illustrating an operation of the supplying mechanism.

Parts (a) to (c) of FIG. 18 are timing charts for illustrating an operation of a supplying mechanism in the comparison example and an embodiment, in the comparison example, and in the embodiment, respectively.

Parts (a) and (b) of FIG. 19 are timing charts each for illustrating an operation of the supplying mechanism in the comparison example.

Parts (a) to (d) of FIG. 20 are timing charts each for illustrating another example of control of the supplying mechanism in the embodiment.

FIG. 21 is a schematic sectional view of another example of the developing unit in an embodiment.

Parts (a) to (c) of FIG. 22 are schematic perspective views each of another example of a holding shaft in the embodiment.

FIG. 23 is a schematic exploded perspective view of a holding shaft and a rotation assisting member.

Parts (a) to (c) of FIG. 24 are schematic exploded perspective view of a holding shaft and a rotation assisting member, a sectional view of the rotation assisting member, and a graph showing a cam profile of the rotation assisting member, respectively.

FIG. 25 is a schematic sectional view of another example of a developing unit in an embodiment.

FIG. 26 is a schematic exploded perspective view of a holding shaft and an urging shaft.

Parts (a) and (b) of FIG. 27 are schematic exploded perspective views of the holding shaft and a slide assisting member, and of the slide assisting member, respectively.

FIG. 28 is a schematic sectional view of another example of the developing unit.

FIG. 29 is a schematic sectional view of another example of the developing unit.

FIG. 30 is a schematic sectional view of another example of the developing unit.

FIG. 31 is a schematic sectional view of another example of the developing unit.

FIG. 32 is a schematic sectional view of another example of the image forming apparatus.

FIG. 33 is a schematic sectional view of another example of the developing unit.

Parts (a) and (b) of FIG. 34 are schematic sectional views of another example of the developing unit.

FIG. 35 is a schematic sectional view of another example of the developing unit.

Parts (a) and (b) of FIG. 36 are schematic sectional views of another example of the developing unit.

FIG. 37 is a schematic sectional view of another example of the developing unit.

Parts (a) and (b) of FIG. 38 are schematic sectional views each of another example of the developing unit.

FIG. 39 is a schematic perspective view of an example of a supply plate.

FIG. 40 is a schematic sectional view of another example of the image forming apparatus.

FIG. 41 is a schematic sectional view of another example of the developing unit.

### DESCRIPTION OF THE EMBODIMENTS

In the following, embodiments of an image forming apparatus and a developing device according to the present invention will be described specifically with reference to the drawings. Incidentally, dimensions, materials, shapes, a relative arrangement, and the like of constituent parts described in the following embodiments can be appropriately changed depending on constitutions and various conditions of apparatuses (devices) to which the present disclosure is applied, and a scope of the present disclosure is not limited to the following embodiments. In addition, in the following embodiments, as regards elements having the same or corresponding functions or constitutions, the same reference numerals or symbols are added thereto, and redundant description thereof will be appropriately omitted.

### Embodiment 1

### General Constitution of Image Forming Apparatus

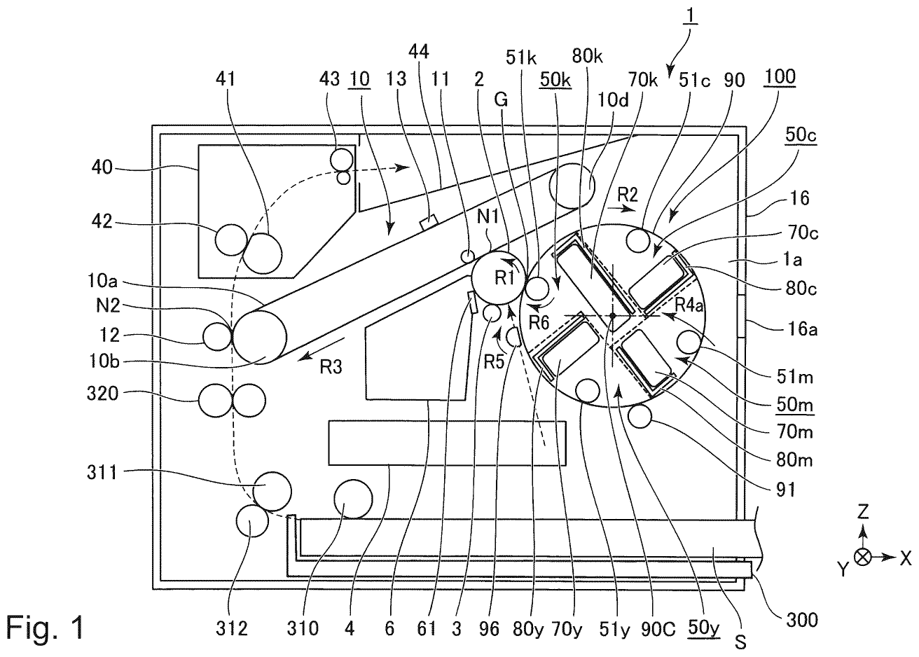

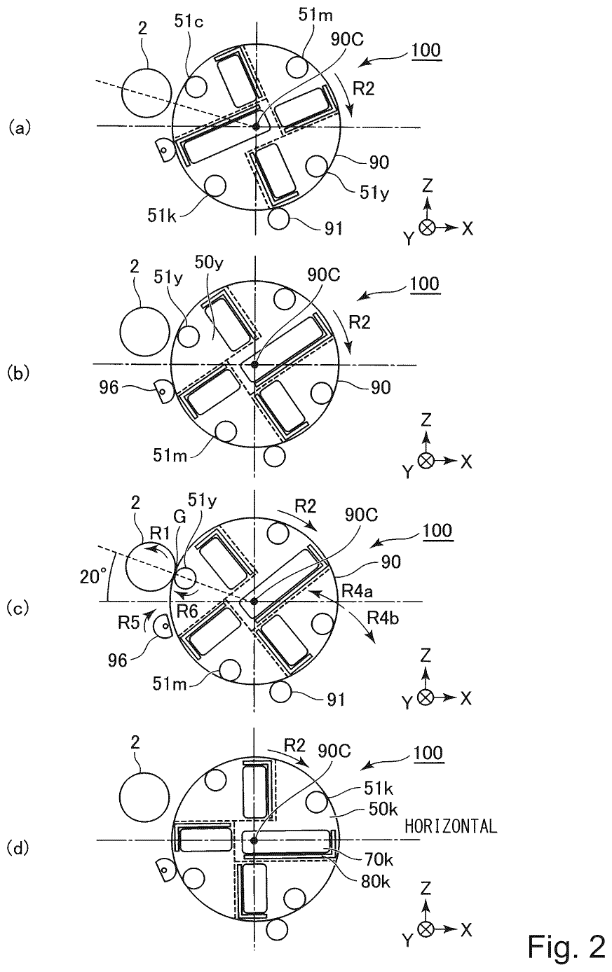

First, using FIG. 1, a general constitution of an image forming apparatus 1 of an embodiment 1 will be described. FIG. 1 is a schematic sectional view of the image forming apparatus 1 of this embodiment. The image forming apparatus 1 of this embodiment is a color laser printer of a rotary development type in which a full-color image is capable of being formed on a sheet S as a recording material by using an electrophotographic type.

Here, for example, as shown in FIG. 1, a direction substantially parallel to a vertical direction (gravitational direction) in the case where the image forming apparatus 1 is installed on a horizontal surface is defined as a “Z axis direction”. Further, a direction perpendicular to the Z axis direction and substantially parallel to a rotational axis direction (direction of a rotational axis 90C of a rotary main body 90 described later) of a photosensitive drum 2 described later is defined as a “Y axis direction”. Further, a direction perpendicular to both the Z axis direction and the Y axis direction is defined as an X axis direction. In addition, as described, directions of arrows X, Y, and Z in the drawings are defined as positive directions of an X axis, a Y axis, a Z axis, respectively. The positive direction of the X axis is a direction from a left side toward a right side in FIG. 1, the positive direction of the Y axis is a direction from a front side toward a back side of the drawing sheet (paper) of FIG. 1, and the positive direction of the Z axis is a direction from a lower side toward an upper side in FIG. 1. In addition, opposite directions to the positive directions of the X axis the Y axis, and the Z axis are defined as negative directions of the X axis, the Y axis, and the Z axis, respectively. Further, the positive directions of the X axis, the Y axis, and the Z axis (or end portion sides in the positive directions of the X axis, the Y axis, and the Z axis) are also referred to as an X axis positive side, a Y axis positive side, and a Z axis positive side, respectively, and opposite directions (opposite surfaces) thereto are also referred to as an X axis negative side, a Y axis negative side, and a Z axis negative side, respectively. Further, “up (above)” and “down (below)” refer to “up (above)” and “down (below)” in the vertical direction (gravitational direction), but do not mean only “immediately above (on)” and “immediately below (under)” and includes an “upper side” and a “lower side” than a horizontal plane passing through a noting element or position. In addition, a direction along a predetermined direction is, as a typical example, a direction including a direction substantially parallel to the predetermined direction. In addition, a direction crossing the predetermined direction is, as a typical example, a direction including a direction substantially perpendicular to the predetermined direction.

The image forming apparatus 1 includes the photosensitive drum 2 which is a rotatable drum-shaped (cylindrical) photosensitive member (electrophotographic photosensitive member) as an image bearing member. Further, the image forming apparatus 1 includes the following means provided at a periphery of the photosensitive drum 2. A charging roller 3 which is a roller-shaped charging member as a charging means, a scanner 4 as an exposure means, a developing rotary (rotary-type developing device) 100 as a developing means, and a photosensitive drum cleaning unit 6 as a photosensitive member cleaning means are provided. A surface of the photosensitive drum 2 electrically charged uniformly by the charging roller 3 is irradiated with laser light depending on image information by the scanner 4, so that an electrostatic latent image (electrostatic image) is formed on the surface of the photosensitive drum 2. The developing rotary 100 includes the rotary main body 90 as a developing device supporting member. The rotary main body 90 includes developing units 50y, 50m, 50c, and 50k as developing devices for developing (visualizing) electrostatic latent images, of color components of yellow, magenta, cyan, and black, respectively, formed on the surface of the photosensitive drum 2 by using toner of each of corresponding colors. Further, the developing rotary 100 includes toner cartridges 70y, 70m, 70c, and 70k as developer supplying containers, each detachably mountable to the rotary main body 90, correspondingly to the developing units 50y, 50m, 50c, and 50k, respectively. Inside the toner cartridges 70y, 70m, 70c, and 70k, yellow toner, magenta toner, cyan toner, and black toner for being supplied to the developing units 50y, 50m, 50c, and 50k, respectively, are accommodated. In this embodiment, even in either one of the developing units 50y, 50m, 50c, and 50k, as a developer, toner which is a negatively chargeable non-magnetic one-component developer and which is 7 μm in average particle size is used. Details of an image forming operation will be described later.

Incidentally, each of suffixes y, m, c, and k of symbols of the developing units 50y, 50m, 50c, and 50k shows an associated color of the toner used. That is, y, m, c, and k show yellow, magenta, cyan, and black, respectively. The same also applies to other elements such as the toner cartridges 70y, 70m, 70c, and 70k, trays 80y, 80m, 80c, and 80k, and the like which are described later. However, as regards elements which are provided for the respective colors and which have the same or corresponding functions or constitutions, these elements are collectively described by omitting the suffixes y, m, c, and k of the symbols each showing the element for the associated color in some instances.

The image forming apparatus 1 further includes an intermediary transfer unit 10, a secondary transfer roller 12, a fixing device 40, and the like. The intermediary transfer unit 10 includes an intermediary transfer belt 10a constituted by an endless belt as an intermediary transfer member. The intermediary transfer belt 10a is extended around a driving roller 10b and a tension roller 10d as a plurality of stretching rollers and is stretched under predetermined tension. The intermediary transfer belt 10a is rotated (circulated and moved) in an arrow R3 direction (clockwise direction) by rotationally driving the driving roller 106. On an inner peripheral surface side of the intermediary transfer belt 10a, a primary transfer roller 11 which is a roller-shaped primary transfer roller member as a primary transfer means is provided.

The primary transfer roller 11 presses the intermediary transfer belt 10a toward the photosensitive drum 2 and forms a primary transfer nip (primary transfer portion) N1 which is a contact portion between the photosensitive drum 2 and the intermediary transfer belt 10a. Further, on an outer peripheral surface side of the intermediary transfer belt 10a, in a position opposing the driving roller 10b also functioning as a secondary transfer opposite roller, a secondary transfer roller 12 which is a roller-shaped secondary transfer member as a secondary transfer means is provided. The secondary transfer roller 12 is pressed toward the driving roller 10b and is contacted to the driving roller 10b through the intermediary transfer belt 10a and is capable of forming a secondary transfer nip (secondary transfer portion N2) which is a contact portion between the intermediary transfer belt 10a and the secondary transfer roller 12. Further, with respect to a rotational direction of the intermediary transfer belt 10a, on the outer peripheral surface side downstream of the secondary transfer nip N2 and upstream of the primary transfer nip N1, a belt cleaning device 13 as an intermediary transfer member cleaning means is provided.

### Developing Rotary

Next, a constitution and an operation of the developing rotary 100 will be further described.

As shown in FIG. 1, to the rotary main body 90, the trays 80y, 80m, 80c, and 80k as cartridge holding members for detachably holding the toner cartridges 70y, 70m, 70c, and 70k, respectively, are mounted. To the trays 80y, 80m, 80c, and 80k, the toner cartridges 70y, 70m, 70c, and 70k for associated colors are mounted, respectively. To each of the developing units 50y, 50m, 50c, and 50k, the toner of the associated color is capable of being supplied. The trays 80y, 80m, 80c, and 80k are mounted to the rotary main body 90 so that the toner cartridges 70y, 70m, 70c, and 70k are mounted to and demounted from the trays 80y, 80m, 80c, and 80k, respectively. Further, as shown in FIG. 1, the developing units 50y, 50m, 50c, and 50k include developing rollers 51y, 51m, 51c, and 51k, respectively, as a developer carrying member. The developing roller 51 is rotated while carrying the toner as the developer and supplies the toner to the photosensitive drum 2. The developing unit 50 may also be made detachably mountable to the rotary main body 90. Incidentally, details of a constitution of the developing unit 50 will be described later.

As shown in FIG. 1, the rotary main body 90 is rotatable in an arrow R2 direction (clockwise direction) about the rotational axis 90C extending in the Y axis direction. By this, the rotary main body 90 is capable of disposing either one of the developing rollers 51y, 51m, 51c, and 51k in a position opposing the photosensitive drum 2. In addition, as shown in FIG. 1, the rotary main body 90 is supported by an image forming apparatus main assembly 1a so as to be swingable about a swing shaft 91. Further, the rotary main body 90 is urged in an arrow R4a direction (counterclockwise direction) about the swing shaft 91 extending in the Y axis direction by an urging means such as a spring. By this, the developing rotary 100 is capable of forming a developing nip (developing portion) G which is a contact portion between the developing roller 51 and the photosensitive drum 2. Further, the image forming apparatus main assembly 1 is provided with a rotatable cam 96 so as to be contactable to the rotary main body 90. By rotating the cam 96, a contact/separation state between the developing roller 51 and the photosensitive drum 2 is capable of being controlled. Each of the rotational axis 90C of the rotary main body 90, a rotational axis of the developing roller 51, and an axis of the swing shaft 91 is substantially parallel to a rotational axis (Y axis direction) of the photosensitive drum 2.

Using FIG. 2, a rotation operation of the rotary main body 90 and a contact/separation operation between the photosensitive drum 2 and the developing roller 51 will be described. Each of parts (a) to (d) of FIG. 2 is a schematic sectional view of the developing rotary 100 and peripheral members thereof.

Part (a) of FIG. 2 shows an operation stand-by attitude of the developing rotary 100 when the image forming apparatus 1 waits for execution of an image forming operation. The rotary main body 90 is in a phase such that the photosensitive drum 2 is opposed to between the developing roller 51c for cyan and the developing roller 51k for black in a state in which the photosensitive drum 2 and the developing roller 51 are separated from each other.

Part (b) of FIG. 2 shows a contact/separation attitude of the developing rotary 100 when the rotary main body 90 is rotated from the state of part (a) of FIG. 2 in the arrow R2 direction by a predetermined angle and the developing roller 51 is brought close to the photosensitive drum 2. The rotary main body 90 is in a phase such that the photosensitive drum 2 is opposed to the developing roller 51 in a state in which the photosensitive drum 2 and the developing roller 51 are separated from each other. When the rotary main body 90 is in such a phase, the developing roller 51 and the photosensitive drum 2 can be brought in contact with each other by a contact operation between the developing roller 51 and the photosensitive drum 2 described later. Incidentally, in the case of part (b) of FIG. 2, a contact stand-by attitude for yellow in which the developing roller 51y for yellow is opposed to the photosensitive drum 2 is shown. On the other hand, an attitude in which the developing roller 51m for magenta opposed to the photosensitive drum 2 is a contact stand-by attitude for magenta. Further, an attitude, in which the developing roller 51c for cyan is opposed to the photosensitive drum 2 is a contact stand-by attitude for cyan. Further, an attitude in which the developing roller 51k for black is opposed to the photosensitive drum 2 is a contact stand-by attitude for black.

Part (c) of FIG. 2 shows a development attitude when the developing roller 51 is contacted to the photosensitive drum 2 for developing the electrostatic latent image on the photosensitive drum 2. Specifically, the cam 96 is rotated in the arrow R5 direction (clockwise direction) in a state in which rotation of the rotary main body 90 is stopped from the contact stand-by attitude of the developing rotary 100 shown in part (b) of FIG. 2. By this, the cam 96 is separated from the rotary main body 90. As described above, an urging force about the swing shaft 91 in the arrow R5a direction acts on the rotary main body 90. For that reason, with rotation of the cam 96, the rotary main body 90 is swung (rotated) about the swing shaft 91 in the arrow R4a direction, so that the developing roller 51 is contacted to the photosensitive drum 2. Incidentally, in the case of part (c) of FIG. 2, a development attitude for yellow in which the developing roller 51 for yellow is contacted to the photosensitive drum 2 is formed. On the other hand, an attitude in which the developing roller 51m for magenta is contacted to the photosensitive drum 2 is a development attitude for magenta. Further, an attitude in which the developing roller 51c for cyan is contacted to the photosensitive drum 2 is a development attitude for cyan. Further, an attitude in which the developing roller 51k for black is contacted to the photosensitive drum 2 is a development attitude for black. Further, in this embodiment, the development attitude of the developing rotary 100 is an attitude in which an angle formed between a horizontal line and a line drawn from the rotation axis 90C of the rotary main body 90 to the developing nip G in which the developing roller 51 and the photosensitive drum 2 are in contact with each other becomes 20°.

After a developing operation for forming a toner image for yellow on the photosensitive drum 2 is ended, the developing roller 51y for yellow is separated from the photosensitive drum 2 in order to subsequently perform a developing operation for forming a toner image for magenta. Specifically, in a state in which the rotation of the rotary main body 90 is stopped from the development attitude for yellow shown in part (c) of FIG. 2, the cam 96 is rotated in the arrow R5 direction, so that the cam 96 is contacted to the rotary main body 90. By this, the rotary main body 90 is urged by the cam 96, so that the rotary main body 90 is swung (rotated) about the swing shaft 91 in an arrow R4b direction (clockwise direction). Then, the contact stand-by attitude for yellow shown in part (b) of FIG. 2, which is a state in which the developing roller 51y for yellow is separated from the photosensitive drum 2 is formed again.

Here, the rotation operation of the rotary main body 90 was described in relation to the development attitude for yellow, but the same also applies to the rotation operations of the rotary main body 90 in relation to the development attitude for magenta, the development attitude for cyan, and the development attitude for black.

Incidentally, in this embodiment, when the developing roller 51 and the photosensitive drum 2 are contacted to and separated from each other, the state in which the rotation of the developing rotary 90 was stopped was formed. On the other hand, the contact/separation operation between the developing roller 51 and the photosensitive drum 2 may be performed by rotating the cam 96 while rotating the rotary main body 90 in the arrow R2 direction.

Further, part (d) of FIG. 2 shows an exchange attitude of the developing rotary 100 when a user exchanges the toner cartridge 70. In the case of part (d) of FIG. 2, the exchange attitude of the developing rotary 100 when the toner cartridge 70k for black is exchanged is shown. In this embodiment, the exchange attitude of the developing rotary 100 is an attitude in which a longitudinal direction of the toner cartridge 70 in an XZ flat plane (cross section perpendicular to the Y axis direction) is substantially parallel to the horizontal line (X axis direction)

Using FIG. 3, the exchange of the toner cartridge 70 will be further described. Parts (a) and (b) of FIG. 3 are schematic sectional views of the developing rotary 100 and the peripheral members thereof, showing a state in which the toner cartridge 70k for black is mounted to and demounted from the image forming apparatus main assembly 1a (rotary main body 90). The image forming apparatus 1 includes a mounting/demounting opening 16a provided in a side surface 16 thereof on the X axis positive side. In addition, the image forming apparatus 1 includes a door 14 for opening and closing the mounting/demounting opening 16a. As shown in part (a) of FIG. 3, when the toner cartridge 70k for black is exchanged, the rotary main body 90 is stopped in a state in which the toner cartridge 70k for black is supported by the tray 80k for black in a position opposing the mounting/demounting opening 16a and the door 14. This attitude of the developing rotary 100 is the exchange attitude of the developing rotary 100 when the toner cartridge 70k for black is exchanged, and the longitudinal direction of the toner cartridge 70k for black in the XZ flat plane becomes substantially parallel to the horizontal line (X axis direction). From this state, as shown in part (b) of FIG. 3, the door 14 is opened and the tray 80k for black is slid and moved to an outside of the rotary main body 90 through the mounting/demounting opening 16a in the substantially horizontal direction. In this state, the toner cartridge 70k for black becomes detachably mountable to the rotary main body 90 (tray 80k for black), so that the user is capable of exchanging the toner cartridge 70k for black. After the toner cartridge 70 for black is exchanged, in a procedure opposite to the above-described procedure, the tray 80k for black is returned to an inside of the rotary main body 90, and the door 14 is closed.

Here, the exchanging method of the toner cartridge 70k for black was described as an example, but the same also applies to exchanging methods of the toner cartridges 70y, 70m, and 70c for yellow, magenta, and cyan.

Incidentally, in this embodiment, the toner cartridge 70k for black is longer in layer in the longitudinal direction in the XZ flat plane than the toner cartridges 70y, 70m, and 70c for other colors. Further, of the toner cartridges 70y, 70m, 70c, and 70k, only the toner cartridge 70k for black is disposed in a position where in the rotary main body 90, one end portion thereof with respect to the longitudinal direction in the XZ flat plane overlaps with the rotation axis 90C of the rotary main body 90.

### Image Forming Operation

Next, using FIGS. 1, 2 and 4, the image forming operation in this embodiment will be described. First, the image forming operation in the case where a full-color image is formed on a sheet S will be described.

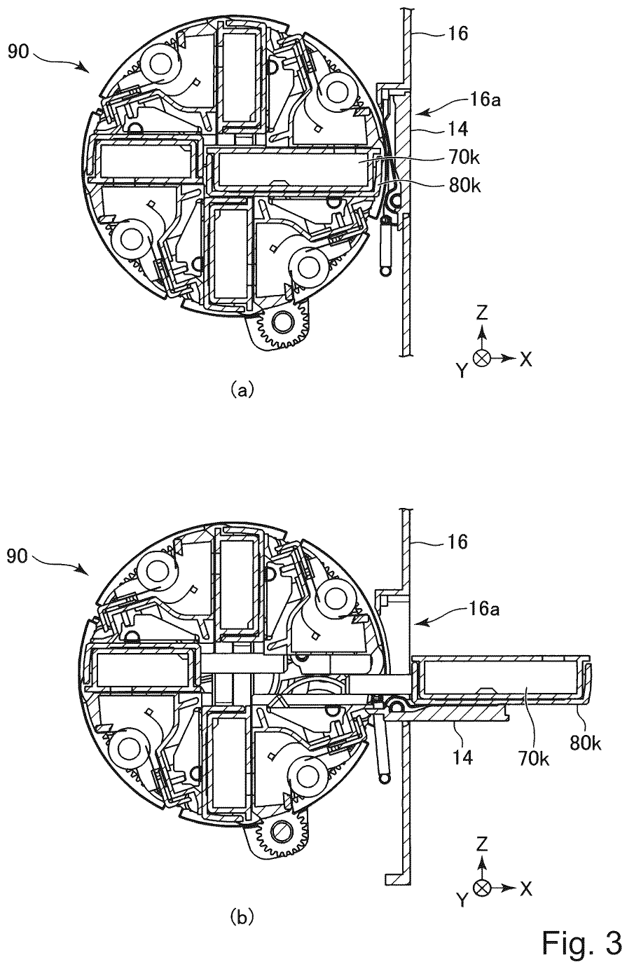

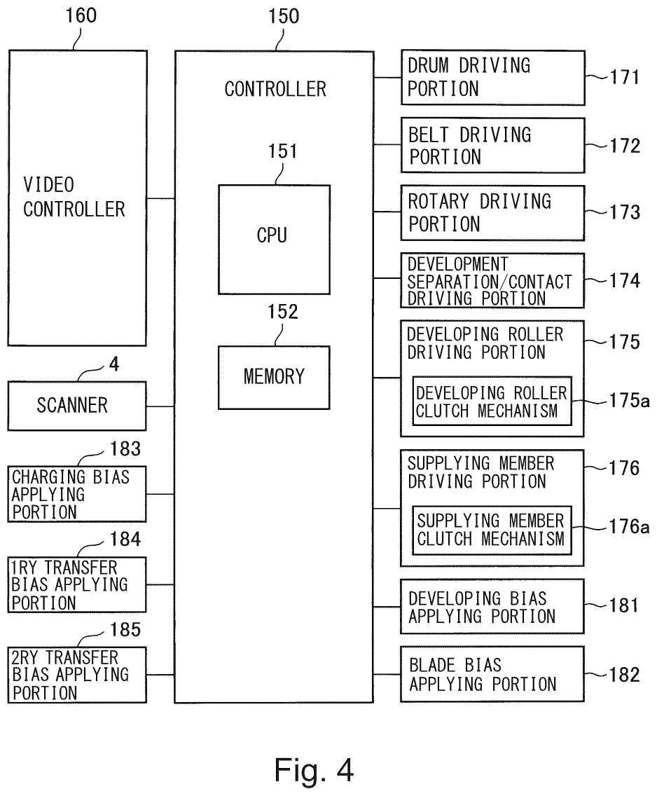

When a video controller 160 (FIG. 4) provided to the image forming apparatus main assembly 1a receives image information from an external device (not shown) such as a host computer, the video controller 160 sends a print signal to a controller 150 provided in the image forming apparatus main assembly 1a. Then, the controller 150 starts the image forming operation by controlling respective portions of the image forming apparatus 1. Incidentally, as described above, at a point in time when the image forming operation is started, the developing rotary 100 is in the operation stand-by attitude as shown in part (a) of FIG. 2. With the start of the image forming operation, by a drum driving portion 171 (FIG. 4) as a photosensitive member driving means, rotation of the photosensitive drum 2 in an arrow R1 direction (counterclockwise direction) is started. Further, substantially simultaneously therewith, by a belt driving portion 172 (FIG. 4) as an intermediary transfer member driving means, rotation of the intermediary transfer belt 10a in the arrow R3 direction (clockwise direction) is started. Further, the surface of the rotating photosensitive drum 2 is electrically charged uniformly by the charging roller 3. In this embodiment, a charge polarity of the photosensitive drum 2 is a negative polarity, and the surface of the photosensitive drum 2 is charged uniformly to a predetermined potential of the negative polarity by the charging roller 3. During charging, to the charging roller 3, a charging bias (charging voltage) which is a DC voltage of the negative polarity is applied by a charging bias applying portion 183 (FIG. 4) as a charging bias applying means.

Here, in this embodiment, in the case where the full-color image is formed, the image forming apparatus 1 successively moves the developing rollers 51y, 51m, 51c, and 51k to the developing position where the associate developing roller contacts the photosensitive drum 2. By this, the image forming apparatus 1 successively forms the toner images of yellow, magenta, cyan, and black on the photosensitive drum 2. Further, the image forming apparatus 1 successively primarily transfers the toner images of yellow, magenta, cyan, and black, formed on the photosensitive drum 2, so as to be superposed on the intermediary transfer belt 10a. Thereafter, the image forming apparatus 1 secondarily transfers the toner image, formed on the intermediary transfer belt 10a with the toners of the four colors, onto the sheet S such as sheet-like paper as a recording material.

The charged surface of the photosensitive drum 2 is irradiated with laser light based on image data corresponding to the yellow image by the scanner 4, so that an electrostatic latent image corresponding to the yellow image is formed on the surface of the photosensitive drum 2. In parallel to formation of this electrostatic latent image, the rotary main body 90 is rotated in the arrow R2 direction (clockwise direction) by a rotary driving portion 173 (FIG. 4) as a rotary driving means. By this, the developing rotary 100 becomes the contact stand-by attitude for yellow as shown in part (b) of FIG. 2 in which the developing roller 51y for yellow is brought close to the photosensitive drum 2.

Further, the cam 96 is rotated in the arrow R5 direction (clockwise direction) by a development separation/contact driving portion 174 (FIG. 4) as a development separation/contact driving means. By this, the developing rotary 100 becomes the development attitude for yellow as shown in part (c) of FIG. 2 in which the developing roller 51y for yellow is contacted to the photosensitive drum 2.

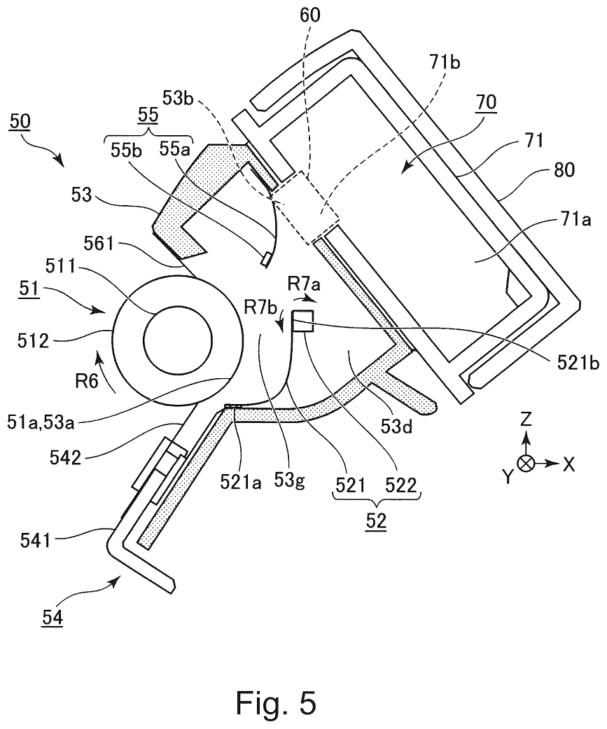

Incidentally, in the case where the developing roller 51 is contacted to the rotating photosensitive drum 2, when rotation of the developing roller 51 is stopped, there is a possibility that the surface of the developing roller 51 is damaged (scarred) by frictional sliding with the photosensitive drum 2. For that reason, in this embodiment, before the developing roller 51 is contacted to the photosensitive drum 2 by rotating the cam 96, rotation of the developing roller 51 is started by a developing roller driving portion 175 (FIG. 4) as a development driving means. In this embodiment, before the developing roller 51 is contacted to the photosensitive drum 2, the developing roller 51 is rotated in advance in an arrow R6 direction (clockwise direction) (FIG. 5) by transmitting a driving force from a development driving gear (not shown) by a developing roller clutch mechanism 175a (FIG. 4). The developing roller clutch mechanism 175a and the development driving gear constitute the developing roller driving portion 175. The developing roller clutch mechanism 175a is controlled by the controller 150. By this, the developing roller 51 is contacted to the photosensitive drum 2 in a rotated state (in this embodiment, in a state in which a predetermined peripheral speed ratio is provided between a peripheral speed of the photosensitive drum 2 and a peripheral speed of the developing roller 51). further, when the developing roller 51 is moved to the developing position, a developing bias applying portion 181 (FIG. 4) as a developing bias applying means is connected to the developing roller 51, so that a predetermined developing bias (developing voltage) can be applied to the developing roller 51. In this embodiment, substantially simultaneously with movement of the developing roller 51 to the developing position, application of the developing bias to the developing roller 51 is started. Further, when the developing roller 51 is moved to the developing position, a blade bias applying portion 182 (FIG. 4) as a blade bias applying means is connected to a regulating blade 54 (FIG. 5) described later, so that a predetermined blade bias can be applied to the regulating blade 54. In this embodiment, substantially simultaneously with the movement of the developing roller 51 to the developing position, application of the blade bias to the regulating blade 54 is started.

In this embodiment, the developing roller 51 is disposed in the developing position, where the developing roller 51 is contacted to the photosensitive drum 2, until a leading end of a region, on the photosensitive drum 2, corresponding to a single (one) sheet S (hereinafter, this region is also simply referred to as a “sheet S corresponding region”) reaches a position corresponding to the developing nip G. Incidentally, the region, on the photosensitive drum 2, corresponding to the sheet S is a region which is set for each image for one page transferred on the single sheet S and which includes an image forming region described later. The leading end and a trailing end of the region, on the photosensitive drum 2, corresponding to the sheet S refer to a leading end and a trailing end on the photosensitive drum 2 with respect to a surface movement direction of the photosensitive drum 2 (the same also applies to the image forming region and an image formed in the image forming region). Incidentally, the developing roller 51 may only be required to be disposed in the developing position, where the developing roller 51 is contacted to the photosensitive drum 2, until the leading end of the image forming region of an image (image for one page), on the photosensitive drum 2, transferred onto the single sheet S (hereinafter, this image forming region is also simply referred to as an “image forming region”) reaches a position corresponding to the developing nip G. Incidentally, the image forming region on the photosensitive drum 2 is a region which is set for an image (image for one page) transferred onto the single sheet S and in which the toner image is capable of being formed. In the case where a margin is provided on at least one of a leading end side and a trailing end side of the sheet S with respect to a conveying direction of the sheet S, and one end side and the other end side of the sheet S with respect to a widthwise direction of the sheet S substantially perpendicular to the conveying direction, the image forming region becomes a region narrower than a region corresponding to the sheet S. However, in the case where the above-described margin is not provided or in the like case, the image forming region and the region corresponding to the sheet S may also be the same region.

In a state in which the developing roller 51y for yellow is disposed in the developing position, the electrostatic latent image, corresponding to the image of yellow, formed on the surface of the photosensitive drum 2 is moved to the developing nip G which is the contact portion between the developing roller 51y and the photosensitive drum 2. Then, by a potential difference between a potential of the electrostatic latent image formed on the surface of the photosensitive drum 2 and the developing bias applied to the developing roller 51y for yellow, the yellow toner carried on the developing roller 51y for yellow is moved to the surface of the photosensitive drum 2. By this, the yellow toner image is formed on the surface of the photosensitive drum 2. In this embodiment, on an exposure portion of the photosensitive drum 2 lowered in absolute value of the potential by being exposed to light after being charged uniformly, the toner charged to the same polarity (in this embodiment, the negative polarity) as the charge polarity of the photosensitive drum 2 is deposited (reverse development type). In this embodiment, a normal charge polarity of the toner which is a principal charge polarity of the toner during the development is the negative polarity.

The yellow toner image formed on the surface of the photosensitive drum 2 is transferred (primarily transferred) onto the intermediary transfer belt 10a in the primary transfer nip N1, in which the photosensitive drum 2 and the intermediary transfer belt 10a are in contact with each other, by the action of the primary transfer roller 11. During the primary transfer, to the primary transfer roller 11, a primary transfer bias (primary transfer voltage) which is a DC voltage of a polarity opposite to the normal charge polarity of the toner is applied by a primary transfer bias applying portion 184 (FIG. 4) as a primary transfer bias applying means. Here, the intermediary transfer belt 10a has a peripheral length longer than a length of the sheet S with respect to the conveying direction of the sheet S to some extent. Further, in a period until the toner images of the four colors of yellow, magenta, cyan, and black are formed on the surface of the intermediary transfer belt 10a, the secondary transfer roller 12 and the belt cleaning device 13 are kept separated from the surface of the intermediary transfer belt 10a.

The operation of the image forming apparatus 1 is shifted to a developing operation for forming the magenta toner image after the developing operation for forming the yellow toner image is performed to a position corresponding to the trailing end of the image forming region on the photosensitive drum 2 (in this embodiment, after the trailing end of the region, on the photosensitive drum 2, corresponding to the sheet S passes through the developing nip G). That is, from a state in which the developing rotary 100 is in the development attitude for yellow, the cam 96 is rotated in the arrow R5 direction by the development separation/contact portion 174. By this, the attitude of the developing rotary 100 is shifted to the contact stand-by attitude for yellow in which the developing roller 51y for yellow is separated from the photosensitive drum 2. Thereafter, the rotary main body 90 is rotated in the arrow R2 direction by the rotary driving portion 173, so that the attitude of the developing rotary 100 is shifted to the contact stand-by attitude for magenta.

Incidentally, in this embodiment, when the attitude of the developing rotary 100 is shifted from the development attitude to the contact stand-by attitude, transmission of the driving force from the development driving gear to the developing roller 51 is cut off by the developing roller clutch mechanism 175a, so that the rotation of the developing roller 51 is stopped. In the case where the rotation of the developing roller 51 is continued, there is a possibility that deterioration of the toner progresses principally in a contact portion between a regulating plate 542 of the regulating blade 54 described later and the developing roller 51. In order to suppress this toner deterioration, it is desirable that the rotation of the developing roller 51 is stopped as can as possible in a state other than when the developing rotary 100 is put in the development attitude. Further, in this embodiment, when the developing rotary 100 is shifted in attitude from the development attitude for yellow to the contact stand-by attitude for yellow, the developing bias applying portion 181 is separated from the developing roller 51, so that the developing bias applied to the developing roller 51 is interrupted. Further, in this embodiment, when the developing rotary 100 is shifted in attitude from the development attitude for yellow to the contact stand-by attitude for yellow, the blade bias applying portion 182 is separated from the regulating blade 54, so that the blade bias applied to the regulating blade 54 is interrupted.

Thereafter, similarly as in the case of the yellow toner image, the electrostatic latent image corresponding to the magenta image is formed on the surface of the photosensitive drum 2, and the developing rotary 100 is moved to the development attitude for magenta. Then, the magenta toner image is formed on the surface of the photosensitive drum 2 is transferred onto the intermediary transfer belt 10a. At that time, in the case where a red image is outputted, the magenta toner image is transferred onto the yellow toner image which has already been transferred on the intermediary transfer belt 10a.

Thus, the developing rotary 100 is successively put in the development attitudes for magenta, cyan, and black by rotating the rotary main body 90 by 90°. By this, on the surface of the photosensitive drum 2, toner images of the colors of yellow, magenta, cyan, and black are successively formed.

Further, the toner images formed on the photosensitive drum 2 are successively transferred onto the surface of the image forming apparatus 1. By this, the four color toner images constituting a full-color image are formed on the surface of the intermediary transfer belt 10a. In synchronism with a region when the four color toner images are formed on the intermediary transfer belt 10a, the secondary transfer roller 12 is contacted to the intermediary transfer belt 10a and is prepares for secondary transfer.

In parallel to the toner image forming operation onto the intermediary transfer belt 10a, the sheet S is fed from a sheet accommodating portion 300, provided in a lower portion of the image forming apparatus 1, by a pick-up roller 310. This sheet S is sent to a conveying roller pair 320 in a state in which sheets S are separated one by one by a feed roller 311 and a separation roller 312. This sheet S is timed to the toner images on the intermediary transfer belt 10a by the conveying roller pair 320 and is conveyed toward the secondary transfer nip N2 in which the intermediary transfer belt 10a and the secondary transfer roller 12 are in contact with each other. By this, the toner images on the intermediary transfer belt 10a are transferred (secondarily transferred) onto the sheet S passing through the secondary transfer nip N2. During the secondary transfer, to the secondary transfer roller 12, a secondary transfer bias (secondary transfer voltage) which is a DC voltage of the opposite polarity to the normal charge polarity of the toner is applied by a secondary transfer bias applying portion 185 (FIG. 4) as a secondary transfer bias applying means.

The sheet surface on which the toner images are transferred is sent to the fixing device 40 includes a heating unit 41 and a pressing roller 42. The fixing device 40 heats and presses the sheet S by the heating unit 41 and the pressing roller 42, and thus fixes (melts, sticks) the toner image on the sheet S. The sheet S passed through the fixing device 40 is discharged (outputted) as a product onto a discharge portion 44 provided outside (in upper portion) of the image forming apparatus 1 by a discharging roller pair 43.

Incidentally, as described above, a contact/separation operation between the developing roller 51 and the photosensitive drum 2 may also be performed while rotating the main body 90 in the arrow R2 direction. For example, while rotating the rotary main body 90, immediately before the image forming region on the photosensitive drum 2 reaches a position corresponding to the developing nip G, the rotation of the developing roller 51 is started, and the developing roller 51 is contacted to the photosensitive drum 2 while being kept in that state. That is, in this case, the attitude of the developing rotary 100 does not enter the contact stand-by attitude, but enters the development attitude. After the developing operation is ended, the rotary main body 90 is rotated while keeping the developing roller 51 in a rotated state, so that the developing roller 51 is separated from the photosensitive drum 2, and thereafter, the rotation of the developing roller 51 is stopped. That is, the attitude of the developing rotary 100 does not enter the contact stand-by attitude from the development attitude, and is shifted toward the development attitude for a subsequent color.

Specifically, for example, the following constitution can be employed. Similarly as in this embodiment, the rotary main body 90 is made swingable, and in addition, is urged in a direction toward the photosensitive drum 2. Further, in an end portion of the rotary main body 90 with respect to the Y axis direction or in the like portion, a rotatable cam is provided concentrically and integrally with the rotary main body 90, and the image forming apparatus main assembly 1a is provided with a contact member (roller or the like) for guiding rotation of the cam in contact with an outer periphery of the cam. This cam has a shape including a recessed portion correspondingly to each of the developing units 50 for the respective colors so that the developing roller 51 of each of the developing units 50 for the respective colors is contacted to the photosensitive drum 2 and separated from the photosensitive drum 2 by rotation of the rotary main body 90. When the developing roller 51 is separated (spaced) from the photosensitive drum 2, the contact member contacts the outer periphery of the cam in a position other than the recessed portion. The rotary main body 90 is rotated and the contact member is positioned in the recessed portion of the cam, so that the rotary main body 90 is swung in a direction in which the rotary main body 90 approaches the photosensitive drum 2, and thus the developing roller 51 contacts the photosensitive drum 2. Further, the rotary main body 90 is rotated, and the contact member gets out of the recessed portion and contacts the outer periphery of the cam in the position other than the recessed portion, so that the developing roller 51 is separated from the photosensitive drum 2. Further, rotation of the developing roller 51 is started immediately before the developing roller 51 contacts the photosensitive drum 2 and is stopped immediately after the developing roller 51 is separated from the photosensitive drum 2.

Thus, the image forming apparatus 1 may be constituted so that the developing roller 51 is contacted to the photosensitive drum 2 and a contact state between the developing roller 51 and the photosensitive drum 2 is released by the rotation of the rotary main body 90. That is, the image forming apparatus 1 may be constituted so that although the rotation of the rotary main body 90 is stopped during the development, the developing roller 51 is separated from the photosensitive drum 2 by the rotation of the rotary main body 90 when the development is ended. In this case, substantially only by an operation for rotating the rotary main body 90, the developing rollers 51 of the developing units for the respective colors can be successively contacted to and separated from the photosensitive drum 2. For that reason, there is no need to provide particular constitution and driving source for contact and separation between the developing roller 51 and the photosensitive drum 2, thus being advantageous for downsizing and cost reduction of the image forming apparatus. Further, the contact/separation operation and a switching operation of the developing unit 50 can be performed at the same time, thus being advantageous for speed-up of the image forming apparatus.

Next, an image forming operation in the case where a black monochromatic image is formed on the sheet S will be described. In this case, the developing rotary 100 is shifted in attitude from the operation stand-by attitude to the development attitude for black. In this state, similarly as in the case of formation of the toner images of the respective colors during the full-color image formation, charging and exposure to light of the photosensitive drum 2 are performed, so that an electrostatic latent image corresponding to the black image is formed on the surface of the photosensitive drum 2. Further, by the developing roller 51k for black disposed in the developing position, the electrostatic latent image formed on the surface of the photosensitive drum 2 is developed with black toner. In the cease where black monochromatic images are continuously formed on a plurality of sheets S, in a state in which the developing rotary 100 is kept in the development attitude, development of electrostatic latent images for the images formed on the plurality of sheets S is successively performed. In the case where the black monochromatic images re not continuously formed, the attitude of the developing rotary 100 is returned to the operation stand-by attitude. Further, the b toner black image formed on the photosensitive drum 2 is primarily transferred onto the intermediary transfer belt 10a, and thereafter is secondarily transferred onto the sheet S. Subsequent operations are similar to those in the case of formation of the full-color image.

### Control Constitution

FIG. 4 is a schematic block diagram of a control constitution of the image forming apparatus 1 of this embodiment. The image forming apparatus 1 includes the controller 150 and the video controller (image processor) 160 which are for controlling the operation of the image forming apparatus 1. The controller 150 includes a CPU 151 as an arithmetic processing means (arithmetic processing portion), a memory 152 constituted by a ROM and a RAM which are as storing means (storing portions), a non-volatile memory, or the like, and an input/output portion (not shown) for transferring signal between the controller 150 and devices other than the controller 150. In the ROM, a control program and data for control are stored. In the RAM, an arithmetic (operation) result by the CPU 151 and detection results of various sensors, and the like are stored. In the non-volatile memory, various pieces of setting information and various pieces of history information, and the like are stored. The video controller 160 receives image information from an external device (not shown) such as a host computer and forms a print signal for performing image formation in the image forming apparatus 1, and then sends the print signal to the controller 150. On the basis of this print signal, the controller 150 controls the respective portions of the image forming apparatus 1 and causes the image forming apparatus 1 to perform the image forming operation.

To the controller 150, the respective portions of the image forming apparatus 1 are connected. For example, to the controller 150, various driving portions such as the drum driving portion 171, the belt driving portion 172, the rotary driving portion 173, the development separation/contact driving portion 174, the developing roller driving portion 175, and the supplying member driving portion 176 and connected. Further, to the controller 150, various bias applying portions such as the developing bias applying portion 181, the blade bias applying portion 182, the charging bias applying portion 183, the primary transfer bias applying portion 184, and the secondary transfer bias applying portion 185 are connected. Further, to the controller 150, the scanner 4 is connected. On the basis of the print signal, the controller 150 controls the respective portions of the image forming apparatus 1 so as to execute the image forming operation. Incidentally, constitutions of a part of the drum driving portion 171, the belt driving portion 172, the rotary driving portion 173, the development separation/contact driving portion 174, the developing roller driving portion 175, and the supplying member driving portion 176 may also be commonized. For example, driving motors may be provided independently for driving objects, respectively, or may also be made common to a plurality of driving objects. In this embodiment, a development driving gear for transmitting a driving force to the developing roller 51 and the supplying mechanism 52 is commonized, and this development driving gear constitutes each of the developing roller driving portion 175 and the supplying member driving portion 176.

### Constitution of Developing Unit

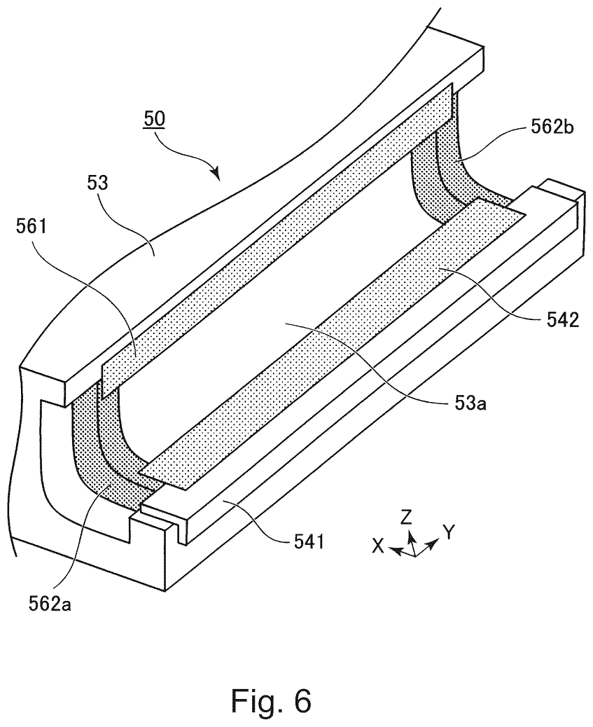

Next, using FIGS. 5 and 6, the developing unit 50 in this embodiment will be further described. Incidentally, in this embodiment, the developing units 50y, 50m, 50c, and 50k have substantially the same constitution except that the colors of the toner accommodated therein are different from each other.

FIG. 5 is a schematic sectional view of the developing unit 50, the toner cartridge 70, and the tray 80. Incidentally, FIG. 5 shows a state in which the attitude of the developing rotary 100 is the development attitude and the developing roller 51 is in the developing position as shown in part (c) of FIG. 2. Further, FIG. 6 is a schematic perspective view of the developing unit 50 in a state in which the developing roller 51 is removed, as viewed from an outside (a side where the photosensitive drum 2 is disposed) of the developing unit 50.

As shown in FIG. 5, the developing unit 50 includes a developing container (developing (unit) frame) 53, the developing roller 51 as a developer carrying member (developing member), the regulating blade 54 as the regulating member, and the supplying mechanism (supplying device) 52.

The developing roller 51 is a roller comprising a developing roller core metal 511 having electroconductivity and a rubber layer 512 having electroconductivity provided around the developing roller core metal 511. The developing roller 51 is mounted to the developing container 53 by being rotatably supported by the developing container 53 in opposite end portions of the developing roller core metal 511 with respect to a rotational axis direction of the developing roller core metal 511. The developing roller 51 is rotatable in the arrow R6 direction (clockwise direction) by transmitting the driving force to a developing roller gear (not shown) mounted to the one end portion of the developing roller more metal 511 with respect to the rotational axis direction. That is, in this embodiment, the developing roller 51 is rotated so that the surface (outer peripheral surface) of the photosensitive drum 2 and the surface (outer peripheral surface) of the developing roller 51 moves in a forward direction in the developing nip G. To the developing roller gear, the driving force from the development driving gear (not shown) is transmitted through the developing roller clutch mechanism 175a (FIG. 4). Further, the developing bias applying portion 181 (FIG. 4) is connected to the developing roller core metal 511, so that a predetermined developing bias is capable of being applied to the developing roller 51. A predetermined potential difference is formed between a potential of an image portion of the electrostatic latent image on the photosensitive drum 2 and a potential (potential of the developing bias) of the developing roller 51, so that the toner carried on the surface of the developing roller 51 is moved onto the photosensitive drum 2.

The regulating blade 54 includes a supporting metal plate 541 as a blade supporting member and the regulating plate 542 as a regulating portion. The developing blade 54 is mounted to the developing container 53 by fixing the supporting metal plate 541 to the developing container 53 with screws (not shown). The supporting metal plate 541 is fixed to a surface of the developing container 53 extending in the Y axis direction (rotational axis direction of the developing roller 51) adjacently to the developing roller 51 on a side upstream of the developing nip G with respect to the rotational direction of the developing roller 51. In this embodiment, the regulating plate 542 is constituted by a flat plate of SUS (stainless steel). The regulating plate 542 is contacted to the rubber layer 512 of the developing roller 51 at a predetermined contact pressure. By this, the regulating plate 542 is capable of regulating an amount of the toner, carried on the surface of the developing roller 51, to a predetermined amount. Further, the blade bias applying portion 182 (FIG. 4) is connected to the supporting metal plate 541, so that a predetermined current is capable of being supplied to between the rubber layer 512 of the developing roller 51 and the regulating plate 542 of the regulating blade 54. The regulating plate 542 is constituted by a plate-like member which is long (long-length) in one direction and which has a substantially rectangular shape in plan view, and is disposed so that a longitudinal direction thereof extends along the Y axis direction. The regulating plate 542 is disposed so that a fixing end portion which one end portion thereof with respect to a widthwise direction substantially perpendicular to the longitudinal direction thereof is fixed to the supporting metal plate 541 and so that a free end portion which is the other end portion thereof with respect to the widthwise direction contacts the rubber layer 512 of the developing roller 51. The regulating plate 542 contacts the developing roller 51 with respect to a counter direction to the rotational direction of the developing roller 51 so that the free end portion is positioned on a side upstream of the fixing end portion with respect to a surface movement direction of the developing roller 51.

The developing container 53 is provided with a sealing sheet 561. The sealing sheet 561 is constituted by a flexible sheet-like member which is long (long-length) in one direction and which has a substantially rectangular shape in plan view, and is disposed so that a longitudinal direction thereof extends along the Y axis direction. The sealing sheet 561 is disposed so that a fixing end portion which is one end portion thereof with respect to a widthwise direction substantially perpendicular to the longitudinal direction thereof is fixed to the developing container 53 and so that a free end portion which is the other end portion thereof with respect to the widthwise direction is contacted to the rubber layer 512 of the developing roller 51 at a predetermined contact pressure. The sealing sheet 561 is fixed at the fixing end portion thereof with respect to the widthwise direction to the surface of the developing container 53 extending in the Y axis direction adjacently to the developing roller 51 on a side downstream of the developing nip G with respect to the rotational direction of the developing roller 51. The sealing sheet 561 seals between the developing container 53 and the developing roller 51 along the Y axis direction and prevents the toner from leaking out from the developing container 53.

Further, as shown in FIG. 6, in opposite end portions of the developing container 53 with respect to the Y axis direction, end portion sealing members 562a and 562b are provided, respectively. The end portion sealing members 562a and 562b contact the rubber layer 512 of the developing roller 51 in opposite end portions of the developing roller 51 with respect to the Y axis direction. The end portion sealing members 562a and 562b prevents the toner from leaking out from the opposite end portions of the developing container 53 with respect to the Y axis direction.

Here, an opening (space) of the developing unit 50 formed by the regulating plate 542 of the regulating blade 54, the sealing sheet 561, and the end portion sealing members 562a and 562b is defined as a developing opening 53a. The toner accommodated in the developing container 53 is supplied to the surface of the developing roller 51 in the developing opening 53a, so that the toner is carried on the surface of the developing roller 51. Of the surface of the developing roller 51, a portion corresponding to the developing opening 53a, i.e., a portion which faces an inside of the developing container 53 and to which the toner accommodated in the developing container 53 is capable of being supplied is defined as a (toner) receiving surface 51a. Specifically, as described later, with a larger amount of the toner supplied to this receiving surface 51a, in other words, with a larger area, in which the toner is supplied of the receiving surface 51a, a supply amount of the toner supplied to the developing roller 51 becomes larger, so that a white void described later becomes hard to occur.

As shown in FIG. 5, the toner cartridge 70 includes a toner container (toner (container) frame) 71. Inside the toner container 71, a toner accommodating portion 71a for accommodating the toner is formed.

Further, the toner container 71 is provided with a discharge opening 71b which communicates with the toner accommodating portion 71a and which is an opening for permitting discharge of the toner from the toner accommodating portion 71a. The toner cartridge 70 is movable to a mounting position, shown in part (a) of FIG. 3, relative to the developing container 53 and retracted position, shown in part (b) of FIG. 3, retracted from the mounting position. On the other hand, the developing container 53 is provided with a receiving opening 53b which is an opening for permitting reception of the toner to the inside of the developing container 53. In a state in which the toner cartridge 70 is disposed in the mounting position, the discharge opening 71b of the toner cartridge 70 and the receiving opening 53b of the developing container 53 are opposed to each other. Further, the toner accommodating portion 71a of the toner cartridge 70 and the inside of the developing container 53 communicate with each other through a communicating portion 60 (a broken line portion in FIG. 5) constituted by the discharge opening 71b and the receiving opening 53b. As specifically described later, when the toner is supplied from the toner cartridge 70 toward the developing unit 50, the developing unit 50 and the toner cartridge 70 are in an attitude in which a direction of the communicating portion 60 becomes a downward direction (Z axis negative side) than a horizontal direction with respect to a vertical direction. Incidentally, the direction of the communicating portion 60 can be represented by a rectilinear (line) direction substantially perpendicular to an inner wall of the developing container 53 and an inner wall of the toner container 71 which are adjacent to the communicating portion 60 is an XZ flat plane.

Further, the developing unit 50 is provided with a backflow preventing member 55 capable of covering the receiving opening 53b. The backflow preventing member 55 includes an openable (open/close) portion 55a constituted by a flexible sheet-like member which is long (long length) in one direction and which has a substantially rectangular shape in plan view, and includes a weight portion 55b. The openable portion 55a is disposed so that a longitudinal direction thereof extends along the Y axis direction, and includes a fixing end portion (upper end portion) which is one end portion thereof, with respect to a widthwise direction thereof substantially perpendicular to the longitudinal direction thereof, fixed to the developing container 53, and a free end portion (lower end portion) which is the other end portion thereof where the weight portion 55b is provided. The openable portion 55a is movable to a position where the openable portion 55a contacts an inner wall of the developing container 53 so as to cover the receiving opening 53b and a position where the openable portion 55a is separated from the inner wall of the developing container 53, and opens and closes the receiving opening 53b (communicating portion 60). The weight portion 55b stabilizes behavior of the openable member 55a. As specifically described later, by rotation of the rotary main body 90, a positional relationship between the weight portion 55b and the communicating portion 60 is changed, so that a contact/separation state between the openable portion 55a and the inner wall of the developing container 53 is controlled. That is, when the toner is supplied from the toner cartridge 70 to the developing container 53 through the communicating portion 60, the openable portion 55a is separated from the inner wall of the developing container 53, so that supply of the toner is made easy. On the other hand, during non-supply of the toner other than during the supply of the toner from the toner cartridge 70 to the developing container 53, the openable portion 55a is contacted to the inner wall of the developing container 53 by the weight portion 55b, so that backflow of the toner to the toner cartridge through the communicating portion 60. Incidentally, the communicating portion 60 may also be provided in a plurality of positions (for example, two or three positions) with respect to the Y axis direction. In that case, each of the communicating portions 60 is provided with the backflow preventing member 55.

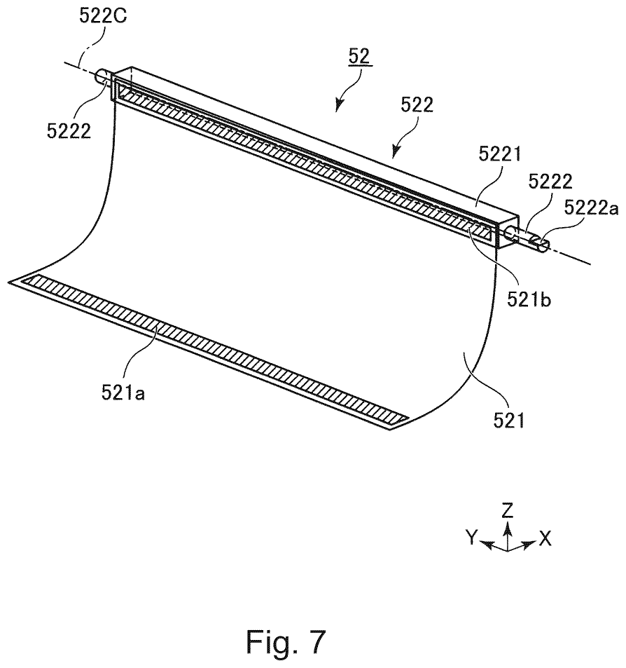

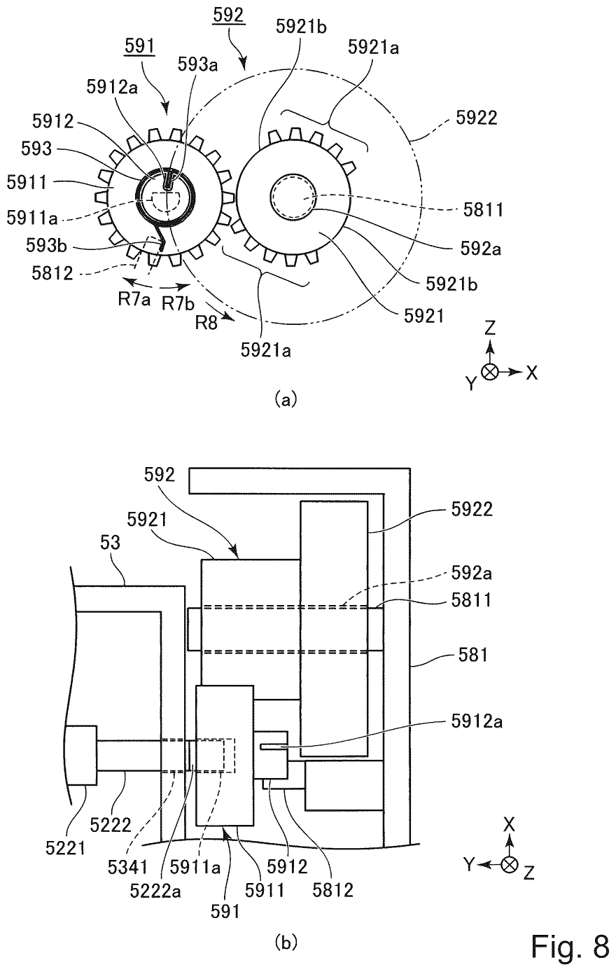

Next, using FIGS. 5 to 7, the supplying mechanism 52 in this embodiment will be described. FIG. 7 is a schematic perspective view of the supplying mechanism 52 in this embodiment. The supplying mechanism 52 includes a supplying sheet 521 which is a sheet portion as a supplying member and a holding shaft 522 as a sheet holding member.

The supplying sheet 521 is constituted by a flexible sheet-like member which is long (long length) in one direction and which has a substantially rectangular shape in plan view, and is disposed so that a longitudinal direction thereof extends along the Y axis direction. A length of the supplying sheet 521 is set to a length of an inside region of the developing container 53 substantially over an entire area thereof in the Y axis direction. The supplying sheet 521 is fixed to the inner wall of the developing container 53 in a fixing portion (first portion) 521a which is a surface of one end portion thereof with respect to a widthwise direction substantially perpendicular to a longitudinal direction thereof, and is bonded (fixed) to the holding shaft 522 in a bonding portion (second portion) 521b which is a surface of the other end portion. In this embodiment, the image form portion 521a is fixed to the inner wall of the developing container 53 substantially over an entire area of a width of the supplying sheet 521 in the Y axis direction by a double-side tape. Further, in this embodiment, the bonding portion 521b is bonded to the holding shaft 522 substantially over an entire area of a width of the supplying sheet 521 in the Y axis direction by the double-side tape. Incidentally, depending on a constitution of the image forming apparatus 1, the fixing portion 521a may also be fixed to the image forming apparatus main assembly 1a.

In this embodiment, as the supplying sheet 521, a polycarbonate sheet having a thickness of 150 μm was used. Incidentally, a material of the supplying sheet 521 is not limited thereto. As the supplying sheet 521, a sheet made of resin such as polycarbonate, PET (polyethylene telephthalate), PPS (polyphenylenesulfide), or Kapton (trade name of extremely heat and cold resistant polyimide film), a sheet made of a rubber such as urethane rubber, or a sheet made of metal such as SUS may also be used. Further, when the sheet has sufficient flexibility, a thickness of the sheet can be appropriately set. Further, the fixing portion 521a is not limited to that fixed to the developing container 53, but may also be fixed to the regulating blade 54, for example. Further, the fixing portion 521a is not limited to that fixed to the developing container 53 or the like by the double-side tape, but may also be fixed by bonding, welding, or the like. Further, the fixing portion 521a is not required to be closely fixed to the developing container 53 or the like by the double-side tape, the welding or the like, but may only be required not to be free by being separated (detached) from the developing container 53 or the like when the supplying sheet 521 is moved (deformed) as described later. For that reason, the supplying sheet 521 is provided with, for example, a hole portion (portion-to-be-engaged) as the fixing portion 521a, and the developing container 53 is provided with, for example, a projected portion (engaging portion) having a folding-back, and then this projected portion is engaged in the hole portion, whereby the supplying sheet 521 may be held by the developing container 53.

The holding shaft 522 includes a holding portion 5221 of which cross section in the XZ plane has a substantially square columnar shape and a cylindrical rotation shaft portion 5222 provided in each of opposite end portions of the holding portion 5221 with respect to a rotational axis direction of the holding shaft 522. To one of four surfaces of the holding portion 5221, the bonding portion 521b of the supplying sheet 521 is bonded by the double-side tape. Of the rotation shaft portions 5222 on the opposite end portion sides with respect to the Y axis direction, the rotation shaft portion 5222 on the Y axis negative side is provided with a cut-away portion 5222a, and with this cut-away portion 5222a, a supplying member gear 591 (parts (a) and (b) of FIG. 8) described later is engaged. By this, the holding shaft 522 is capable of being rotated, about a rotational axis 522c extending in the Y axis direction, in an arrow R7a direction (clockwise direction) and an arrow R7b direction (counterclockwise direction). Incidentally, in the respective views, the arrow R7a direction shows a rotational direction in which the supplying sheet 521 is changed from a state (first state described later) in which flexure is relatively large toward a state (second state described later) in which the flexure is relatively small. Further, in the respective views, the arrow R7b direction shows a rotational direction in which the supplying sheet 521 is changed from the state (the second state described later) in which the flexure is relatively small toward the state (the first state described later) in which the flexure is relatively large. The developing container 53 is provided with a holding shaft supporting hole portion 5341 (part (b) of FIG. 8) in each of opposite sides with respect to the Y axis direction. The holding shaft 522 is mounted to the holding container 53 by being rotatably supported in the holding shaft supporting hole portion 5341 at the rotation shaft portion 5222 thereof in each of the opposite end portions with respect to the Y axis direction. By this, a positional relationship between the developing container 53 and the holding shaft 522 is defined.

Incidentally, the bonding portion 521b is not limited to that fixed to the holding shaft 522 by the double-side tape, but may also be fixed by bonding, welding, or the like. Further, the bonding portion 521b is not required to be closely fixed to the holding shaft 522 by the double-side tape, the welding, or the like, but may only be required not to be free by being separated (detached) from the holding shaft 522 when the supplying sheet 521 is moved (deformed) as described later. For that reason, the supplying sheet 521 is provided with, for example, a hole portion (portion-to-be-engaged) as the bonding portion 521b, and the holding shaft 522 is provided with, for example, a projected portion (engaging portion) having a folding-back, and then this projected portion is engaged in the hole portion, whereby the supplying sheet 521 may be held by the holding shaft 522.

As shown in FIG. 5, in this embodiment, the supplying sheet 521 is provided to the developing mechanism 52 with a predetermined flexure. That is, in this embodiment, in the XZ plane, a length of the supplying sheet 521 excluding the fixing portion 521a and the bonding portion 521b is set longer than a length of a rectilinear line connecting two points consisting of a position of the fixing portion 521a fixed to the developing container 53 (i.e., a position, in the developing container 53, where the fixing portion 521a is fixed) and a position of the bonding portion 521b bonded to the holding shaft 522 (i.e., a position of the holding shaft 522 defined as described above). The supplying sheet 521 is curved convexly toward a side opposite from the surface of the developing roller 51. As specifically described later, the holding shaft 522 is rotated in the arrow R7a direction, so that the supplying sheet 521 in a flexed state is tightened (a degree of the flexure of the supplying sheet 521 decreases). That is, the supplying sheet 521 is moved (deformed) so that at least a part thereof approaches the surface of the developing roller 51. By this, the toner in the developing container 53 (specifically, in a supplying region 53b described later) is supplied to the receiving surface 51a of the developing roller 51.

Further, as shown in FIG. 5, an inside space of the developing container 53 is partitioned by the supplying sheet 521. Here, a space on a developing roller side relative to the supplying sheet 521 is defined as the “supplying region 53g”. On the other hand, a space on a side opposite from the supplying region 53b relative to the supplying sheet 521 is defined as a “rear surface-side region 53d”. As specifically, described later, the toner accommodated in the supplying region 53g is supplied to the receiving surface 51a of the developing roller 51 by the supplying mechanism 52. By this, an amount of the toner carried on the surface of the developing roller 51 is further stabilized.

Next, using FIG. 9, a driving constitution (driving mechanism) of the supplying mechanism 52 (holding shaft 522) will be described. FIG. 8 shows a gear train for driving the supplying mechanism 52, wherein part (a) of FIG. 8 is a schematic sectional view of the gear train as viewed in the XZ flat plane (cross section perpendicular to the Y axis direction), and part (b) of FIG. 8 is a schematic sectional view of the gear train as viewed in the XY flat plane (cross section perpendicular to the Z axis direction).

The developing unit 50 is provided with a supplying member gear 591, an idle gear 592, and an urging spring 593.

The idle gear 592 is a two-stage gear in which a partially-toothless gear portion 5921 and an input receiving gear portion 5922 are integrally provided. The idle gear 592 is mounted to the developing unit 50 by being supported at the input receiving hole portion 592a, provided in a center thereof, by a supporting shaft 5811 provided in a side cover 581. The side cover 581 is mounted to a side portion of the developing container 53 on the Y axis negative side. The input receiving gear portion 5922 is disposed in the idle gear 592 on the Y axis negative side, and a driving force is transmitted from a development driving gear (not shown) to the input receiving gear portion 5922, so that the idle gear 592 is rotated in an arrow R8 direction (counterclockwise direction). The partially-toothless gear 5921 is disposed in the idle gear 592 on the Y axis positive side, and on a peripheral surface thereof, a gear portion 5921a and a cut-away portion 5921b are provided. Further, to the idle gear 592, a supplying member clutch mechanism 176a (FIG. 4) is connected. The controller 150 is capable of controlling whether or not the driving force from the development driving gear is transmitted to the idle gear 592. The supplying member clutch mechanism 176a and the development driving gear constitute the supplying member driving portion 176.

The supplying member gear 591 includes a gear portion 5911 and a projected portion 5912. The supplying member gear 591 is mounted to the supplying mechanism 52 by being mounted at the gear portion 5911 thereof to the rotation shaft 5222 provided to the holding shaft 522 of the supplying mechanism 52. The supplying member gear 591 transmits the driving force to the holding shaft 522 by engagement of an engaging portion 5911a thereof provided to the gear portion 5911 with the cut-away portion 5222a provided on the rotation shaft portion 5222 of the holding shaft 522.

The gear portion 5911 is disposed so as to be connectable with the partially-toothless gear portion 5921 of the idle gear 592. The supplying gear 591 is rotated in the arrow R7a direction (clockwise direction) with rotation of the idle gear 592 in the arrow R8 direction. Further, on the Y axis negative side of the supplying member gear 591, the cylindrical projected portion 5912 is disposed, and on a part of a peripheral surface of the projected portion 5912, a cut-away portion 5912a is formed.

The urging spring 593 is constituted by a torsion coil spring which is an urging member as an urging means, and includes an engaging portion 593a in one end portion thereof and a portion-to-be-held 593b in the other end portion thereof. The urging spring 593 is disposed so as to cover a periphery of the projected portion 5912 of the supplying member gear 591. The engaging portion 593a of the urging spring 593 is engaged with the cut-away portion 5912a formed on the projected portion 5912 of the supplying member gear 591. On the other hand, the portion-to-be-held 593b of the urging spring 593 is held by a holding portion 5812 provided in the side cover 581.

The idle gear 592 is rotated in the arrow R8 direction, and when the gear portion 5921a of the idle gear 592 engages with the gear portion 5911 of the supplying member gear 591, the supplying member gear 591 is rotated in the arrow R7a direction. The engaging portion 593a of the urging spring 593 engages with the cut-away portion 5912a formed on the projected portion 5912 of the supplying member gear 591. For that reason, with rotation of the supplying member gear 591, the engaging portion 593a of the urging spring 593 is also rotated in the arrow R7a direction. On the other hand, the portion-to-be-held 593b of the urging spring 593 is held by the holding portion 5812. For that reason, with rotation of the supplying member gear 591, the urging spring 593 becomes a state in which elastic energy is accumulated. When the idle gear 592 is further rotated and the cut-away portion 5921b of the idle gear 592 opposes the supplying member gear 591, the supplying member gear 591 does not engage with the idle gear 591. By this, on the supplying member gear 591, power for rotating the supplying member gear 591 in the arrow R7a direction does not act, and therefore, by the elastic energy accumulated in the urging spring 593, the supplying member gear 591 is urged in the arrow R7b direction. Thereafter, the idler gear 592 is further rotated, and the gear portion 5921a of the idle gear 592 engages with the gear portion 5911 of the supplying member gear 591, so that the supplying member gear 591 is rotated again in the arrow R7a direction.

In this embodiment, by the constitution as described above, the holding shaft 522 of the supplying mechanism 52 is made rotatable in both the arrow R7a direction and the arrow R7b direction. Incidentally, the constitution in which the holding shaft 522 is made rotatable is not limited to the constitution as described above, fur for example, depending on a constraint such as a shape or the like of the developing container 53, can be appropriately selected. For example, another gear may also be further provided between the supplying member gear 591 and the idle gear 592. Further, for example, a constitution in which the urging spring 593 is engaged with the holding shaft 522, not the supplying member gear 591 may also be employed.

### Stirring of Toner by Rotation of Rotary Main Body

Next, a method of stirring the toner in the developing unit 50 in this embodiment will be described. As shown in FIG. 5, the developing unit 50 in this embodiment is not provided with a particular member for stirring the toner accommodated in the developing container 53. In this embodiment, by rotation of the rotary main body 90, stirring of the toner in the developing unit 50 is performed. Specifically, as described later, with the rotation of the developing roller 51 in the image forming operation, the toner existing in the supplying region 53g is gradually agglomerated weakly, so that flowability of the toner lowers. On the other hand, a stirring operation of the toner in the developing unit 50 by the rotation of the rotary main body 90 is performed, so that the flowability of the toner existing in the supplying region 53g can be put again in a high state.

Using FIG. 9, the stirring operation of the toner in the developing unit 50 in this embodiment will be described. FIG. 9 includes schematic sectional views each of the developing unit 50 and peripheral members thereof.

Incidentally, in FIG. 9, for explanation, as regards the developing units 50 and the toner cartridge 70, only those for one color are shown. Further, parts (a) to (i) of FIG. 9 show respective states when the rotary main body 90 is rotated in the arrow R2 direction by 45° in an order from the state of part (a) of FIG. 9. The state of part (a) of FIG. 9 shows a state immediately after a developing period (specifically described later) in which the electrostatic latent image on the photosensitive drum 2 is developed. Then, in each of the states of parts (c), (e), and (g) of FIG. 9 in which the rotary main body 90 is further rotated in the arrow R2 direction by 90° from the state of parts (a), (c), and (e), respectively, a developing operation (developing step) with the toner of associated color is performed. Thereafter, by further rotating the rotary main body 90 in the arrow R2 direction by 90° (from the state of part (g) of FIG. 9), the state of the rotary main body 90 becomes the state of part (i) of FIG. 9 which is the same state as the state of part (a) of FIG. 9. In the following, each of the states shown in FIG. 9 is referred to by using an angle of rotation of the rotary main body 90 from the state of part (a) of FIG. 9 in the arrow R2 direction in some instances. For example, the state of part (d) of FIG. 9 is referred to as a “rotated state by 135°” in some instances. Further, FIG. 9 is divided into FIG. 9A, FIG. 9B, and FIG. 9C for convenience, but description will be made by using figure numerals or symbols of part (a) of FIG. 9 to part (i) of FIG. 9 shown in FIGS. 9A to 9C.

Further, the toner accommodated in each developing unit 50 and each toner cartridge 70 is collectively referred to as “toner T”. Here, in FIG. 9, as the toner T, two types including a black circle and a white circle are indicated. The toner T existing in the supplying region 53g in the state (state immediately after the developing period is ended) of part (a) of FIG. 9 is indicated by the black circle, and the toner T existing in the rear surface-side region 53d or the toner cartridge 70 in the state of part (a) of FIG. 9 is indicated by the white circle. The toner T indicated by the black circle is defined as “charge toner Tc”. Further, the toner T indicated by the white circle is defined as “discharged toner Tn”. Specifically, as described later, the charged toner Tc is the toner T in a state in which a surface electric charge is higher than that of the discharged toner Tn. Further, the discharged toner Tn is the toner T which is an unused article or in a state in which the toner is (electrically) discharged to some degree. As regards the toner T existing in the surface region 53g is hard to be agglomerated and is high in flowability with an increasing proportion of the discharged toner Tn.

First, in the state of part (a) of FIG. 9, as regards the toner T existing in the supplying region 53b, a proportion of the charged toner Tc is more than the proportion of the discharged toner Tn (typically, the toner T is occupied by the charged toner Tc). This is because as specifically described later, in a state in which the developing rotary 100 is in the development attitude, the surface electric charge of the toner T in the supplying region 53g gradually becomes high by frictional slide of the toner T principally in a contact portion between the developing roller 51 and the regulating blade 54. On the other hand, also in the state of part (a) of FIG. 9, as regards the toner T existing in the rear surface-side region 53d, the proportion of the discharged toner Tn is more than the proportion of the charged toner Tc (typically, the toner T is occupied by the discharged toner Tn).

Thereafter, the developing roller 51 is separated from the photosensitive drum 2, and the rotary main body 90 is rotated in the arrow R2 direction. By this, the state of the rotary main body 90 becomes a rotated state by 90° of part (c) of FIG. 9 through a rotated state by 45° of part (b) of FIG. 9. At that time, a part of the charged toner Tc existing in the supplying region 53g in the state of part (a) of FIG. 9 is moved toward the rear surface-side region 53d by gravitation exerted thereon on the Z axis negative side. Further, at that time, gravitation acts on the weight portion 55b of the backflow preventing member 55, so that the openable portion 55a of the backflow preventing member 55 contacts the inner wall of the developing container 53. By this, back flow of the toner T from the developing container 53 toward the toner cartridge 70 is prevented.

Thereafter, the rotary main body 90 is further rotated in the arrow R2 direction, the state of the rotary main body 90 becomes a rotated state by 180° of part (e) of FIG. 9 through a rotated state by 135° of part (d) of FIG. 9. At that time, a part of the discharged toner Tn existing in the rear surface-side region 53d in the state of part (a) of FIG. 9 is moved toward the supplying region 53g by gravitation. Thereafter, in a rotated state by 225° of part (f) of FIG. 9, almost all of the discharged toner Tn existing in the rear surface-side region 53d in the state of part (a) of FIG. 9 becomes a state in which the discharged toner Tn is conveyed toward the supplying region 53g.

Thereafter, the main body 90 is further rotated in the arrow R2 direction, so that the state of the rotary main body 90 becomes a rotated state by 315° of part (h) of FIG. 9 through a rotated state by 270° of part (g) of FIG. 9. At that time, by gravitation exerted on the weight portion 55b of the backflow preventing member 55, the openable portion 55a of the backflow preventing member 55 becomes again the state in which the openable portion 55a is separated from the inner wall of the developing container 53. By this, it becomes possible that the discharged toner Tn accommodated in the toner cartridge 70 is moved toward the developing container 53. At least a part of the discharged toner Tn moved from the toner cartridge 70 toward the developing container 53 is moved toward the supplying region 53g. Thereafter, the rotary main body 90 is further rotated in the arrow R2 direction, so that the state of the rotary main body 90 becomes a rotated state by 360° of part (i) of FIG. 9.

Thus, in a period in which the rotary main body 90 is rotated from the state of part (a) of FIG. 9 by 360°, the discharged toner Tn is conveyed from the toner cartridge 70 toward the supplying region 53g, and in addition, the discharged toner Tn existing in the rear surface-side region 53d is also conveyed toward the supplying region 53g. At that time, in the case where the toner T enough to sufficiently fill the supplying region 53g exists inside the developing container 53, the toner T which is not accommodated in the supplying region 53g is conveyed toward the rear surface-side region 53d.

Further, by a series of rotation operations shown in part (a) of FIG. 8 to part (i) of FIG. 9, the toner T accommodated in the developing container 53 becomes a stirred state. For that reason, in the rotated state by 360° of part (i) of FIG. 9, in the supplying region 53g and the rear surface-side region 53d, a state in which the charged toner Tc and the discharged toner Tn are mixed with each other is formed. Further, as specifically described later, there is a tendency that the toner T existing in the supplying region 53g is pressed and hardened with the rotation of the developing roller 51. On the other hand, by performing the stirring operation as described above, the toner T existing in the supplying region 53g can be returned again to a state in which flowability of the toner T is high.

### Supply of Toner to Surface of Developing Roller

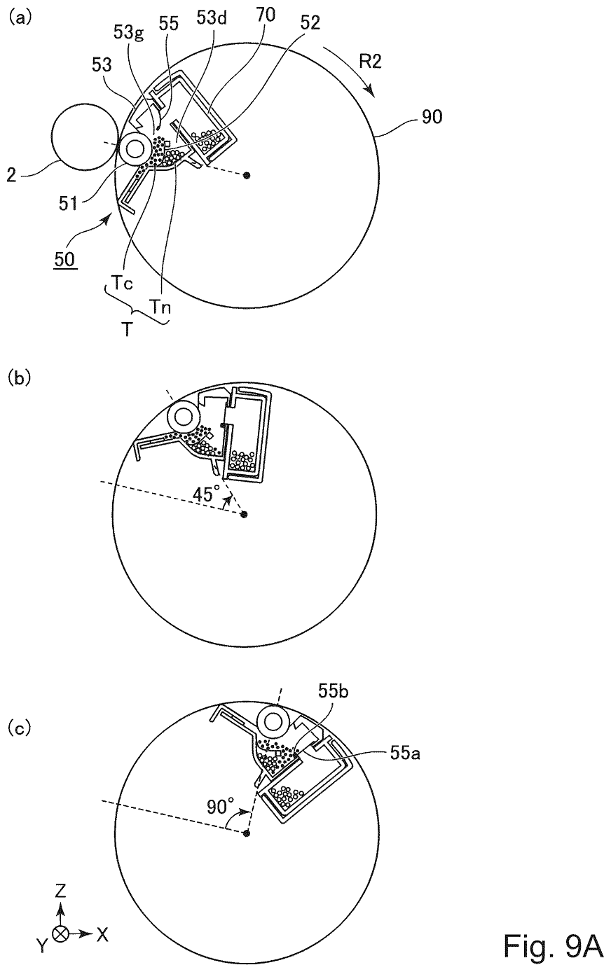

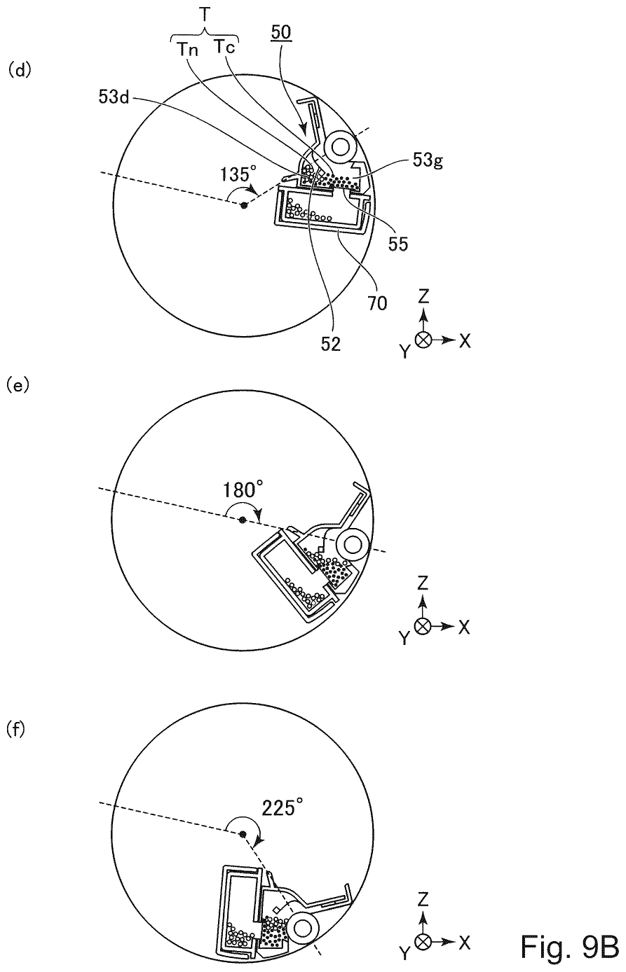

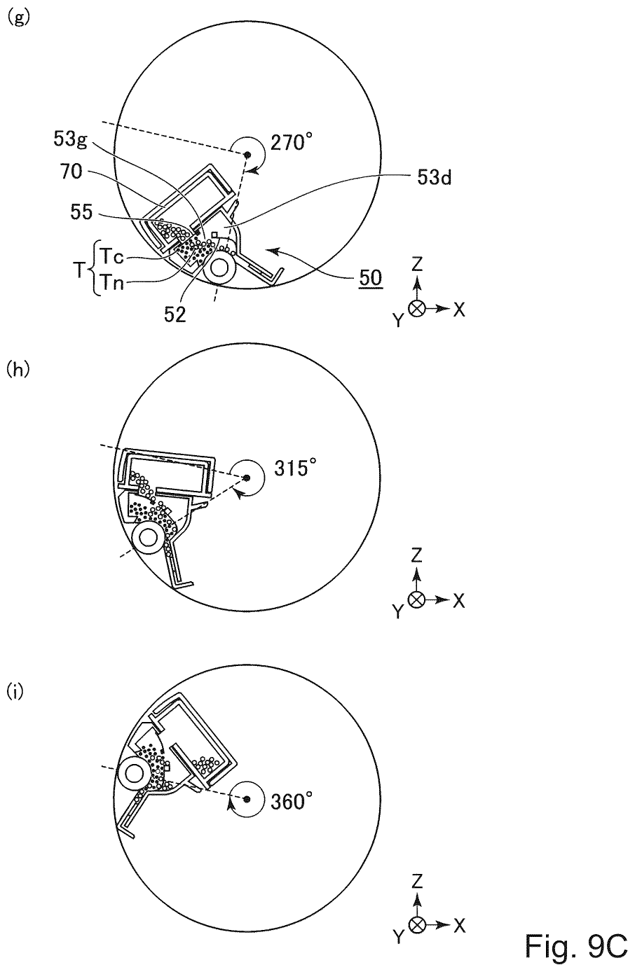

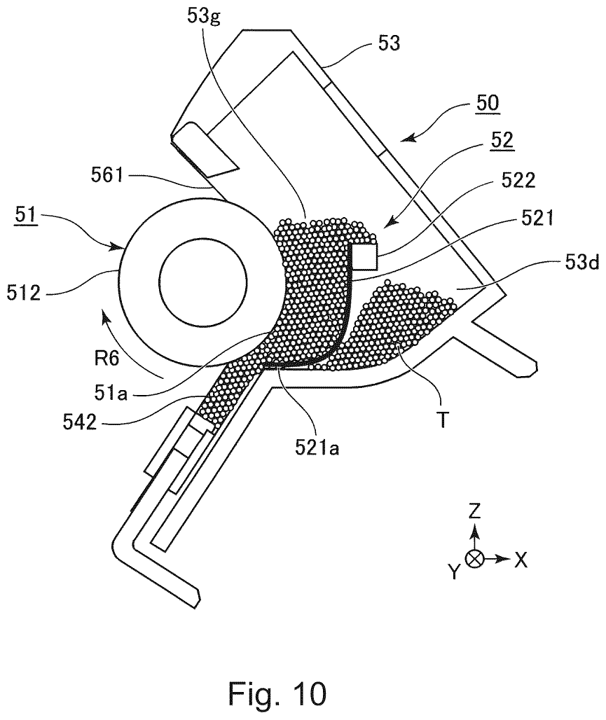

Next, using FIGS. 10 to 13, supply of the toner T toward the surface of the developing roller 51, specifically to the (toner) receiving surface 51a of the developing roller 51 will be described.

### Description of States of FIG. 10 to FIG. 13

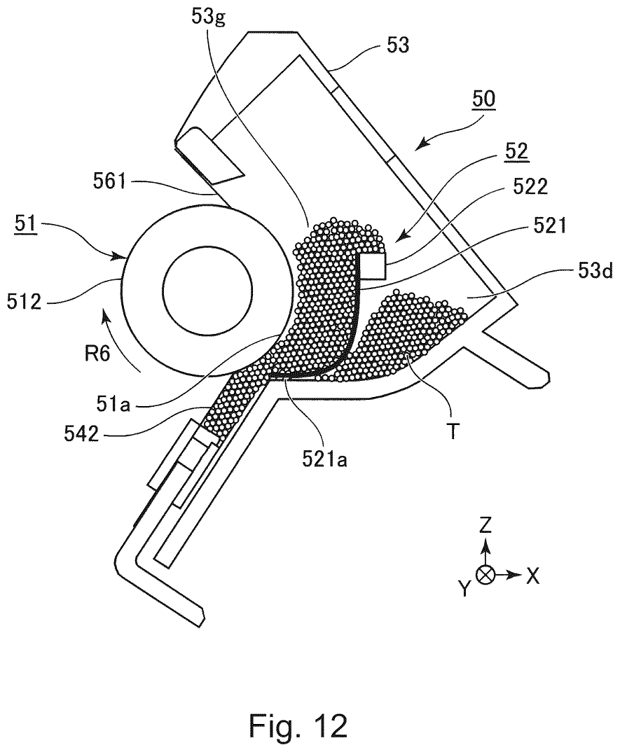

Each of FIGS. 10 to 13 is a schematic sectional view of the developing unit 50 or a part thereof, and shows a state, as shown in part (c) of FIG. 2, in which the developing rotary 100 is put in the development attitude and in which the developing roller 51 is disposed in the developing position. Further, in FIGS. 10 to 13, the toner T in a predetermined is accommodated in the developing container 53. Incidentally, the toner T illustrated in, for example, FIG. 10 or FIG. 12, is illustrated in a deformation manner such that each toner T is enlarged with a magnification of about 100 times- 1000 times with respect to a ratio of an actual size of each toner T to an actual size of the developing unit 50. Incidentally, as regards the above-described numerical range (about 100 times-1000 times), “-” shows a range including numerical values before and after “-”.

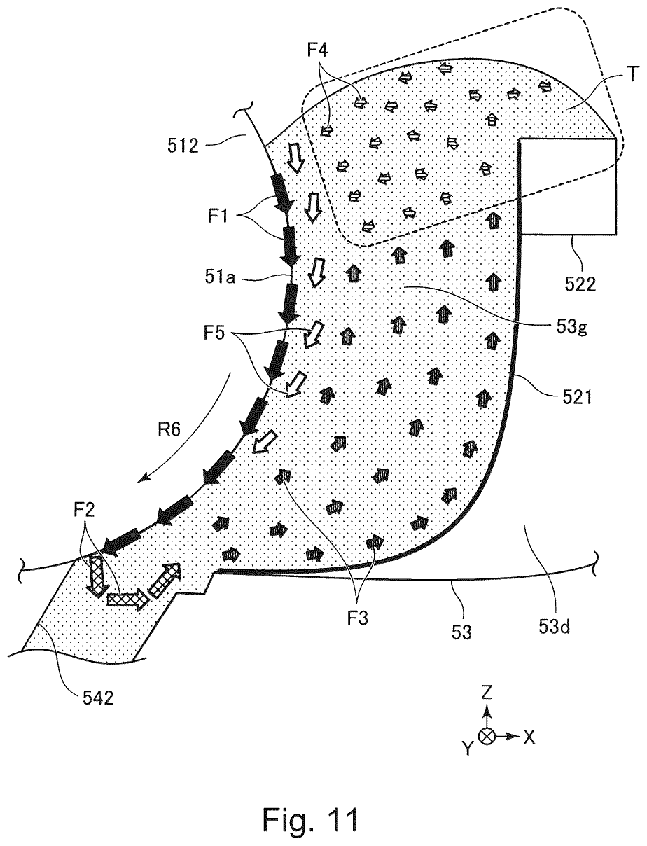

FIG. 10 shows a state after the developing roller 51 is disposed in the developing position where the developing roller 51 is contacted to the photosensitive drum 2 by the rotating operation (switching operation) of the rotary main body 90 and before a developing period (specifically described later) in which the electrostatic latent image on the photosensitive drum 2 is developed starts. In this state, the toner T accommodated in the developing container 53 is not agglomerated weakly by the rotation of the rotary main body 90, and is in a state in which flowability of the toner T is high. Further, FIG. 11 is a schematic sectional view showing circulation of the toner T in the supplying region 53g in a state immediately after the rotation of the developing roller 51 in the arrow A6 direction is started after a timing when the developing unit 50 is put in the state of FIG. 10. The supplying region 53g is formed by the developing roller 51 and the supplying sheet 521.

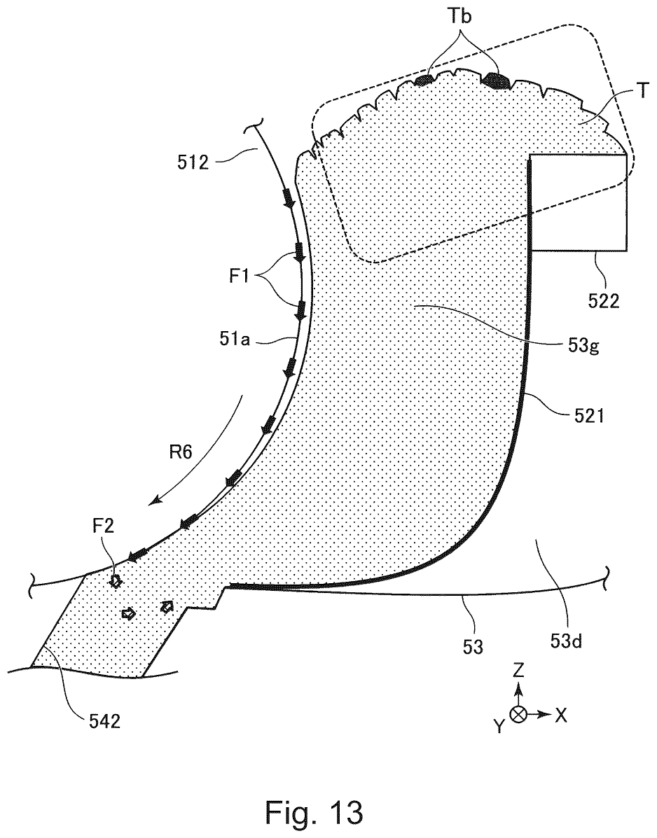

On the other hand, FIG. 12 shows a state after the developing operation of the electrostatic latent image on the photosensitive drum 2 is performed without moving (deforming) the supplying sheet 521 while the developing unit 50 is kept in the state shown in FIG. 10. Incidentally, the states in FIG. 10 and FIG. 12 are substantially the same state (first state described later) as the state of the supplying sheet 521 in FIG. 5. Further, FIG. 13 is a schematic sectional view showing circulation of the toner T in the supplying region 53g in the state shown in FIG. 12.

As specifically described later, in the state shown in FIG. 12 and FIG. 13, in the neighborhood of the surface of the developing roller 51, the toner T forms a (developer) wall surface extending along an arc of the surface of the developing roller 51. By this, the toner T contacting the surface of the developing roller 51, i.e., the (toner) receiving surface 51a of the developing roller 51 is decreased in amount compared with the state shown in FIG. 10 and FIG. 11. In other words, in the state of FIG. 12 and FIG. 13, an area of the receiving surface 51a to which the toner T is supplied is decreased compared with an area in the state shown in FIG. 10 and FIG. 11.

### Case where Flowability of Toner is High (FIG. 10 and FIG. 11)

First, a state (state immediately before the start of the developing period) in which the flowability of the toner T is high by the rotation of the rotary main body 90, shown in FIG. 10 and FIG. 11 will be further described.

As shown in FIG. 11, when the image formation (development) is carried out, by the rotation of the developing roller 51 in the arrow A6 direction, for the toner T in the developing unit 50, a flow thereof in a direction indicated by arrows F1, F2, F3, F4 and F5 occurs.

First, the toner T carried on the developing roller 51 flows in the arrow F1 direction. At that time, the toner T is deposited in about 1 to 10 layers on the surface of the developing roller 51. In this embodiment, an average particle size of the toner T is 7 μm. For that reason, a layer thickness of the toner T moved in the arrow F1 direction with the rotation of the developing roller 51 is slightly less than 100 μm even when being estimated as a larger value.

The toner T carried on the surface of the developing roller 51 is regulated to a predetermined amount by the regulating plate 542 of the regulating blade 54. Incidentally, in this embodiment, the toner T on the surface of the developing roller 51 is regulated in layer thickness to 1 to 3 layers. By this, of the toner T carried on the surface of the developing roller 51, the toner T regulated by the regulating plate 542 flows in the arrow F2 direction so as to be separated from the surface of the developing roller 51. At that time, in a space, between the regulating plate 542 and the inner wall of the developing container 53, positioned on a lower side (Z axis negative side) of a contact portion between the developing roller 51 and the regulating plate 542 with respect to the vertical direction, the toner in a predetermined amount has already existed and forms an immobile layer.

For that reason, during the image formation, the toner T moved in the arrow F1 direction flows in the arrow F2 direction so as to be repelled by this immobile layer. On the other hand, of the toner carried by the developing roller 51, the toner T passing through the contact portion between the developing roller 51 and the regulating plate 542 is charged to a more negative polarity side at a surface thereof by frictional slide thereof in a contact portion between the rubber layer 512 of the developing roller 51 and the regulating plate 542. Further, into the surface of the toner T, an electric charge is injected by a blade bias applied to the developing blade 54. That is, the toner T passed through the contact portion between the developing roller 51 and the regulating plate 542 has a surface electric charge higher than a surface electric charge of the toner T accommodated in the supplying region 53g. Further, the toner T passed through the contact portion between the developing roller 51 and the regulating plate 542 passes through a contact portion between the developing roller 51 and the sealing sheet 561 and is conveyed again toward the supplying region 53g except for a part thereof corresponding to the toner T moved to the surface of the photosensitive drum 2.

Next, the toner repelled by the above-described immobile layer flows in the arrow F3 direction while gradually expanding along the supplying sheet 521. That is, the flow of the toner T is widely dispersed into the supplying region 53g, and even in a portion close the developing roller 51, the toner T flows toward an upper side (Z axis positive side) with respect to the vertical direction. At that time, the toner T conveyed in the arrow F2 direction flows so as to push out the toner T existing in the supplying region 53g, and a flowing speed of the flow of the toner T in the arrow F3 direction becomes slower than each of a flowing speed of the flow of the toner T in the arrow F1 direction and a flowing speed of the flow of the toner T in the arrow F2 direction.

Thereafter, in the neighborhood of a developer (toner) surface of the toner T on the upper side (Z axis positive side) of the supplying region 53g with respect to the vertical direction (i.e., in a broken line portion in FIG. 11), the flow of the toner T is diffused in the arrow F4 direction. That is, the toner T reached the developer surface thereof loses a propulsive force toward the upper side (Z axis positive side) with respect to the vertical direction, so that most of the toner T flows toward a developing roller side (X axis negative side by being dragged by the flow of the toner T, carried on the surface of the developing roller 51, in the arrow F1 direction. With this flow, the toner T inside (Z axis negative side) the developer surface also flows toward the developing roller 51 side, so that a flow of the toner T such that the toner T is swirled in the neighborhood of the developer surface occurs.

Then, by the flow of the toner T in the arrow F4 direction, the toner T conveyed to the neighborhood of the surface of the developing roller 51 flows in the arrow F5 direction. That is, by the flow in the arrow F1 direction of the toner T carried on the surface of the developing roller 51, the above-described toner T flows along the rotational direction (arrow R6 direction) of the developing roller 51 while moving toward the surface of the developing roller 51. At this time, on the surface of the developing roller 51, in many cases, the toner T passed through the contact portion between the developing roller 51 and the regulating plate 542 of the regulating blade 54 is carried as described above. Incidentally, in the case where most of the toner T on the surface of the developing roller 51 is used for developing the electrostatic latent image on the photosensitive drum 2, at that time, the toner T carried on the surface of the developing roller 51 is relatively small in amount in some instances. Further, the toner T passed through the contact portion between the developing roller 51 and the regulating plate 542 has the surface electric charge higher than the surface electric charge of the toner T accommodated in the supplying region 53g by the frictional slide and the blade bias as described above. By this surface electric charge, the toner T accommodated in the supplying region 53g is electrostatically attracted toward the surface of the developing roller 51.

Incidentally, this electrostatic force does not act onto a wide range. That is, this electrostatic force does not have an influence widely onto the supplying sheet 521 side (X axis positive side) of the supplying region 53g. For that reason, of the flow of the toner T in the arrow F4 direction, the propulsive force toward the developing roller 51 side (X axis negative side) is only to a degree such that a space formed in the neighborhood of the developing roller 51 is filled with the toner T. That is, the toner only flows to a degree such that the toner T fills the space of the toner T flowed along the rotational direction (arrow R6 direction) of the developing roller 51, by the flows of the toner T in the arrow F1 direction and the arrow F5 direction. That is, this electrostatic force does not positively presses the toner T in entirety of the supplying region 53g toward the surface side (X axis negative side) of the developing roller 51.

### Case where Control of Supplying Mechanism is Not Carried Out (FIG. 12 and FIG. 13)

Next, a state after the developing operation of the electrostatic latent image on the photosensitive drum 2 is performed without moving (deforming) the supplying sheet 521 while the developing unit 50 is kept in the state of FIG. 10 (i.e., state immediately after the developing period is ended) will be further described.

As shown in FIG. 13, in this state, as regards the toner T in the developing unit 50 the flows in the directions indicated by the arrows F3, F4, and F5 in FIG. 11 do not occur in some instances. Further, in this state, in the neighborhood of the surface of the developing roller 51, the toner T forms a wall surface extending along the arc of the surface of the developing roller 51 in some instances. By this, the toner T contacting the surface of the developing roller 51, i.e., the receiving surface 51a decreases compared with that in the state shown in FIG. 11.

In other words, in the state of FIG. 13, an area of the receiving surface 51a to which the toner T is supplied decreases compared with that in the state shown in FIG. 11.

First, as described above, in the supplying region 53g, the toner T flows in a manner such that the toner T is pushed out by adjacent toner T. For that reason, with circulation of the toner T in the developing unit 50 by the rotation of the developing roller 51, the toner T existing in the supplying region 53g is arranged gradually densely.

In addition, in general, the toner T used in the image forming apparatus of the electrophotographic type does not have high flowability such as flowability of water, and flows in a weakly agglomerated state to some extent by an electrostatic force and a non-electrostatic force. Further, as described above, the toner T passed through the contact portion between the developing roller 51 and the regulating plate 542 of the developing blade 54 has the higher surface electric charge. For that reason, with the circulation of the toner T in the developing unit 50 by the rotation of the developing roller 51, as regards the toner T existing in the supplying region 53g, a proportion of the toner T having the higher surface electric charge increases, and thus is more liable to electrostatically agglomerate.

By these behaviors, with the rotation of the developing roller 51 in the image forming operation, the toner T existing in the supplying region 53g gradually agglomerate densely and is in a state in which the flowability thereof lowers. As a result, particularly, in the neighborhood of the developer (toner) surface of the toner T (in a broken line portion in FIG. 13), a toner block Tb having a wall surface with a macroscope size in the order of several mm to several cm is observed. The toner block Tb in such an agglomerated state is not collapsed by gravitation, so that the toner block Tb becomes a state in which a wall surface having an angle close to verticality than angle of repose is formed.

Thus, at a point of time, before the developing period is started, shown at least in FIG. 10 and FIG. 11, the toner T in the supplying region 53g is stirred by the rotation of the rotary main body 90, and is put in a state in which the flowability thereof is high. Further, with the rotation of the developing roller 51 in the image forming operation, the toner T is pressed and hardened and the toner T is electrostatically agglomerated, whereby the flowability of the toner T in the supplying region 53g gradually lowers. By this, at a point of time, after the developing period is ended, shown in FIG. 12 and FIG. 13, the toner T in the supplying region 53g becomes a state in which the toner T is weakly agglomerated to some extent such that the toner block Tb is formed in the neighborhood of the developer surface (in the broken line portion in FIG. 13).

That is, in a period from the start of the developing period until the toner T reaches the stage in which the developing period is ended, the toner T flowing in the arrow F4 direction and the arrow F5 direction shown in FIG. 11 flows in the weakly agglomerated state. For that reason, the toner T hardened in a block shape to some extent is conveyed toward the surface of the developing roller 51. Further, in the case where the toner T is such a weakly agglomerated state is on exposure to the flow in the arrow F1 direction, entirety of the toner T hardened in the block shape is not always conveyed by the flow in the arrow F1 direction, but there is a case where only a part of the weakly agglomerated toner T is scraped off by the flow in the arrow F1 direction in some instances. Such a phenomenon is repeated, whereby as shown in FIG. 13, in the neighborhood of the surface of the developing roller 51, the weakly agglomerated toner T stagnates (stays with a gap between itself and the surface of the developing roller 51). As a result, the toner T existing in the supplying region 53g forms a wall surface larger in radius of curvature than the outer peripheral surface of the developing roller 51 by a length corresponding to a distance equal to a thickness of the toner layer carried on the surface of the developing roller 51. For that reason, in the state shown in FIG. 12 and FIG. 13, the toner T contacting the surface of the developing roller 51, i.e., the receiving surface 51a decreases in amount compared with that in a state immediately after the toner is stirred by rotational movement of the rotary main body 90 shown in FIG. 10 and FIG. 11. Then, the toner T is not supplied to the receiving surface 51a, whereby as shown in FIG. 13, the toner T is not circulated in the supplying region 53g in some instances.

In such a state, for example, in the case where an image in which a region with a high print ratio is continued is formed, an amount of the toner T supplied to the receiving surface 51a of the developing roller 51 becomes insufficient, so that a white void occurs in some instances.

### Example of Constitution in Which White Void is Capable of Occurring

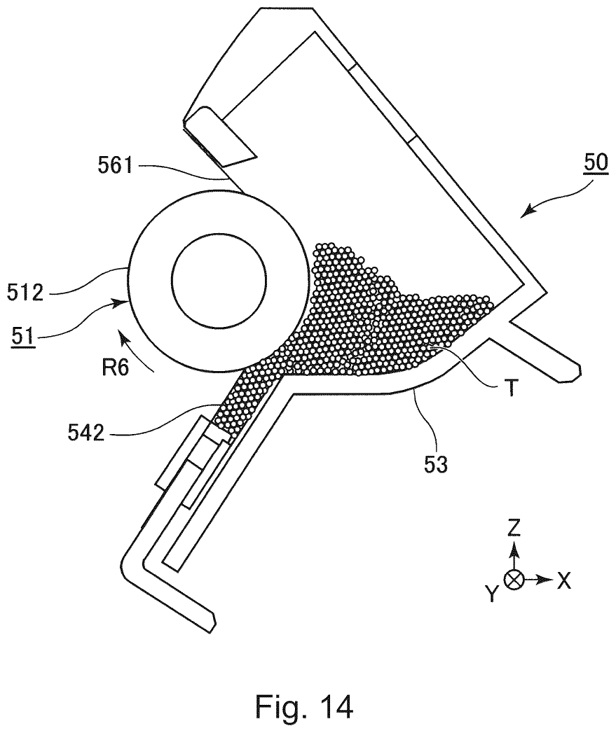

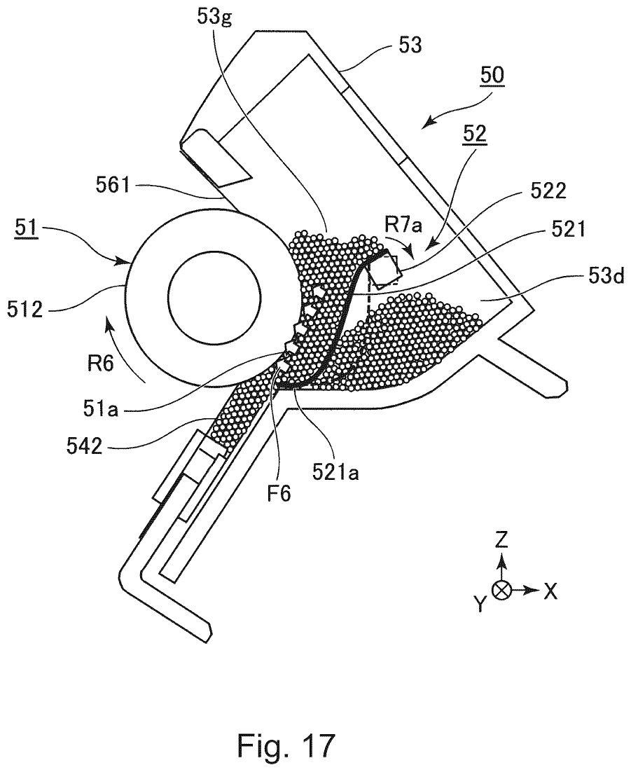

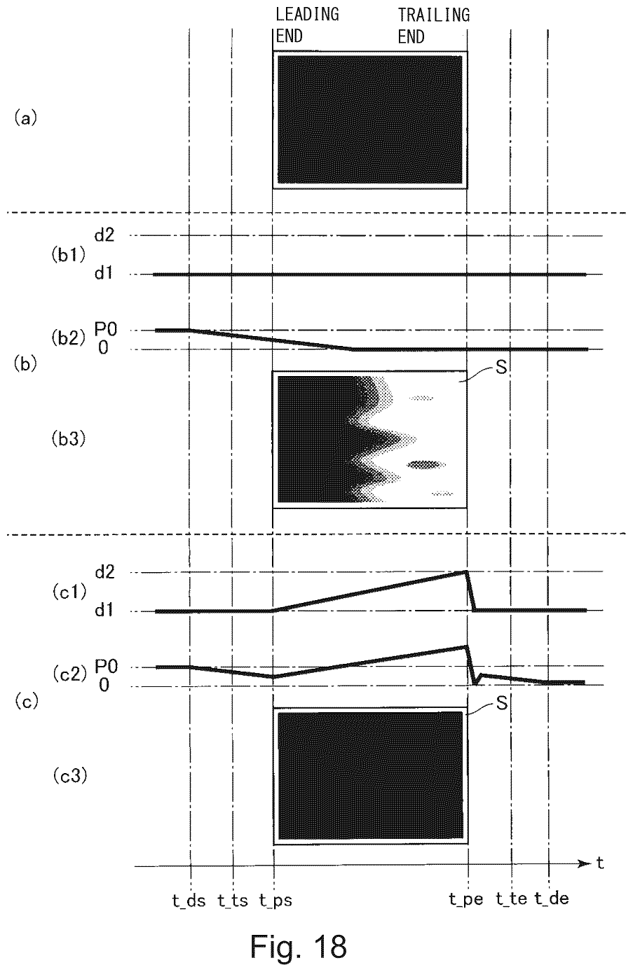

On the assumption of the case where the developing operation was performed without moving (deforming) the supplying sheet 521, by using FIG. 12 and FIG. 13, a state in which the amount of the toner T supplied to the receiving surface 51a of the developing roller 51 is insufficient was described. A similar state is capable of occurring also in constitutions as shown in FIGS. 14 to 16. A table 1 appearing hereinafter shows an occurrence status of the white void in this embodiment and a comparison example. As the comparison example, in addition to the case where a phase of the holding shaft 522 of the supplying mechanism 52 is not changed, described using FIGS. 12 and 13 (the case where movement (deformation) of the supplying sheet 521 is not performed), cases of the constitutions shown in FIGS. 14 to 16 are shown. FIGS. 14 to 16 are schematic sectional views each of a developing unit 50 in the comparison example. Further, in the table 1, as the embodiment 1, the case of this embodiment described later with reference to FIG. 17 is shown. In the table 1, the occurrence status of the white void was evaluated as follows. The case where the white void can be sufficiently suppressed was evaluated as “◯(good)”, and the case where the white void occurs by exceeding an allowable range was evaluated as “×(poor)”.

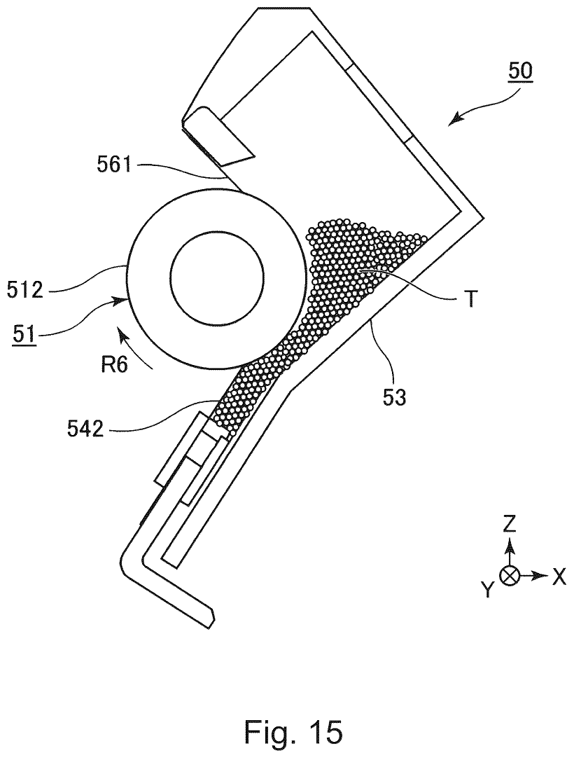

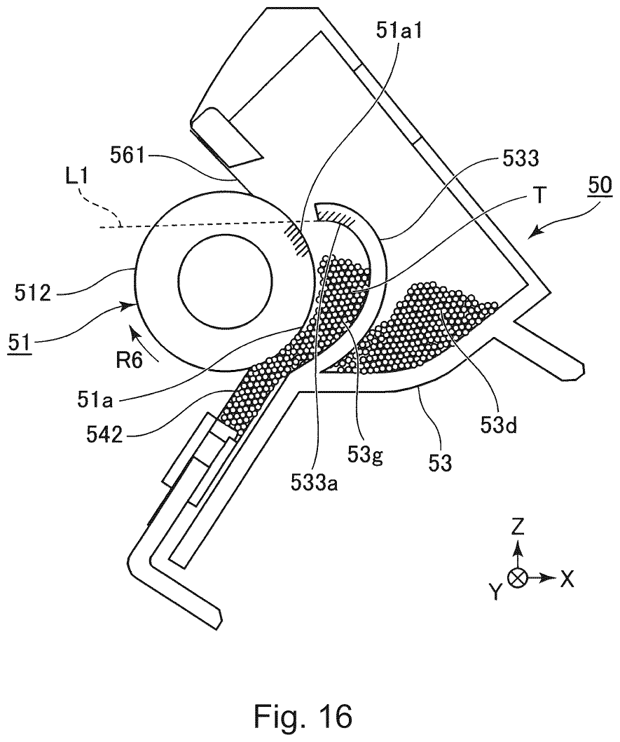

TABLE 1

| | | WHITE |
|---|---|---|
| | CONSTITUTION | VOID |
| EMB. 1 | FIG. 17 | ◯ |
| | FIG. 12 | X |
| COMP.EX | FIG. 14 | X |
| | FIG. 15 | X |
| | FIG. 16 | X |

For example, as shown in FIG. 14, also in the case where a supplying member for supplying the toner to the developing roller 51 is not provided, an amount of the toner supplied to the receiving surface 51a is insufficient in some instances similarly as in the example described using FIGS. 12 and 13. Further, as shown in FIG. 15, also in the case where the inner wall of the developing container 53 is brought near to the surface of the developing roller 51 to a position equivalent to a position of the supplying sheet 521 shown in FIG. 12, the amount of the toner supplied to the receiving surface 51a is insufficient in some instances similarly as in the example described using FIG. 12.

Therefore, as shown in FIG. 16, it would be considered to employ a constitution of a developing unit 50 such that a flow of the toner toward the surface of the developing roller 51 is created. In the example of FIG. 16, the developing unit 50 includes a partition wall portion 533 molded integrally with the developing container 53. In the example of FIG. 16, by this partition wall portion 533, an inside space of the developing container 53 is partitioned into the supplying region 53g and the rear surface-side region 53d similarly as the developing unit 50 in this embodiment. Of this partition wall portion 533, a free end, of a portion thereof facing the supplying region 53g, indicated by oblique lines is defined as a discharge surface 533a. Further, a line extended from this discharge surface 533a (broken line L1 in FIG. 16) extends toward the surface of the developing roller 51. The toner flowed along the wall surface of the partition wall portion 533 flows toward the surface of the developing roller 51 along the discharge surface 533a. For that reason, by the discharge surface 533a of the partition wall portion 533, a supply amount of the toner toward the surface of the developing roller 51 becomes large. However, in the example of FIG. 16, the toner on which the propulsive force toward the surface of the developing roller 51 acts is only the toner in the neighborhood of the discharge surface 533a. For that reason, of the receiving surface 51a of the developing roller 51, a portion where the toner supply amount increases is limited to an opposing portion 51a1, to the discharge surface 533a, indicated by oblique lines in FIG. 16. As a result, the toner supply amount is insufficient as the supply amount of the toner to entirety of the receiving surface 51a, so that the white void occurs in some cases.

### Summary of Action of Supplying Sheet in this Embodiment

Using FIG. 17, a summary of action of the supplying sheet 521 in this embodiment will be described.

FIG. 17 is a schematic sectional view of the developing unit 50 in this embodiment, and show a state immediately after the end of the developing period (state similar to the state of FIG. 12).

In this embodiment, as shown in FIG. 17, in the state immediately after the end of the developing period, the holding shaft 522 of the supplying mechanism 52 becomes a state in which the holding shaft 522 is rotated in the arrow R7a direction by a predetermined phase.

By this, the supplying sheet 521 fixed to the holding shaft 522 is moved (deformed) so as to be wound up by the holding shaft 522, so that a state in which flexure of the supplying sheet 521 is decreased (the supplying sheet is extended) is formed. Then, the toner T existing in the supplying region 53g is urged in arrow F6 directions toward the surface of the developing roller 51. As a result, the toner T can be stably supplied to the receiving surface 51a of the developing roller 51, so that the white void can be suppressed.

### Control of Supplying Mechanism

Next, controls of the supplying mechanism 52 in this embodiment will be described.

In order to suppress the white void occurring based on a mechanism as described above, it is effective that the weakly agglomerated toner in the neighborhood of the surface of the developing roller 51 is pressed against toward the surface of the developing roller 51 or that the toner stagnated in the neighborhood of the surface of the developing roller 51 is collapsed. In the following, while comparing this embodiment and the comparison example with each other, the action of the supplying sheet 521 in this embodiment will be further described.

### Explanation of Sequence Chart

FIGS. 18 to 20 are sequence charts for illustrating control of the supplying mechanism 52, and show an example in which a condition of the control of the supplying mechanism 52 is changed.

In FIGS. 18 to 20, an abscissa represents progression of time. Herein, a process such that the developing roller 51 is moved to the developing position in which the developing roller 51 contacts the photosensitive drum 2 and develops the electrostatic latent image on the photosensitive drum 2, and thereafter, the developing roller 51 is separated again from the photosensitive drum 2 is shown.

Further, in FIGS. 18 to 20, an ordinate represents a phase of the holding shaft 522 of the supplying mechanism 52 and powder pressure of the toner acting on the (toner) receiving surface 51a of the developing roller 51 (herein, this power pressure is simply referred to as “power pressure”). As the phase of the holding shaft 522, “d1” shows a “first phase (holding shaft first position)” in which s shown in FIG. 10, the supplying sheet 521 is put in a “first state (supplying sheet first position” in which flexure is relatively large (largest in this embodiment). In addition, “d2” shows a “second phase (holding shaft second position)” in which as shown in FIG. 17, the supplying sheet 521 is put in a “second state (supplying sheet second position)” in which the flexure is relatively small (smallest in this embodiment). Incidentally, the second state of the supplying sheet 521 may also be a stretched state in which there is substantially no flexure. Further, as the powder pressure, “P0” shows the powder pressure in a timing when drive (rotation) of the developing roller 51 is started. Further, as the powder pressure, “0” shows a state in which substantially no powder pressure acts on the receiving surface 51a. Incidentally, the powder pressure is not uniform with respect to the rotational axis direction (Y axis direction) of the developing roller 51 in many instances. Herein, the powder pressure shows, as an example, powder pressure in predetermined position with respect to the rotational axis direction (Y axis direction) of the developing roller 51.

Further, in FIGS. 18 and 19, an output image is shown together, and an occurrence status of the white void and density non-uniformity is schematically shown. The amount of the toner supplied to the developing roller becomes unstable, whereby the “density non-uniformity” such that a density (toner amount) of a part of an image corresponding to a portion of the developing roller where the toner supply amount decreases is decreased occurs in some instances. Further, in the case where the amount of the toner supplied to the developing roller is remarkably decreased, the “white void” such that the image is partially lacked occurs in some instances. Details of this output image will be described later.

### Explanation of Various Timings

First, various timings in processes shown in FIGS. 18 to 20 will be described.

As described above, the rotation of the rotary main body 90 and the like are performed from a state in which the developing rotary 100 is in the operation stand-by attitude. Then, in a “timing t_ds, the driving force from the development driving gear is transmitted to the developing roller gear through the developing roller clutch mechanism 175a, so that drive (rotation) of the developing roller 51 is started. This timing t_ds is also referred to as a “drive start timing t_ds”. Substantially simultaneously with this, to the supplying member gear 591 engaging with the holding shaft 522 of the supplying mechanism 52, the driving force from the development driving gear is transmitted through the idle gear 592, so that the holding shaft 522 is capable of being driven. At that time, by the supplying member clutch mechanism 176a, it is possible to control whether or not the driving force is transmitted from the development driving gear to the idle gear 592. For that reason, by controlling the supplying member clutch mechanism 176a, a timing when drive transmission to the holding shaft 522 is started can be arbitrarily controlled.

Substantially, in a “timing t_ts”, as shown in part (c) of FIG. 2, the developing roller 51 is contacted to the photosensitive drum 2. That is, when the electrostatic latent image is formed on the photosensitive drum 2, it becomes possible to develop the electrostatic latent image on the photosensitive drum 2 from the timing t_ts. This timing t_ts is also referred to as a “contact timing t_ts”.

Thereafter, a “timing t_ps” shows a timing when a leading end of a region corresponding to the sheet S on the photosensitive drum 2 reaches the developing nip G. This timing t_ps is also referred to as an “image leading end timing t_ps”. Further, a subsequent “timing t_pe” shows a timing when a trailing end of the region corresponding to the sheet S on the photosensitive drum 2 finishes passing through the developing nip G. This timing t_pe is also referred to as an “image trailing end timing t_pe”. Further, as an example of a predetermined period, a period between the image leading end timing t_ps and the image trailing end timing t_pe is referred to as a “development period”. Incidentally, the image leading end timing t_ps may also be a timing when a leading end of an image forming region on the photosensitive drum 2 reaches the developing nip G. Further, the image trailing end timing t_pe may also be a timing when a trailing end of the image forming region on the photosensitive drum 2 finishes passing through the developing nip G.

After the development period is ended, in a “timing t_te”, as shown in part (b) of FIG. 2, the developing roller 51 is separated from the photosensitive drum 2. This timing t_te is also referred to as a “separation timing t_te”. That is, a period from the contact timing t_ts to the separation timing t_te is a period in which the electrostatic latent image on the photosensitive drum 2 is capable of being developed by supplying the toner from the developing roller 51 to the photosensitive drum 2.

Thereafter, in a “timing t_de”, transmission of the driving force to the developing roller 51 is cut off. This timing t_de is also referred to as a “drive end timing t_de”.

Further, in part (a) of FIG. 18, a reference of an image formed in respective examples of parts (b) and (c) of FIG. 18 and parts (a) and (b) of FIG. 19 is shown. That is, description as to which image is outputted in the respective examples in the case where the image shown in part (a) of FIG. 18 is inputted as a print signal will be made in the following. Incidentally, it is assumed that the input image shown in part (a) of FIG. 18 is a solid image, having a maximum density on an entire surface of an image forming region thereof, as a high print ratio image easy to understand occurrence statuses of the white void and the density non-uniformity. Here, in general, formation of the image on the sheet S is not performed to an end most portion on a leading end side and an endmost portion on a trailing end side of the sheet S with respect to a conveying direction of the sheet S, and a predetermined margin is provided to at least one of these endmost portions. The same also applies to one end side and the other end side of the sheet S with respect to a widthwise direction of the sheet S. This is because lack of the image on the sheet S due to oblique movement of the sheet S, a mounting error of the photosensitive drum 2, and the like is prevented, or the like.

### Explanation of Respective Example

Next, respective examples shown in FIGS. 18 to 20 will be described.

### Example of Part (b) of FIG. 18 (Comparison Example)

Part (b) of FIG. 18 shows an example (comparison example), described using FIGS. 12 and 13, in the case where the image forming operation was performed without changing the phase of the holding shaft 522.

In the example of part (b) of FIG. 18, as shown in (b1) of FIG. 18, the phase of the holding shaft 522 is kept in a first phase d1.

Further, in the example of part (b) of FIG. 18, as shown in (b2) of FIG. 18, the powder pressure gradually decreases from “P0” with the drive start timing t_ds as a starting point and becomes “0” during the developing period (in a middle stage of the developing period in the example shown in (b2) of FIG. 18). That is, (b2) of FIG. 18 shows that as described using FIGS. 12 and 13, in the neighborhood of the surface of the developing roller 51, the toner supplied to the receiving surface 51a is decreased in amount, i.e., the powder pressure is decreased, by gradual stagnation of the weakly agglomerated toner. By this, as shown in (b3) of FIG. 18, a white void such that the image is lacked from an intermediary portion of the image occurs.

Incidentally, as described above, the power pressure is not uniform with respect to the rotational axis direction of the developing roller 51 in many instances.

For that reason, in a timing when the white void occurs, the powder pressure becomes non-uniform with respect to the Y axis direction (vertical direction in (b3) of FIG. 18), so that for example, a white void in an icicle-like shape as shown in (b3) of FIG. 18 occurs. Further, there is also a case where a supply amount of the toner to the receiving surface 51a is gradually decreased, so that a density of the output image becomes thin from a maximum density stepwise or in a moderate gradation shape, thus finally results in the white void. Further, there is also a case where even in a state in which the weakly agglomerated toner is stagnated in the neighborhood of the surface of the developing roller 51, the toner is temporarily conveyed to the surface of the developing roller. For that reason, as shown in (b3) of FIG. 18, in a timing when the white void occurs in eight position with respect to the Y axis direction, an image is partially formed (toner is outputted) in another either position with respect to the Y axis direction in some cases.

Thus, in the case where the phase of the holding shaft 522 is not changed and the urging force by the supplying sheet 521 is not caused to act on the toner, the powder pressure is gradually decreased, so that the white void occurs.

### Example (Embodiment) of Part (c) of FIG. 18

Part (c) of FIG. 18 shows an example of control of the supplying mechanism 52 in this embodiment.

In the example of part (c) of FIG. 18, as shown in (c1) of FIG. 18, the phase of the holding shaft 522 is gradually changed from a first phase d1 to a second phase d2 with the image leading end timing t_ps as a starting point. That is, the supplying sheet 521 is gradually wound about the holding shaft 522 from a first state in which flexure is relatively large, and is changed in state to a second state in which the flexure is relatively small, so that the surface of the supplying sheet 521 gradually approaches the surface of the supplying sheet 521. By this, during the developing period, by the supplying sheet 521, an urging force such that the toner is pressed against the surface of the developing roller 51 acts on the toner. As a result, supply of the toner to the receiving surface 51a of the developing roller 51 becomes sufficient, so that the white void can be suppressed. In the following, an operation for bringing the supplying sheet 521 near to the surface of the developing roller 51 is also simply referred to as an “approaching operation”.

Further, in the example of part (c) of FIG. 18, as shown in (c1) of FIG. 18, elastic energy accumulated in the urging spring 593 is released with the image trailing end timing t_pe as a starting point. By this, the phase of the holding shaft 522 is returned from the second phase d2 to the first phase d1 and the surface of the supplying sheet 521 is moved away from the surface of the developing roller 51, so that the supplying sheet 521 is returned in state from the second state in which the flexure is relatively small to the first state in which the flexure is relatively high. In the following, an operation for moving the supplying sheet 521 away from the surface of the developing roller 51 is also simply referred to as a “separating (spacing) operation”.

Further, in the example of part (c) of FIG. 18, as shown in (c2) of FIG. 18, the powder pressure is gradually decreased from “P0” with the drive start timing t_ds as a starting point, but is gradually increased with the image leading end timing t_ps as a starting point. Thereafter, the powder pressure is decreased with the image trailing end timing t_pe as a starting point. In an example of part (c) of FIG. 18, when the supplying sheet 521 is moved away from the surface of the developing roller 51, the powder pressure temporarily becomes “0”. That is, the supplying sheet 521 is moved away from the surface of the developing roller 51, whereby the toner in the supplying region 53g is also moved in a direction, in which the toner is moved away from the surface of the developing roller 51, with movement of the supplying sheet 521. For that reason, the supply amount of the toner to the receiving surface 51a is decreased, so that the powder pressure temporarily becomes “0”. However, when the timing is a timing after the detecting period is ended (on or after the image trailing end timing t_pe), there is no problem even when the powder pressure is decreased. Incidentally, as shown in part (c) of FIG. 18, after the power pressure is temporarily decreased by moving the supplying sheet 521 away from the surface of the developing roller 51, the powder pressure is increased again even when the supplying sheet 521 is brought near to the surface of the developing roller 51. This is because although the toner in the supplying region 53g is also temporarily moved in the direction away from the surface of the developing roller 51 with the movement of the supplying sheet 521, in the case where the toner has the flowability to some extent, the toner is contacted again to the surface of the developing roller 51. On the other hand, it is not desirable that the supplying sheet 521 is moved away from the surface of the developing roller 51. This will be described using the following example of part (a) of FIG. 19.

### Example (Comparison Example) of Part (a) of FIG. 19

Part (a) of FIG. 19 shows an example (comparison example) in the case where each of the approaching operation and the separating operation is performed plural times in a single developing period ((a1) of FIG. 19).

In the example of part (a) of FIG. 19, in a timing when the supplying sheet 521 is moved away from the surface of the developing roller 51, the powder pressure is abruptly decreased ((a2) of FIG. 19). By this, the supply amount of the toner to the receiving surface 51a of the developing roller 51 is temporarily decreased, so that density non-uniformity such that the toner density becomes thin in a lateral band shape occurs ((a3) of FIG. 19).

Incidentally, for example, also in a constitution in which the toner is supplied to the developing roller 51 by rotating a stirring member in a sheet shape or a plate shape at a high speed, similarly as in the example of part (a) of FIG. 19, a density non-uniformity in rotation (cycle) period pitch of the stirring member occurs.

Further, as in the example of part (a) of FIG. 19, even in the case where the separating operation of the supplying sheet 521 is performed one time during the developing period without performing each of the approaching operation and the separating operation of the supplying sheet 521 plural times, the density non-uniformity occurs similarly as in the example of part (a) of FIG. 19. At that time, as described in the example of part (c) of FIG. 18, after the powder pressure is temporarily decreased by moving the surface of the supplying sheet 521 from the surface of the developing roller 51, the powder pressure is increased again even when the supplying sheet 521 is not brought near to the surface of the developing roller 51. For that reason, the density non-uniformity due to a temporary decrease in toner supply amount occurs.

However, thereafter, in the case where the supplying sheet 521 is not brought near to the surface of the developing roller 51 again, the white void occurs.

Thus, it is not desirable that the supplying mechanism 52 is controlled so that the supplying sheet 521 is moved away from the surface of the developing roller 51 during the developing period. On the other hand, it is also not desirable that a state in which the supplying sheet 521 is brought near to the surface of the developing roller 51 is maintained. This will be described using an example of part (b) of FIG. 19.

### Example (Comparison Example) of Part (b) of FIG. 19

Part (b) of FIG. 9 shows an example (comparison example) in the case where the state in which the supplying sheet 521 is brought near to the surface of the developing roller 51 is maintained ((b1) of FIG. 19). Specifically, in the drive start timing t_ds, the supplying sheet 521 is brought near to the surface of the developing roller 51 by changing the phase of the holding shaft 522 from the first phase d1 to the second phase d2. By this, the powder pressure is temporarily increased ((b2) of FIG. 19). However, also in the example of part (b) of FIG. 19, similarly as in the example of part (b) of FIG. 18, the toner weakly agglomerated in the neighborhood of the surface of the developing roller 51 is gradually stagnated, and the powder pressure is decreased, so that the white void occurs.

### Another Example of Control of Supplying Mechanism

Next, using FIG. 20, another example (modified example) of control of the supplying mechanism 52 in accordance with the present disclosure will be described.

First, in an example of part (a) of FIG. 20, as control for bringing the supplying sheet 521 near to the surface of the developing roller 51, the phase of the holding shaft 522 is changed stepwise (in multiple stages) from the first phase d1 to the second phase d2 with the image leading end timing t_ps as a starting point ((a1) of FIG. 20). Also, in this case, similarly as in the case where the phase of the holding shaft 522 is linearly (rectilinearly) changed as shown in part (c) of FIG. 18, the toner is urged toward the surface of the developing roller 51 ((a2) of FIG. 20), so that the white void and the density non-uniformity can be suppressed. Incidentally, as the control for bringing the supplying sheet 521 near to the surface of the developing roller 51, the phase of the holding shaft 522 may also be curvedly changed from the first phase d1 to the second phase d2. Further, the control for linearly changing the phase of the holding shaft 522, the control for changing the phase of the holding shaft 522 stepwise, and the control for curvedly changing the phase of the holding shaft 522 may be used in arbitrary combination. That is, at least in a part of the period in which the phase of the holding shaft 522 is changed from the first phase d1 to the second phase d2, the phase of the holding shaft 522 can be changed linearly, stepwise, or curvedly.

Further, in the example of part (b) of FIG. 20, a timing when the approaching operation of the supplying sheet 521 is started by changing the phase of the holding shaft 522 from the first phase d1 (hereinafter, this timing is also referred to as an “approach start timing”) is set as a timing before the image leading end timing t_ps. Further, in the example of part (b) of FIG. 20, a timing when the separating operation of the supplying sheet 521 is started by changing the phase of the holding shaft 522 from the second phase d2 (hereinafter, this timing is also referred to as a “separation start timing”) is set as a timing after the image trailing end timing t_pe. In the example of part (b) of FIG. 20, the approach start timing is set to the drive start timing t_ds, and the separation start timing is set to the drive stop timing t_pe ((b1) of FIG. 20). Also, in this case, the toner is urged toward the surface of the developing roller 51 ((b2) of FIG. 20), so that the white void and the density non-uniformity can be suppressed. That is, when control of contact/separation between the developing roller 51 and the photosensitive drum 2 and control of transmission and cut-off of the drive for the developing roller 51 can be appropriately carried out, the approaching operation may also be started before a start of the developing period, and the separating operation may also be started after an end of the developing period. Incidentally, either one of the start of the approaching operation before the start of the developing period and the start of the separating operation after the end of the developing period may be applied. That is, a constitution in which the approaching operation is started before the start of the developing period and in which the separating operation is started substantially simultaneously with the end of the developing period or a constitution in which the approaching operation is started substantially simultaneously with the start of the developing period and the separating operation is started after the end of the developing period may also be employed.

Incidentally, by carrying out the control as in the example of part (a) of FIG. 20, a drive constitution of the supplying mechanism 52 can simplified. That is, in this embodiment, in order to control the phase of the idle gear 592 transmitting the driving force to the holding shaft 522, the image forming apparatus 1 is provided with the supplying member clutch mechanism 176a. On the other hand, in the case where the drive start timing and the drive stop timing are the same timing between the idle gear 592 and the development driving gear, the image forming apparatus 1 is not required to be provided with the supplying member clutch mechanism 176a.

On the other hand, there is a need to pay attention in the case where each of the approaching start timing and the separation start timing is provided during the developing period.

First, the case where the approaching start timing is provided during the developing period will be described. For example, in an example of part (c) of FIG. 20, the approach start timing is set as a timing during the developing period (in an intermediary portion of the developing period in the example of this figure) ((c1 of FIG. 20). In this case, as indicated by a broken line in (c2) of FIG. 20, when the powder pressure is gradually decreased from the drive start timing t_ds and becomes “0” before the approach start timing, there is a case where the white void occurs. However, a time required until the powder pressure is lowered with the rotation of the developing roller 51 and the toner is not sufficiently supplied to the surface of the developing roller 51 varies depending on various conditions. For example, in the case where the flowability of the toner is originally improved by addition of minute inorganic particles as an external additive in a large amount to the surface of the toner, or the like, even when the toner is not urged toward the surface of the developing roller 51 by the supplying sheet 521, there is a case where a sufficient supply amount of the toner toward the developing roller 5 can be maintained over a peripheral surface corresponding to a plurality of full circumferences of the developing roller 51. In that case, as indicated by a solid line in (c2) of FIG. 20, a speed at which the powder pressure is lowered with the rotation of the developing roller 51 is decreased more than a speed in the case indicated by the broken line. In this case, even when the approach start timing is set as the timing during the developing period, the toner can be urged toward the surface of the developing roller 51 before the powder pressure becomes “0”, so that the white void can be suppressed.

On the other hand, in the case where the toner flowability is lowered such as the case where the developing unit 50 is repetitively used (a cumulative use amount is increased) or the case where the image forming apparatus 1 is used in a low-temperature environment, the following occurs in some instances. That is, even in a timing when a change amount of the phase of the holding shaft 522 temporarily becomes small as in the example of part (a) of FIG. 20, it is concerned that urging of the toner toward the developing roller 51 by the supplying sheet 521 becomes insufficient and the supply amount of the toner toward the developing roller 51 is decreased. Further, in the case where the approach start timing is set as a timing during the developing period as in the example of part (c) of FIG. 20, it is concerned that the powder pressure becomes “0” before the approach start timing as indicated by the broken line. Accordingly, in such a case, it can be said that control of the supplying mechanism 52 as in the examples of part (c) of FIG. 18 and part (b) of FIG. 20 is more desirable than control of the supplying mechanism 52 as in the examples of part (a) of FIG. 20 and part (c) of FIG. 20. Thus, depending on assumed flowability of the toner, the control of the supplying mechanism 52 can be appropriately set.

Next, the case where the separation start timing is set as a timing during the developing period will be described. As described using part (a) of FIG. 19, it is not desirable that the separation start timing is set as the timing during the developing period. This can also be similarly said even in a state in which the flowability of the toner is high. That is, in a state in which the flowability of the toner is high, a time required until the state of the supplying sheet 521 is restored from the state in which the powder pressure is decreased after the supplying sheet 521 is moved away from the surface of the developing roller 51 becomes short as described using part (c) of FIG. 18. However, by movement of the toner in the supplying region 53g with movement of the supplying sheet 521, it is unchanged that the powder pressure is temporarily decreased.

However, in the following case, the separation start timing can be provided as the timing during the developing period. For example, as described using part (a) of FIG. 18, in general, a predetermined margin is used for a shape of the sheet S. For that reason, there is no problem even when the separation start timing is set as a timing before the image trailing end timing t_pe at least correspondingly to this margin. That is, in the example of part (c) of FIG. 18 or the like, the separation start timing was set as a timing on or after when a trailing end of a region corresponding to the sheet S on the photosensitive drum 2 finishes passing through the developing nip G. On the other hand, the separation start timing can be set as a timing after when the trailing end of the image forming region on the photosensitive drum 2 finishes passing through the developing nip G and before when the trailing end of the region corresponding to the sheet S on the photosensitive drum 2 finishes passing through the developing nip G.

Similarly, for example, in the case where discrimination that the image is not formed in a region of the sheet S on a trailing end side of the sheet S can be made on the basis of the image information, there is no problem that the separation start timing is set as a timing before the image trailing end timing t-period correspondingly to the region on the trailing end side where the image is not formed. That is, the separation start timing can be set as a timing after when a trailing end of a region, in which the image is formed, of the image forming region on the photosensitive drum 2 finishes passing through the developing nip G and before when the trailing end of the region corresponding to the sheet S on the photosensitive drum 2 finishes passing through the developing nip G. For example, on the basis of the image information of the print signal received from the video controller 160, the controller 150 is capable of discriminating a leading end of a region, in which the image is not formed, on a trailing end side of the sheet S (i.e., trailing end of the region in which the image is formed). Then, for example, on the basis of positional information of the leading end of the region, in which the image is not formed, on the trailing end side of the sheet S (i.e., the trailing end of the region in which the image is formed), the separation start timing can be changed so as to become a timing before the image trailing end timing t_pe.

Further, even when the powder pressure becomes “0” and the amount of toner carried on the surface of the developing roller 51 is decreased, it takes a predetermined time until the density of the toner image on the photosensitive drum 2 is lowered by the influence thereof. This predetermined time is a time corresponding to rotation of the surface of the developing roller 51, decreased in toner amount due to at least a decrease in powder pressure, passed through the contact position with the regulating plate 542 and reached the contact position (developing nip G) with the photosensitive drum 2. For that reason, with respect to a rotational direction of the developing roller 51, there is no problem that at least correspondingly to a phase from the contact position between the developing roller 51 and the regulating plate 542 to the contact position between the developing roller 51 and the photosensitive drum 2, the separation start timing may be set as a timing before the image trailing end timing t_pe. It can be said that the same applies to the case where the separation start timing is set as the timing corresponding to the margin or the region, in which the image is not formed, on the trailing end side of the sheet S as described above. That is, with respect to the rotational direction of the developing roller 51, correspondingly to at least the phase from the contact position between the developing roller 51 and the regulating plate 542 to the contact position between the developing roller 51 and the photosensitive drum 2, the separation start timing can be set as a timing before when the trailing end of the image forming region on the photosensitive drum 2 finishes passing through the developing nip G or when the trailing end of the region, in which the image is formed, of the image forming region on the photosensitive drum 2. The separation start timing may also be a timing between the timing when the trailing end of the image forming region on the photosensitive drum 2 finishes passing through the developing nip G (or the timing when the trailing end of the region in which the image is formed finishes passing through the developing nip G, and the timing preceding correspondingly to the above-described phase.

Thus, with respect to the developing period, the approach start timing and the separation start timing can be appropriately set so that the white void and the density non-uniformity can be sufficiently suppressed.

Further, in this embodiment (the same applies to the above-described other embodiments (examples) according to the present disclosure), in the drive start timing t_ds and the drive stop timing t_de, the phase of the holding shaft 522 was the first phase d1. That is, in this embodiment (the same applies to the above-described other embodiments (examples) according to the present disclosure), the first state of the supplying sheet 521 in FIG. 5 is an initial state of the supplying sheet 521, and the first phase d1, corresponding to the first state, of the holding shaft 522 is an initial state of the holding shaft 522. However, the present disclosure is not limited to such embodiments (examples). For example, in the example of part (d) of FIG. 20, in the drive state timing t_ds and the drive stop timing t_de, the phase of the holding shaft 522 is the second phase d2. In this case, for example, before the start of the developing period, the phase of the holding shaft 522 is set to the first phase d1, so that the supplying sheet 521 is once put in the first state in which the flexure is relatively large. Then, during the developing period, the supplying sheet 521 is gradually brought near to the surface of the developing roller 51. By this, similarly as this embodiment (and the above-described other embodiments (examples) according to the present disclosure), the white void and the density non-uniformity can be suppressed.

Further, phase changing manners (linearly, stepwise, curvedly, and the like) of the holding shaft 522, settings of the approach start timing and the separation start timing, initial states of the holding shaft 522, and the like in this embodiment (part (c) of FIG. 18) and modified embodiments (examples) thereof (FIG. 20) can be arbitrarily combined with each other.

### Effect

Thus, according to this embodiment and the modified embodiments (examples) thereof, the toner can be stably supplied to the surface of the developing roller 51, so that it is possible to suppress the occurrence of image defects such as the white void and the density non-uniformity. In order to suppress the occurrence of the image defects such as the white void and the density non-uniformity by stably supplying the toner to the receiving surface 51a of the developing roller 51, it becomes important to continuously apply sufficient powder pressure to the surface of the developing roller 51 during the developing period. For that reason, as described above, on the assumption that the toner at the periphery of the developing roller 51 is weakly agglomerated with the rotation of the developing roller 51, the supplying mechanism 52 may desirably be controlled so that the toner is urged toward the surface of the developing roller 51 during the developing period. Further, it is desirable that the supplying mechanism 52 is controlled so that the powder pressure is not decreased even temporarily during the developing period.

Here, conventionally, the developing device is provided with a supplying roller for supplying the toner to the developing roller. The toner accommodated in the developing device is changed in characteristics such as the chargeability and the flowability by repetitive use of the developing device. In the case where the flowability of the toner is lowered, the image defects such as the density non-uniformity and the white void occur in some instances. That is, in the case where the flowability of the toner is lowered, although the toner in sufficient amount is accommodated in the developing device, an amount of the toner contained in a sponge layer of the supplying roller is decreased, so that an amount of the toner supplied to the developing roller becomes unstable in some instances. By this, the “density non-uniformity” such that a density (amount of the toner) of a part of an image corresponding to a portion, where the toner supply amount is decreased, of the developing roller is decreased occurs in some instances.

Further, in the case where the amount of the toner supplied to the developing roller is remarkably decreased, the “white void” such that the image is partially lacked occurs in some instances. Further, in the case where the chargeability of the toner is lowered, a “fog” such that the toner is deposited on a non-image portion desired that the toner is not originally deposited thereon occurs in some instances. As a factor of such a change in toner characteristic, it is possible to cite that the toner is subjected to a load such as frictional slide in a contact portion between the developing roller and the supplying roller, or the like.

According to this embodiment and the modified embodiments (examples) thereof, compared with the constitution in which the developing unit 50 is provided with the supplying roller, it is possible to suppress the occurrence of the image defects such as the white void and the density non-uniformity while alleviating a change in performance of the toner accommodated in the developing container 53. According to the study of the present inventors, in this embodiment and the modified embodiments (examples) thereof, compared with the constitution in which the developing unit 50 is provided with the supplying roller, a speed at which the flowability of the toner is lowered can be suppressed to about 25 % with respect to a total number of rotations of the developing roller 51.

Incidentally, as described above, the toner carried on the surface of the developing roller 51 is formed in about 1 to 10 layers, so that a layer thickness of the toner moved in the arrow F1 direction with the rotation of the developing roller 51 is slightly less than 100 μm even by the longest estimation. Further, a wall surface of the toner formed in the neighborhood of the surface of the developing roller 51 as described using FIGS. 12 and 13 is formed in a position separated form the surface of the developing roller 51 by about 100 μm. For that reason, when the toner in the supplying region 53g is urged by the supplying sheet 521, the supplying sheet 521 may only be required to urge the toner in a distance corresponding to this gap of 10 μm. In this embodiment and the modified embodiments (examples) thereof, for example, as shown in FIG. 17, when the supplying sheet 521 is brought near to the surface of the developing roller 51, the holding shaft 522 is rotated from an initial state indicated by a broken line by about 30°. However, when the toner in the supplying region 53 g is urged by the supplying through 521, if the supplying sheet 521 is capable of urging the toner in the distance corresponding to the above-described gap of 100 μm, this rotation angle may be made smaller. This rotation angle can be appropriately selected from, for example, about 5° to 90°, preferably about 10° to 60°, typically about 20° to 45°.

Further, a time required to return the phase of the holding shaft 522 from the second phase d2 to the first phase d1 is adjustable by a spring constant of the urging spring 593 and can be appropriately set in view of strength of the holding shaft 522, a time required for a step after the developing period, and the like.

Further, in an operation in a monochromatic image mode, more images can be formed in a shorter time by forming images for a plurality of pages to be transferred onto a plurality of sheets S without rotating the rotary main body 90 while keeping the developing rotary 100 in the development attitude shown in part (c) of FIG. 2. At that time, similarly as in the example of part (c) of FIG. 18, every time when the developing period for one page is ended, the phase of the holding shaft 522 can be returned to the first phase d1. For example, in the case where images for 2 pages to be transferred onto two sheets S are formed, the following operation can be performed. That is, similarly as in the example of part (c) of FIG. 18, when the developing period for a first page is ended, the phase of the holding shaft 522 is returned from the second phase d2 to the first phase d1, and is changed again from the first phase d1 to the second phase d2 in a developing period for a second page. On the other hand, when the developing period for the first page is ended, the phase of the holding shaft 522 may also be kept in the second phase d2. Then, in the developing period for the second page, the phase of the holding shaft 522 may be changed to a third phase (holding shaft third position) d3 in which the supplying sheet 521 is brought further nearer to the surface of the developing roller 51 than in the second phase d2. Further, similar to the example of part (b) of FIG. 20, in the operation in the monochromatic image mode, during rotation of the developing roller 51, the phase of the holding shaft 522 may be continuously changed so that the supplying sheet 521 is continuously brought near to the surface of the developing roller 51. In this case, every time when developing periods for predetermined pages (for example, two to ten pages) are ended, the phase of the holding shaft 522 may also be returned to the first phase d1. Incidentally, the monochromatic image mode is, in general, a mode in which a black monochromatic image is formed with black toner, but may also be a mode in which a monochromatic image of another color may also be formed.

As described above, in this embodiment, the image forming apparatus 1 includes the image bearing member (photosensitive drum) 2, and the developing device 50 which is a developing device (developing unit) 50 for forming the toner image on the surface of the image bearing member 2 and which includes the developing container 53 for accommodating the toner and the rotatable developer carrying member (developing roller) 51 for forming the developing portion (developing nip) G in contact with the surface of the image bearing member 2 and for conveying the toner, accommodated in the developing container 53, toward the image bearing member 2 while carrying the toner. Further, in this embodiment, the image forming apparatus 1 includes the supplying including the supplying member (state sheet) 521 which is changeable in state between the first state and the second state in which at least a part of the supplying mechanism 52 is brought nearer to the developer carrying member 51 than in the first state and which urges the toner, accommodated in the developing container 53, toward the surface of the developer carrying member 51, the driving portion (supplying member driving portion) 176 capable of operating the supplying mechanism 52 so as to change the state of the supplying member 521 to the first state and the second state, and the controller 150 for controlling the driving portion 176. Further, in this embodiment, when a timing when a leading end of an image forming region, in which a toner image for one page is formable, on the image bearing member 2 with respect to a rotational direction of the image bearing member 2 reaches the developing portion G is a first timing, a timing having a predetermined relationship with a timing when a trailing end of the image forming region with respect to the rotational direction of the image bearing member 2 finishes passing through the developing portion G is a second timing, and a period between the first timing and the second timing is a predetermined period, the controller 150 controls the driving portion 176 so that an operation of the supplying mechanism 52 for changing the state of the supplying member 521 in a direction from the first state to the second state in at least a part of a period of the predetermined period is performed, and in addition so that the operation of the supplying mechanism 52 for changing the state of the supplying member 521 in a direction from the second state to the first state in the predetermined period is not performed. The second timing may be the timing when the trailing end of the image forming region with respect to the rotational direction of the image bearing member 2 finishes passing through the developing portion G. Further, the developing device 50 may include a regulating member (regulating blade) 54 which forms a contact portion in contact with the surface of the developer carrying member 51 and which is for regulating an amount of the toner carried on the developer carrying member 51, and the second timing may be a timing before the timing when the trailing end of the image forming region with respect to the rotational direction of the image bearing member 2 finishes passing through the developing portion G, by a time taken for movement of the surface of the developer carrying member 51 from the contact portion to the developing portion G. Further, in this embodiment, when the image forming region is a first image forming region, the above-described predetermined period is a first period, and a period between the first timing and the second timing for a second image forming region, in which a toner image for one page subsequent to the first image forming region, on the image bearing member 2 is a second period, the controller 150 controls the driving portion 176 so that an operation of the supplying mechanism 52 for changing the state of the supplying member 521 from the second state to the first state after the first period and before the second period.

Further, in this embodiment, the supplying member 521 is constituted by a flexible sheet which is provided so that a first direction (longitudinal direction) thereof extends along (in this embodiment, substantially parallel to) a rotational axis direction of the developer carrying member and which is held in a first portion (fixing portion) 521a thereof on one end portion side thereof and a second portion (bonding portion) 521b thereof on the other end portion side thereof with respect to a second direction (widthwise direction) crossing (in this embodiment, substantially perpendicular to) the first direction, the supplying mechanism 52 includes a holding member (holding shaft) 522 holding the second portion 521b of the supplying member 521 and rotatable about a rotational axis along (in this embodiment, substantially parallel to) the above-described first direction, and the driving portion 176 is capable of changing the state of the supplying member 521 to the first state and the second state by rotating the holding member 522. In this embodiment, the first portion 521a of the supplying member 521 is held by the developing container 53. Further, in this embodiment, the supplying member 521 is changeable in state to the first state in which the supplying member 521 has flexure in the second direction and to the second state in which the flexure is smaller than in the first state. Further, in this embodiment, inside the developing container 53, a first region (supplying region) 53g in which the developer carrying member 51 is accommodated and a second region (rear surface-side region) 53d in which the developer carrying member 51 is not accommodated are formed by the supplying member 521, and the image forming apparatus 1 includes a moving means capable of enabling movement of the toner between the first region 53g and the second region 53d. In this embodiment, the image forming apparatus 1 includes a rotary (rotary main body) 90 capable of rotating the developing device 50, and the moving means enables the movement of the toner between the first region 53g and the second region 53d.

Further, according to this embodiment, it becomes possible to stably supply the toner to the surface of the developer carrying member without providing the supplying roller to the developing device.

### Embodiment 2

Another embodiment of the present disclosure will be described. In this embodiment, another example of each of the constitution of the supplying mechanism 52 and the driving constitution of the supplying mechanism 52 will be principally described. In this embodiment, the present disclosure is applied to an image forming apparatus 1 having a basic constitution similar to the basic constitution of the image forming apparatus 1 of the embodiment 1.

### Another Example of Supplying Mechanism

First, another example of the supplying mechanism 52 will be described.

In the embodiment 1, the supplying mechanism 52 employed the constitution in which the bonding portion 521b of the supplying sheet 521 is rotated about the rotation center 522C of the holding shaft 522. On the other hand, the supplying mechanism 52 may also employ a constitution in which the bonding portion 521b of the supplying sheet 521 is swung.

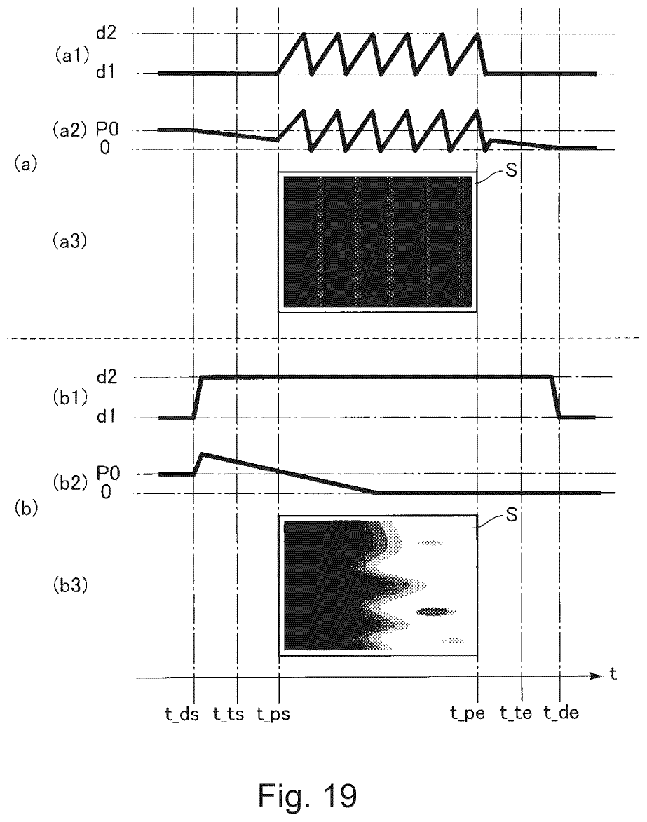

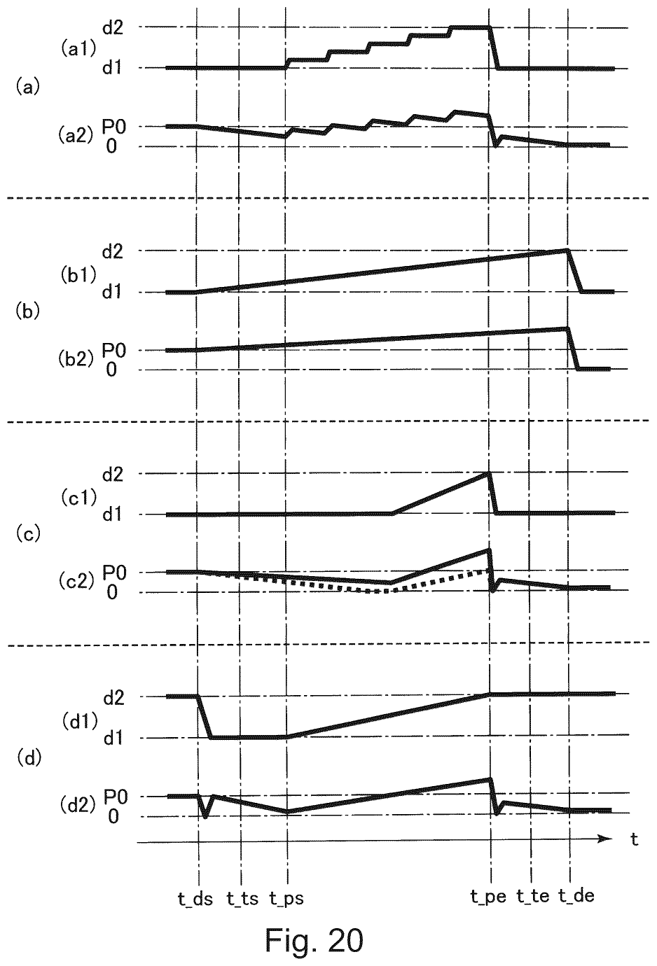

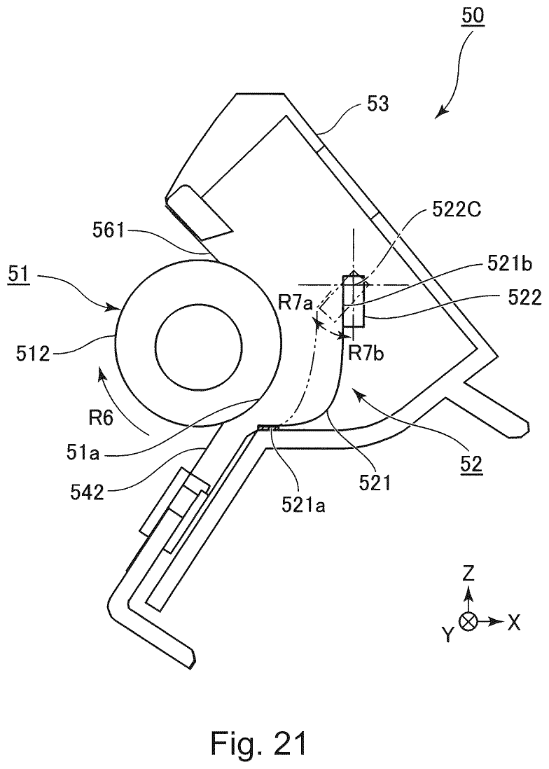

FIG. 21 is a schematic sectional view of another example of the developing unit 50 provided with the another example of the supplying mechanism 52. Further, parts (a), (b), and (c) of FIG. 22 are schematic perspective views each of another example of the holding shaft 522 of the supplying mechanism 52. Incidentally, each of parts (a), (b), and (c) of FIG. 22 shows an example of the holding shaft 522, and in FIG. 21, the developing unit 50 provided with the holding shaft 522 shown in part (a) of FIG. 22 is shown. Further, with the holding shaft 522 shown in each of parts (a), (b), and (c) of FIG. 22, a bonding portion 521b of the supplying sheet 521 for being bonded to the holding shaft 533 is illustrated together.

As shown in FIG. 21 and part (a) of FIG. 22, a holding portion 5221 of the holding shaft 522 may have a substantially rectangular shape in cross section in the XZ flat plane. This holding shaft 522 is rotatable (rotationally movable) in the arrow R7a direction (clockwise direction) and the arrow R7b direction (counterclockwise direction) about the rotational axis 522C extending in the Y axis direction. In this holding shaft 522, the rotational axis 522C is disposed by being shifted toward one end portion side with respect to a longitudinal direction of the holding shaft 522 in the XZ flat plane.

Further, to this holding shaft 522, the bonding portion 521b of the supplying sheet 521 is bonded in a position separated from the rotational axis 522C in the holding portion 5221 with respect to a rotation radius direction of the holding shaft 522. That is, the bonding portion 521b of the supplying sheet 521 is bonded to a surface (surface extending in the longitudinal direction in the XZ flat plane) on an end portion side opposite from an end portion side where the rotational axis 522C is disposed with respect to the longitudinal direction of the holding portion 5221 in the XZ flat plane. By this, when the holding shaft 522 is rotated about the rotational axis 522C, the bonding portion 521b of the supplying sheet 521 is swung about the rotational axis 522C in the arrow R7a direction and the arrow R7b direction. Thus, by employing a constitution in which the bonding portion 521b of the supplying sheet 521 is swung, it becomes possible to control loosening/tightening of the supplying sheet 521 only by rotating the holding shaft 522 with a smaller angle. Also, in this case, a degree of the flexure of the supplying sheet 521 can be adjusted, so that the toner in the supplying region 53g can be urged toward the surface of the developing roller 51.

Further, the holding shaft 522 may have a constitution in which a part of the holding shaft 522 shown in part (a) of FIG. 22 is cut away to leave a projected portion as shown in part (b) of FIG. 22. Further, the holding shaft 522 may have a constitution in which a part of the holding shaft 522 shown in part (a) of FIG. 22 is cut away to leave a crank shape as shown in part (c) of FIG. 22. For example, as a material of the holding shaft 522, by using a material sufficiently strong in strength, the constitutions as shown in parts (b) and (c) of FIG. 22 are employed, so that a use amount of the material can be reduced. Even in such a constitution, the bonding portion 521b of the supplying sheet 521 can be swung about the rotational axis 522C as a swing center, so that the toner in the supplying region 53g can be urged toward the surface of the developing roller 51.

Incidentally, the supplying mechanisms 52 provided with the holding shafts 522 shown in FIGS. 21 and 22 are driven by a driving constitution similar to the driving constitution in the embodiment 1.

### Another Example of Driving Constitution of Supplying Mechanism

Next, another example of the driving constitution of the supplying mechanism 52 will be described.

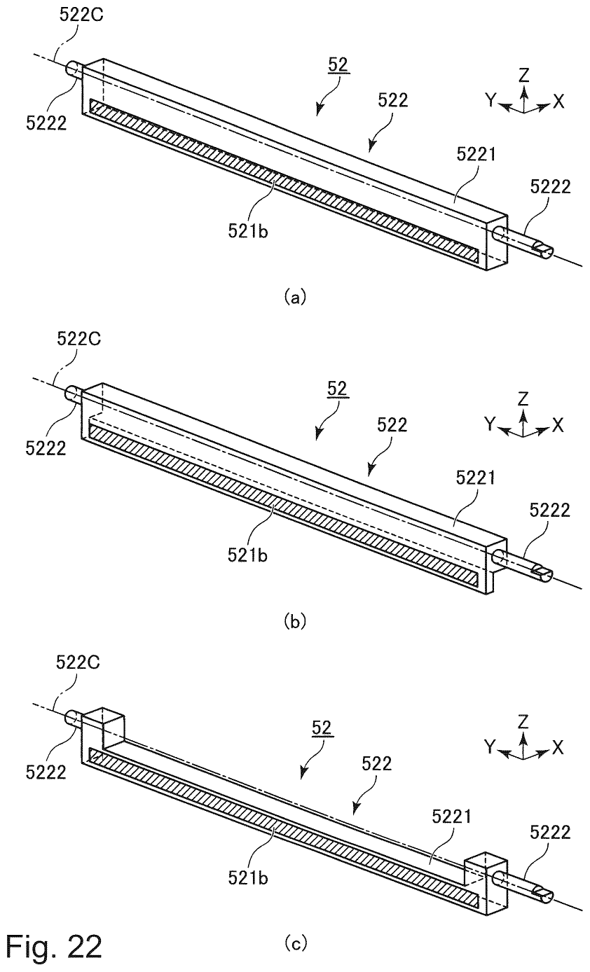

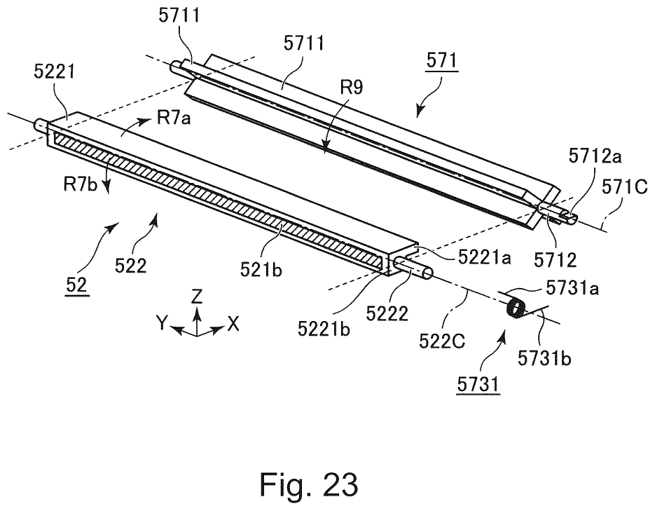

FIG. 23 and part (a) of FIG. 24 are schematic exploded perspective views each for illustrating the another example of the driving constitution of the holding shaft 522. In FIG. 23, the holding shaft 522 and a rotation assisting member 571 which is an example of a rotation assisting member (moving member) are shown. Further, in part (a) of FIG. 24, the supplying mechanism 522 and a rotation assisting member 572 which is another example of the rotation assisting member (moving member) are shown. Further, part (b) of FIG. 24 is a sectional view of the rotation assisting member 572 shown in part (a) of FIG. 224. Further, part (c) of FIG. 24 is a graph showing a change (cam profile) of a radius r of a cam portion 5721 described later with respect to a rotational direction of the rotation assisting member 572 shown in part (a) of FIG. 24. With each of the holding shafts 522 shown in FIG. 23 and part (a) of FIG. 24, the bonding portion 521b of the supplying sheet 521 for bonding the supplying sheet 521 to the holding shaft 522 is illustrated together.

The holding portion 5221 of the holding shaft 522 shown in each of FIG. 23 and part (a) of FIG. 24 includes a main portion 5221b having a substantially square shape in cross section in the XZ flat plane similar to the holding portion 5221 (FIG. 7) in the embodiment 1. Further, this holding shaft 522 is provided with a projected portion 5221a projected toward an outside from the main portion 5221b in the rotational radius direction of the holding shaft 522.

A rotation shaft portion 5222 of the holding shaft 522 shown in each of FIG. 23 and part (a) of FIG. 24 is not provided with the cut-away portion 5222a which was provided to the rotation shaft portion 5222 (FIG. 7) in the embodiment 1 and which is for transmitting the driving force to the holding shaft 522, and has a cylindrical shape. That is, the holding shaft 522 shown in each of FIG. 23 and part (a) of FIG. 24 is not a holding shaft to which power is transmitted from a member such as a supplying member gear 592 (FIG. 8) in the embodiment 1, and is rotated about the rotation axis 522C by the rotation assisting member 571 or the rotation assisting member 572 which are described later.

Further, to the rotational shaft portion 5222 shown in each of FIG. 23 and part (a) of FIG. 24, an urging spring 5731 is made mountable. In the constitution shown in each of FIG. 23 and part (a) of FIG. 24, the urging spring 5731 is mounted to the rotation shaft portion 5222 on the Y axis negative side, but may also be mounted to the rotation shaft portions 5222 on opposite end portion sides with respect to the Y axis direction. The urging spring 5731 is constituted by a torsion coil spring, and includes an engaging portion 5731a in one portion thereof and a portion-to-be-held 5731b in the other end portion thereof. The urging spring 5731 is disposed so as to cover a periphery of the rotation shaft portion 5222. When the urging spring 5731 is mounted to the rotation shaft portion 5222, the engaging portion 5731a of the urging spring 5731 is engaged with the projected portion 5221a. On the other hand, the portion-to-be-held 5731b of the urging spring 5731 is held by a holding portion (not shown) provided to the developing container 53.

The rotation assisting member 571 shown in FIG. 23 includes plate-like paddle portions 5711 and a cylindrical rotation shaft portion 5712. This rotation assisting member 571 is mounted to the developing container 53 by rotatably supporting the rotation shaft portion 5712, provided in each of opposite end portions thereof with respect to the Y axis direction, in a supporting hole portion (not shown) provided in each of opposite end portions of the developing container 53 with respect to the Y axis direction. This rotation assisting member 571 is rotatable in an arrow R9 direction (counterclockwise direction) about a rotational axis 571C extending in the Y axis direction by engaging a rotation assisting member driving gear (not shown) with a cut-away portion 5712a provided to the rotation shaft portion 5712. Further, this rotation assisting member 571 includes four paddle portions 5711 radially around the rotational axis 571C so that a cross section thereof in the XZ flat surface has a substantially cross shape. Incidentally, in FIG. 23, for explanation, the holding shaft 522 and the rotation assisting member 571 are illustrated in a separation manner along broken lines in the figure. However, the holding shaft 522 and the rotation assisting member 571 are disposed so that the projected portion 5221a of the holding shaft 522 and the paddle portions 5711 of the rotation assisting member 571 are engageable with each other. For that reason, the rotation assisting member 571 is rotated in the arrow R9 direction and a driving force is transmitted to the holding shaft 522 through the projected portion 5221a of the holding shaft 522, so that the holding shaft 522 is rotated in the arrow R7a direction (clockwise direction) about the rotational axis 522C. At that time, elastic energy is accumulated in the urging spring 5731. When the rotation assisting member 571 is further rotated in the arrow R9 direction, the paddle portions 5711 of the rotation assisting member 571 and the projected portion 5221a of the holding shaft 522 are not engaged with each other. Then, by the elastic energy accumulated in the urging spring 5731, the holding shaft 522 is rotated in the arrow R7b direction (counterclockwise direction).

The rotation assisting member 572 shown in part (a) of FIG. 24 includes a cam portion 5721 and a cylindrical rotation shaft portion 5722. This rotation assisting member 572 is mounted to the developing container 53 by rotatably supporting the rotation shaft portion 5722, provided in each of opposite end portions thereof with respect to the Y axis direction, in a supporting hole portion (not shown) provided in each of opposite end portions of the developing container 53 with respect to the Y axis direction. This rotation assisting member 572 is, similarly as the rotation assisting member 57 shown in FIG. 23, rotatable in an arrow R9 direction (counterclockwise direction) about a rotational axis 572C extending in the Y axis direction by engaging a rotation assisting member driving gear (not shown) with a cut-away portion 5722a provided to the rotation shaft portion 5722. The cam portion 5721 includes a slow movement portion 5721a and a bent portion 5721b as shown in part (b) of FIG. 24. Further, as shown in part (c) of FIG. 24, the slow movement portion 5721a is constituted so that a radius r thereof in a contact position with the holding shaft 522 linearly becomes large from r1 to r2 in the case where the rotation assisting member 572 is rotated in the arrow R9 direction. Further, as shown in part (c) of FIG. 24, the bent portion 5721b is constituted so that the radius r thereof in the contact position with the holding shaft 522 is returned from r2 to r1 (linearly becomes small) with an inclination larger than that of the slow movement portion 5721a (but in an opposite direction). Incidentally, in part (a) of FIG. 24, for explanation, the holding shaft 522 and the rotation assisting member 572 are illustrated in a separation manner along broken lines in the figure. However, the holding shaft 522 and the rotation assisting member 572 are disposed so that the projected portion 5221a of the holding shaft 522 and the cam portion 5721 of the rotation assisting member 572 are contactable with each other.

By such a constitution, the rotation assisting member 572 is rotated in the arrow R9 direction, so that the holding shaft 522 is rotated depending on a change in radius r of the cam portion 5721 as shown in part (c) of FIG. 24.

That is, by rotating the rotation assisting member 572 in the arrow R9 direction, the slow movement potion 5721a of the rotation assisting member 572 contacts the projected portion 5221a of the holding shaft 522 in a predetermined timing.

Thereafter, the rotation assisting member 572 is further rotated in the arrow R9 direction, so that a rotation radius of the rotation assisting member 572 (slow movement portion 5721a) in the contact position with the holding shaft 572 becomes large, and the rotation assisting member 572 gradually urges the projected portion 5221a of the holding shaft 572 in the arrow R7a direction. By this, the holding shaft 572 is rotated about the rotational axis 522C in the arrow R7a direction (clockwise direction). At that time, the elastic energy is accumulated in the urging spring 5731. Thereafter, when the rotation assisting member 572 is further rotated in the arrow R9 direction, the bent portion 5721b of the rotation assisting member 572 reaches the contact position with the projected portion 5221a of the holding shaft 572, so that the cam portion 5721 and the projected portion 5221a of the holding shaft 572 are not in contact with each other. Then, by the elastic energy accumulated in the urging spring 5731, the holding shaft 522 is rotated in the arrow R7b direction (counterclockwise direction).

Incidentally, to the rotation assisting member driving gear, similar to the driving constitution of the holding shaft 522 in the embodiment 1, the driving force is transmitted from the development driving gear through the supplying member clutch mechanism.

By using the drive constitutions shown in FIGS. 23 and 24, the holding shaft 522 is rotated in both the arrow R7a direction and the arrow R7b direction with a constitution simpler than the drive constitution (FIG. 8) in the embodiment 1. On the other hand, the rotation assisting members 571 and 572 occupy a certain volume in an inside space of the developing container 53. For that reason, in the case where the driving constitutions shown in FIGS. 23 and 24 are used, a volume, in the developing container 53, for accommodating the toner is more decreased than in the case where the driving constitution (FIG. 8) in the embodiment 1 is used. For example, in view of these, the driving constitution of the supplying mechanism 52 can be appropriately selected.

Incidentally, in the examples of FIGS. 23 and 24, the paddle portions 5711 of the rotation assisting member 571 and the cam portion 5721 of the rotation assisting member 572 extended over substantially entire regions of the rotation assisting members 571 and 572, respectively, in the Y axis direction. Similarly, in the examples of FIGS. 23 and 24, the projected portion 5221a of the holding shaft 522 extended over a substantially entire region of the holding shaft 522 in the Y axis direction. However, the present disclosure is not limited to such constitutions. For example, as materials of the rotation assisting members 571 and 572 and the holding shafts 522, a material sufficiently strong in strength is used, and these members may be provided only in a part with respect to the Y axis direction. Further, these members may be divided into a plurality of portions with respect to the Y axis direction.

Further, in order to more facilitate the drive transmission to the projected portion 5221a of the holding shaft 522, at least one of the projected portion 5221a and the paddle portions 5711 may also be further provided with a projected part. Further, as in the case of the rotation assisting members 571 and 572, when the driving force can be directly transmitted to the holding portion 5221 of the holding shaft 5222 without through the rotation shaft portion 5222 of the holding shaft 522, another arbitrary constitution may also be used.

Further, in the example of FIG. 24, the cam portion 5721 of the rotation assisting member 572 had a shape such that the radius r of the slow movement portion 5721a becomes linearly large as shown in part (c) of FIG. 24. However, the present disclosure is not limited to such a constitution. As described in the embodiment 1, when the supplying mechanism 52 can be controlled so as to urge the toner toward the surface of the developing roller 51 during the developing period, a shape of the cam portion 5721 can be appropriately set, and may be, for example, an elliptical shape, an egg-like shape, or the like in cross section. Further, as the rotation assisting members 571a and 572. When a distance from each of the rotational axes 571C and 572C to a contact portion with the holding shaft 522 is changeable, a rotation assisting member having an arbitrary constitution can be used. For example, members having shapes such as a rectangular shape, a shape having a projected portion which is partially cut away, and a crank shape, in cross section, which are shown as the examples of the shapes of the holding shaft 522 in FIG. 22 may also be used as the rotation assisting members 571 and 572.

### Constitution in which Holding Shaft is Slid

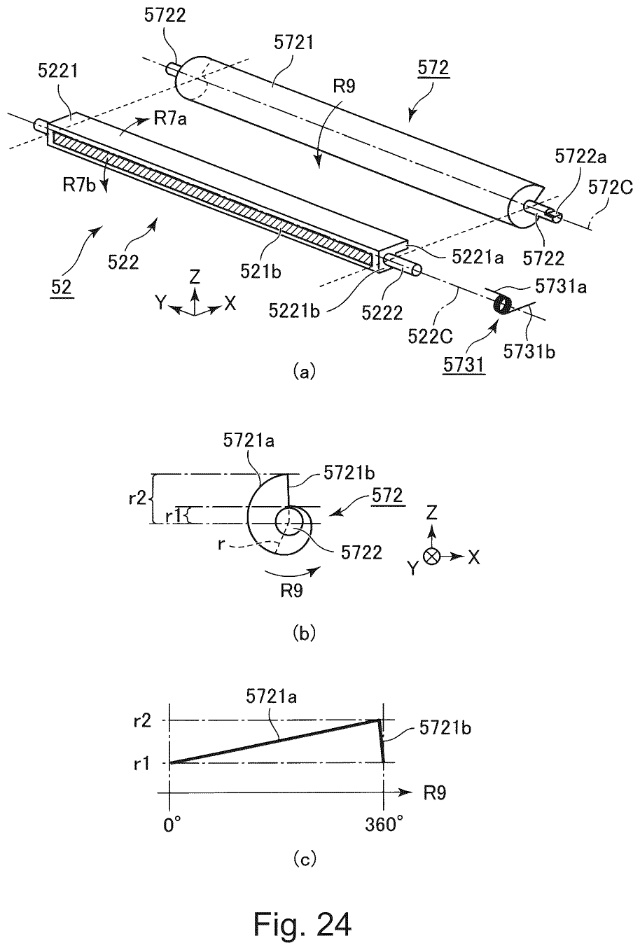

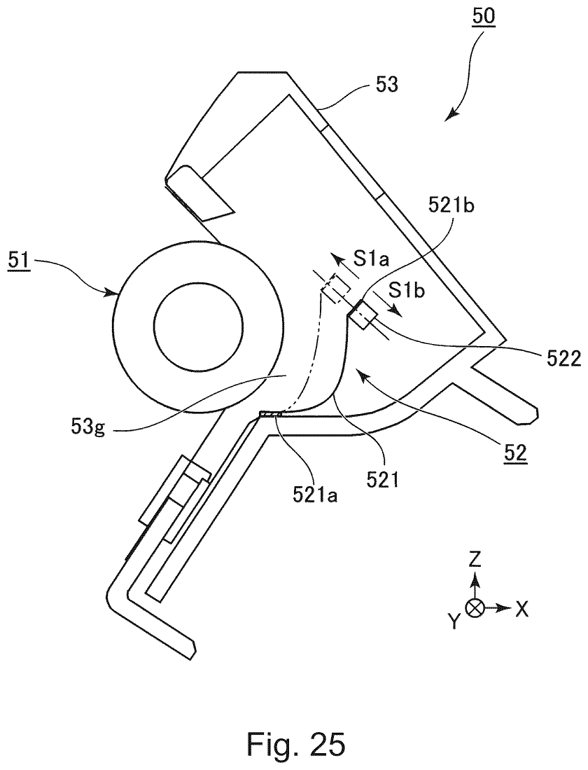

FIG. 25 is a schematic sectional view of another example of the developing unit 50 provided with a driving constitution of a supplying mechanism 52 constituted so that the holding shaft 522 is slid. As shown in FIG. 25, the developing unit 50 may have a constitution in which the holding shaft 522 is slid (reciprocated) in an arrow S1a direction (direction in which the holding shaft 522 approaches the developing roller 51) and in an arrow S1b direction (direction in which the holding shaft 522 is separated from the developing roller 51). Incidentally, in the respective views, the arrow S1a direction shows a movement direction in which the supplying sheet 521 is changed in state from a state (first state) in which flexure thereof is relatively large to a state (second state) in which the flexure thereof is relatively small. Further, in the respective views, the arrow S1 direction shows a movement direction in which the supplying sheet 521 is changed in state from the state (second state) in which the flexure thereof is relatively small to the state (first state) in which the flexure thereof is relatively large.

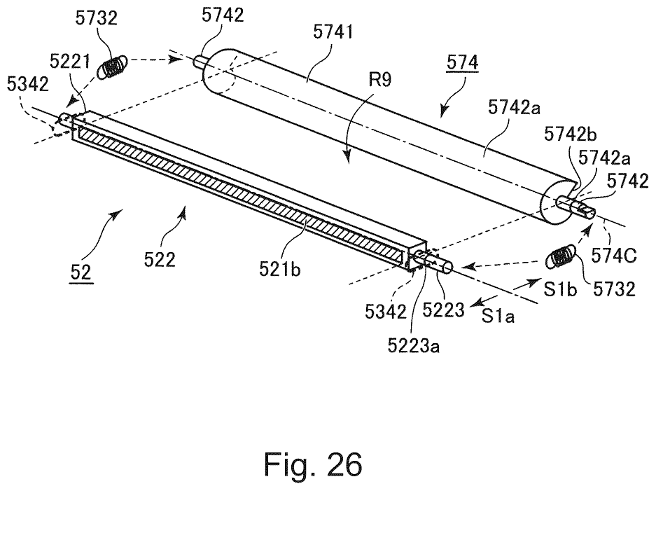

As the constitution in which the holding shaft 522 is made movable in both the arrow S1a direction and the arrow S1b direction, it is possible to use, for example, a constitution as described using FIG. 8, in which a partially-toothless gear and an urging spring are used. Further, a constitution as subsequently described using FIG. 26 may also be used.

FIG. 26 is a schematic exploded perspective view, of a holding shaft 522 and an urging shaft 574 described later, for illustrating a driving constitution constituted so that the holding shaft 522 is slidable (reciprocable). With the holding shaft 522 shown in FIG. 26, the bonding portion 521b, of the supplying sheet 521, for bonding the supplying sheet 521 to the holding shaft 522 is illustrated together.

A basic constitution of the holding shaft 522 shown in FIG. 26 is similar to the constitution of the holding shaft 522 (FIG. 7) in the embodiment 1. However, as regards the holding shaft 522 shown in FIG. 26, a portion-to-be-supported 5223 provided in each of opposite end portions of the holding shaft 522 with respect to the Y axis direction is movably supported in a supporting hole portion 5342 provided in each of opposite end portions of the developing container 53 with respect to the Y axis direction, so that the holding shaft 522 is mounted to the developing container 53. The supporting hole portion 5342 extends along the arrow S1a direction and the arrow S1b direction, so that the holding shaft 522 is movable along the arrow S1a direction and the arrow S1b direction. Incidentally, in the supporting hole portion 5342, a sealing member (not shown) for preventing toner leakage is provided.

The urging shaft 574, shown in FIG. 26, which is another example of the moving member includes a cam portion 5741 and a cylindrical shaft portion 5742, similar to the rotation assisting member 572 described using FIG. 24, and is rotatable in the arrow R9 direction (counterclockwise direction) about a rotational axis 574C extending in the Y axis direction. Further, the cam portion 5741 of this urging shaft 574 includes a slow movement portion 5742a and a bent portion 5742b similar to those of the cam portion 5721 of the rotation assisting member 572 described using parts (b) and (c9 of FIG. 24. The slow movement portion 5742a and the bent portion 5742b of this cam portion 5741 have shapes similar to those described using parts (b) and (c) of FIG. 24.

Incidentally, in FIG. 26, for explanation, the holding shaft 522 and the urging shaft 574 are illustrated in a separation manner along the arrow S1a direction and the arrow S1b direction as indicated by broken lines in the figure. However, the holding shaft 522 and the urging shaft 574 are disposed so that the holding portion 5221 of the holding shaft 522 and the cam portion 5741 of the urging shaft 574 are contactable with each other. Further, on each of opposite end portion sides with respect to the Y axis direction, the portion-to-be-supported 5223 of the holding shaft 522 is provided with a cut-away portion 5223a. Similarly, on each of opposite end portion sides with respect to the Y axis direction, the rotation shaft portion 5742 of the urging shaft 574 is provided with a cut-away portion 5742a. On each of the opposite end portion sides with respect to the Y axis direction, to these cut-away portions 5223a and 5742a, one end portion and the other end portion of the urging spring 5732 constituted by a torsion coil spring are mounted, respectively. By this, the holding shaft 522 and the urging shaft 574 are urged so as to be attracted to each other (in an approaching direction).

Incidentally, the urging shaft 574 is driven by transmitting thereto a driving force through an urging shaft driving gear (not shown) by a driving constitution similar to the driving constitution of the rotation assisting member 572 in the constitution shown in each of the FIGS. 23 and 24.

By such a constitution, the urging shaft 574 is rotated in the arrow R9 direction, so that the holding shaft 522 is slid depending on a change in radius r of the cam portion 5741 similar to the cam potion described using part (c) of FIG. 24. That is, in a state in which the urging shaft 574 has a rotation angle in the neighborhood of 0° shown in part (c) of FIG. 24, the holding shaft 522 is closest to the rotational axis 574C of the urging shaft 574. Then, by rotating the urging shaft 574 in the arrow R9 direction, a rotation radius of the urging shaft 574 (slow movement portion 5741a) in the contact position with the holding shaft 522 becomes large, so that the urging shaft 574 urges the holding shaft 522 in the arrow S1a direction. By this, the holding shaft 522 is slid in the arrow S1a direction. At that time, elastic energy is accumulated in the urging spring 5732. Thereafter, when the urging shaft 574 is further rotated in the arrow R9 direction, the bent portion 5741b of the urging shaft 574 reaches the contact position with the holding shaft 522, so that the holding shaft 522 is slid in the arrow S1b direction by the elastic energy accumulated in the urging spring 5732.

Thus, the holding shaft 522 is capable of being slid (reciprocated) in both the arrow S1a direction (direction in which the holding shaft 522 approaches the developing roller 51) and the arrow S1b direction (direction in which the holding shaft 522 is separated from the developing roller 51). Also, in this case, the holding shaft 522 comes and goes between a state (holding shaft first position) indicated by a solid line and a state (holding shaft second position) indicated by a chain double-dashed line which are shown in FIG. 25, so that the supplying sheet 521 comes and goes between a state (first state, supplying sheet first position) indicated by a solid line and a state (second state, supplying sheet second position) indicated by a chain double-dashed line which are shown in FIG. 25. By this, the toner in the supplying region 53g can be urged toward the surface of the developing roller 51. Further, in the case of the constitution in which the holding shaft 522 is slid, the holding shaft 522 (i.e., the fixing portion 521b of the supplying sheet 521) is moved to a predetermined position, and therefore, compared with the case where the holding shaft 522 is rotated as described above, it becomes easy to manage an amount in which the supplying sheet 521 is brought near to the surface of the developing roller 51 and an amount in which the supplying sheet 521 is moved away from the developing roller 51.

Incidentally, similarly as in the case of the rotation assisting member 572 described using FIG. 24, the shape of the cam portion 5741 of the urging shaft 574 is not limited to the shape shown in FIG. 26. As described in the embodiment 1, when the supplying mechanism 52 can be controlled so that the toner is urged toward the surface of the developing roller 51 during the developing period, the shape of the cam portion 5741 can be appropriately changed.

Further, the urging shaft 574 may have a paddle shape as in the case of the rotation assisting member 571 described using FIG. 23, for example. Further, similar to the cases of the rotation assisting members 571 and 572, the portion (cam portion, paddle portion), in the urging shaft 574, acting on the holding shaft 522 may be provided only in a part thereof with respect to the Y axis direction or may be divided in a plurality of portions with respect to the Y axis direction.

Further, in this embodiment, as shown in FIG. 25, the constitution in which the holding shaft 522 is moved in the arrow S1a direction and the arrow S1b direction opposite to the arrow S1a direction by 180° was described. However, a locus of movement of the holding shaft 522 is not limited to that constituted linearly, but for example, constituted so s to be bent or to draw an arc. Further, the slide direction is not limited to the direction as shown in FIG. 25, but for example, a direction along (for example, substantially parallel to) the X axis direction when the supplying sheet 521 can be moved toward and away from the surface of the developing roller 51.

Thus, the supplying mechanism 52 may include the holding member (holding shaft) 522 which holds the second portion (bonding portion) 521b of the supplying member 521 and which is slidable along a direction crossing the first direction (direction along the rotational axis direction of the developer carrying member 51, and the driving portion 176 may be capable of changing the state of the supplying member 521 to the first state and the second state by sliding the holding member 522.

### Another Constitution in which Holding Shaft is Slid

Another example of the constitution in which the holding shaft 522 is slid in the arrow S1a direction and the arrow S1b direction as shown in FIG. 25 will be described. Part (a) of FIG. 27 is a schematic sectional view of a slide assisting member 575 described later for illustrating another example of a drive constitution of the supplying mechanism 52 constituted so as to slide the holding shaft 522, in which peripheral members such as the holding shaft 522 are shown in combination.

Further, part (b) of FIG. 27 is a schematic plan view in which an outer peripheral surface of the slide assisting member 575 described below is developed.

The slide assisting member 575 is a shaft-like member including a cam portion 5751 and a rotation shaft portion 5752. This slide assisting member 575 is mounted to the developing container 53 by being rotatably supported by a side cover (not shown) mounted a side portion of the developing container 53 on the Y axis negative side. The rotation shaft portion 5752 includes a cut-away portion 5752a, and with this cut-away portion 5752a, a slide assisting member driving gear (not shown) is engaged. By this, the slide assisting member 575 is rotatable in an arrow R10 direction (counterclockwise direction as viewed in the arrow S1a direction) about a rotational axis 575C substantially parallel to the arrow S1a direction and the arrow S1b direction. The cam portion 5751 is a barrel cam including a groove portion 5751a, and this groove portion 5751a is engaged with a portion-to-be-supported 5223 of the holding shaft 522 on the Y axis negative side. By this, the holding shaft 522 becomes possible to be slid in the arrow S1a direction and the arrow S1b direction by following the cam portion 5751.

Incidentally, in the cam portion 5751, with respect to the groove portion 5751a, a projected portion on an upstream side in the arrow S1a direction (on a downstream side in the arrow S1b direction) is referred to as a first projected portion 5751b. Further, in the cam portion 5751 with respect to the groove portion 5751a, a projected portion on a downstream side in the arrow S1a direction (on an upstream side in the arrow S1b direction) is referred to as a second projected portion 5751c. Further, the groove portion 5751a includes, as shown in part (b) of FIG. 27, a slow movement portion 5751a1 moderately inclined with respect to the arrow R10 direction and a bent portion 5751a2 abruptly inclined (but in a direction opposite to the direction of the slow movement portion 5751a1) with respect to the arrow R10 direction.

Further, to the cut-away portion 5223a provided to the portion-to-be-supported 5223 of the holding shaft 522 on the Y axis negative side, one end portion of the urging spring 5732 constituted by an extension coil spring (helical extension spring) is mounted. Further, the developing container 53 is provided with a supporting projection 535 positioned on an upstream side in the arrow S1a direction (on a downstream side in the arrow S1b direction) relative to the supporting hole portion 5342. The other end portion of the urging spring 5732 is mounted to this supporting projection 535. Incidentally, the supporting projection 535 is provided with a returning portion 535a projected toward the upstream side in the arrow S1a direction (downstream side in the arrow S1b direction), so that demounting (disengagement) of the urging spring 5732 from the supporting projection 535 is prevented. By this urging spring 5732, the holding shaft 522 is urged in the arrow Sb1 direction.

By such a constitution, the slide assisting member 575 is rotated in the arrow R10 direction, so that when the portion-to-be-supported 5223 is engaged with the slow movement portion 5751a1 (part (b) of FIG. 27), the slide assisting member 575 slides the holding shaft 522 in the arrow S1a direction. At that time, elastic energy is accumulated in the urging spring 5732. Thereafter, when the portion-to-be-supported 5223 is engaged with the bent portion 5751a2 (part (b) of FIG. 27), the holding shaft 522 is urged in the arrow S1b direction by the urging spring 5732, and is slid in the arrow S1b direction.

Thus, it is possible to move the holding shaft in both the arrow S1a direction and the arrow S1b direction. Also, in this case, the holding shaft 522 comes and goes the state (holding shaft first position) indicated by the solid line in FIG. 25 and the state (holding shaft second position) indicated by the chain double-dashed line in FIG. 25, whereby the supplying sheet 521 comes and goes the state (first state, supplying sheet first position) indicated by the solid line in FIG. 25 and the state (second state, supplying sheet second position) indicated by the chain double-dashed line in FIG. 25. By this, the toner in the supplying region 53g can be urged toward the surface of the developing roller 51. Further, by using the slide assisting member 575 as shown in FIG. 27, even in a constitution in which the holding shaft 522 is slid, similarly as in the case of the constitution (FIG. 8) of the embodiment 1, the space in the developing container 53 can be used widely, so that a toner filling amount can be increased.

Incidentally, the constitution of the slide assisting member 575 is not limited to the constitution shown in FIG. 27. For example, the holding shaft 522 is always urged in the arrow S1b direction by the urging spring 5732. By this, the portion-to-be-supported 5223 of the holding shaft 522 is moved in contact with a boundary surface between the first projected portion 5751b and the groove portion 5751a in the cam portion 5751 of the slide assisting member 575. For that reason, the second projected portion 5751c in the constitution shown in FIG. 27, and a portion corresponding to the second projected portion 5751c may have the same height (rotation radius) as the groove portion 5751a. Further, for example, a constitution in which a rail-like projected portion is provided on an outer peripheral surface of the cam portion 5751 of the slide assisting member 575 and in which a member engaging with this projected portion is provided to the holding shaft 522 may also be employed.

### Embodiment 3

Next, another embodiment of the present disclosure will be described. In this embodiment, a member for supporting the supplying sheet 521 in contact with a surface between the fixing portion 521a and the bonding portion 521b of the supplying sheet 521 will be principally described. Further, in this embodiment, in addition to the case where the present disclosure is applied to an image forming apparatus 1 having a basic constitution similar to the basic constitution of the embodiment 1, the case where the present disclosure is applied to an image forming apparatus 1 having a basic constitution different from the basic constitution of the embodiment 1 will be also described.

### Example of Suspension Shaft

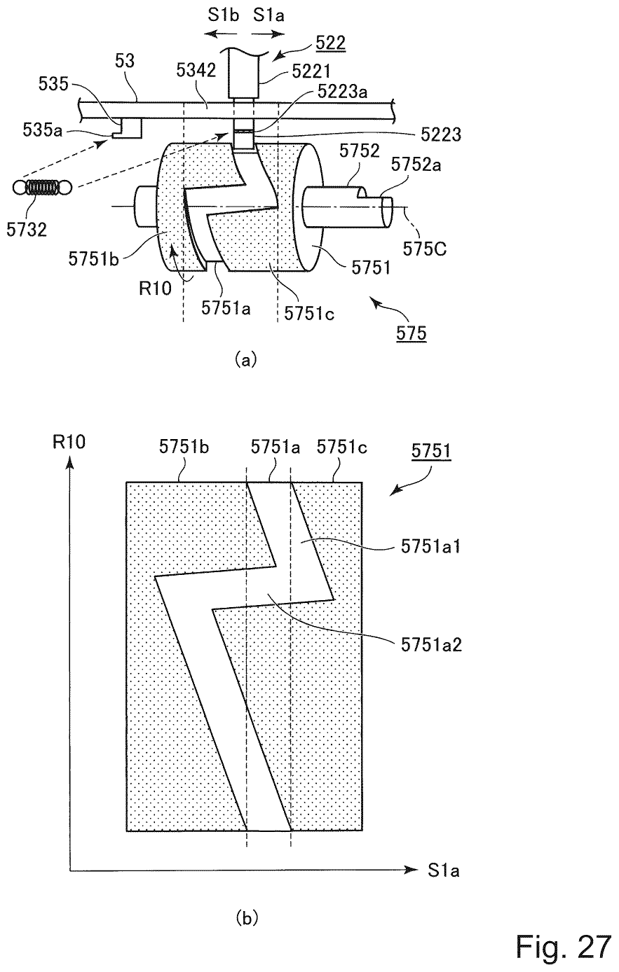

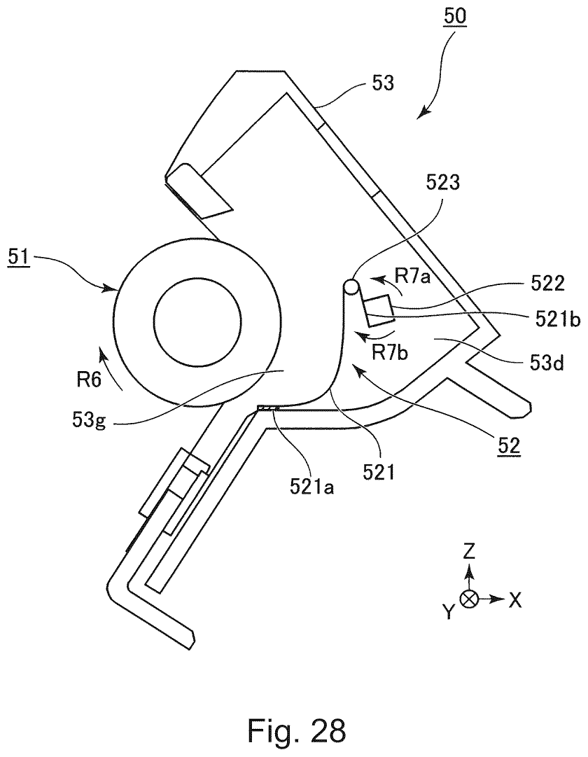

FIG. 28 is a schematic sectional view of an example of the developing unit 50 in this embodiment. In a constitution shown in FIG. 28, a supplying mechanism 52 is constituted by including the supplying sheet 521, the holding shaft 522, and a suspension shaft 523 as a supporting member (suspension member) for supporting the supplying sheet 521 in contact with the surface between the fixing portion 521a and the bonding portion 521b of the supplying sheet 521. In the constitution shown in FIG. 28, the suspension shaft 523 is constituted by a cylindrical bar member substantially circular in cross section in the XZ flat plane. This suspension shaft 523 is disposed so that a longitudinal direction thereof extends along the Y axis direction. Further, this suspension shaft 523 is mounted to the developing container 53 by being supported in a supporting hole portion (not shown) provided in each of opposite end portions of the developing container 53 with respect to the Y axis direction. Further, this suspension shaft 523 contacts a surface of the supplying sheet 521 opposing the rear surface-side region 53d. The holding shaft 522 is rotated in the arrow R7a direction or the arrow R7b direction, and the supplying sheet is moved so as to be pulled or returned through a portion extended around the suspension shaft 523, so that a degree of flexure in a portion on a fixing portion 521a side than the suspension shaft 523 can be changed.

Also, in such a constitution, similarly as in the embodiment 1, the supplying sheet 521 is brought near to the surface of the developing roller 51 by rotating the holding shaft 522 in the arrow R7a direction (counterclockwise direction), so that the toner in the supplying region 53g can be urged toward the surface of the developing roller 51. Further, by employing the constitution in which the supplying sheet 521 is pulled or returned through the suspension shaft 523, it is possible to enhance a degree of freedom of arrangement of the supplying sheet 521 and the holding shaft 522 and a degree of freedom of a constitution of the supplying sheet 521 and the holding shaft 522.

### Another Example of Suspension Shaft

Further, the developing unit 50 may also have a constitution in which the approaching operation and the separating operation of the supplying sheet 521 relative to the surface of the developing roller 51 are controlled by controlling an operation of an operable suspension shaft 523.

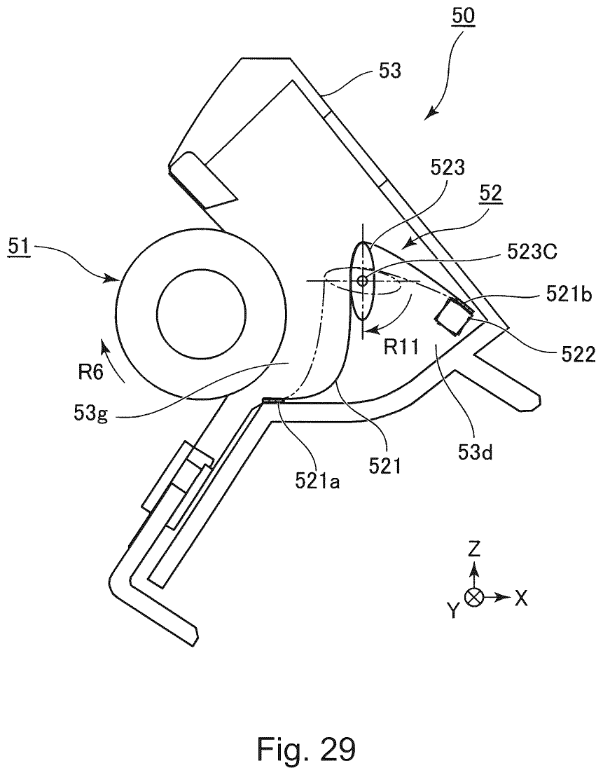

FIG. 29 is a schematic sectional view of another example of the developing unit 50 in the present disclosure. In a constitution shown in FIG. 29, the suspension shaft 523 is constituted by a bar member substantially elliptical in cross section in the XZ flat plane. This suspension shaft 523 is disposed so that a longitudinal direction thereof extends along the Y axis direction similarly as the suspension shaft 523 in the constitution shown in FIG. 28. Further, this suspension shaft 523 is mounted to the developing container 53 in such a manner that rotation shafts (not shown) thereof provided in opposite end portions with respect to the Y axis direction thereof are supported in supporting hole portions (not shown), respectively, provided in opposite end portions of the developing container 53 with respect to the Y axis direction. Further, this suspension shaft 523 contacts a surface of the supplying sheet 521 opposing the rear surface-side region 53d. In the constitution shown in FIG. 29, the suspension shaft 523 is constituted so as to be rotated in an arrow R11 direction (clockwise direction) about a rotational axis 523C extending in the Y axis direction by transmitting a driving force from a suspension shaft driving gear (not shown), engaging with the suspension shaft 523, to the suspension shaft 523. In this case, the suspension shaft 523 is rotated in the arrow R11 direction, so that the supplying sheet 521 is capable of being changed in state to a first state (supplying sheet first position, separation state) indicated by solid line in FIG. 29 and a second state (supplying sheet second position, approach state). The first state of the supplying sheet 521 is a state in which the flexure is relatively large (in this example, largest), and the second state of the supplying sheet 521 is a state in which the flexure is relatively small (in this example, smallest). Further, in this case, a phase of the suspension shaft 523 in which the supplying sheet 521 is in the first state is a first phase (suspension shaft first position), and a phase of the suspension shaft 523 in which the supplying sheet 521 is in the second state is a second phase (suspension shaft second position). In this example, the suspension shaft 523 becomes the first phase and second phase each two times during rotation thereof through one full circumference (one full turn). By this, the toner in the supplying region 53g can be urged toward the surface of the developing roller 51.

Incidentally, to the suspension shaft driving gear, the driving force is transmitted from the development driving gear through the clutch mechanism similarly as in the drive constitution of the holding shaft 522 in the embodiment 1.

Thus, a function of moving the supplying sheet 521 toward and away from the surface of the developing roller 51 can be imparted to a member other than the holding shaft 522. By this, it is possible to enhance a degree of freedom of arrangement of the supplying sheet 521 and the holding shaft 522 and a degree of freedom of a constitution of the supplying sheet 521 and the holding shaft 522, in a space formed by the developing container 53. Incidentally, the supplying sheet 521 can be moved toward and away from the surface of the developing roller 51 by operating at least one (may be both) of the holding shaft 522 and the suspension shaft 523.

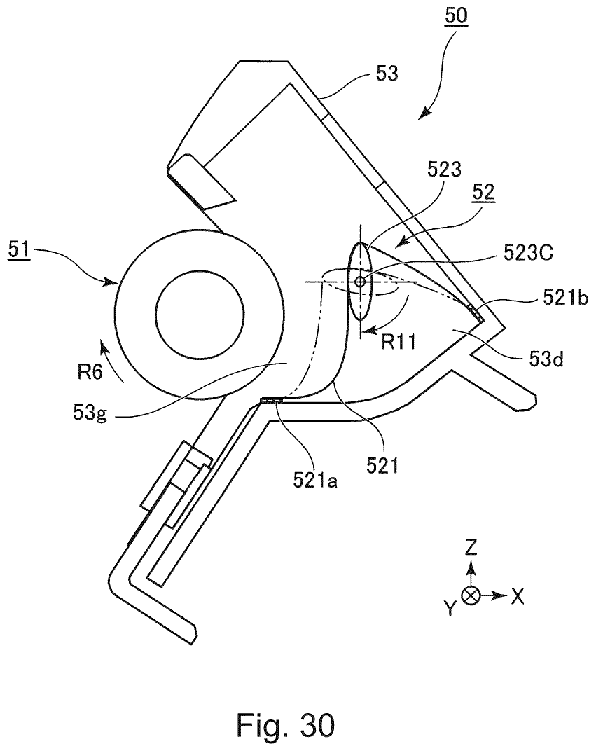

Here, for example, as in the constitution shown in FIG. 29, in the constitution in which the approaching operation and the separating operation of the supplying sheet 521 relative to the surface of the developing roller 51 are controlled by the suspension shaft 523, a mechanism for rotating the holding shaft 522 is not particularly required. For that reason, the holding shaft 522 may be constituted so as to be swung about the rotational axis 522C or may be fixed to the developing container 53 so as not to be rotated. Further, as subsequently described using FIG. 30, the bonding portion 521b of the supplying sheet 521 is not limited to the bonding portion fixed (bonded) to the holding shaft 522.

FIG. 30 is a schematic sectional view of another example of the developing unit 50 in this embodiment. As shown in FIG. 30, the bonding portion 521b of the supplying sheet 521 may also be fixed to an inner wall of the developing container 53, not the holding shaft 522. In this case, the supplying mechanism 52 is constituted by including the supplying sheet 521 and the suspension shaft 523 and does not include the holding shaft 522. Also, in this case, the approaching operation and the separating operation of the supplying sheet 521 relative to the surface of the developing roller 51 are controlled by the suspension shaft 523, whereby the toner in the supplying region 53g can be urged toward the surface of the developing roller 51.

Incidentally, in the constitution in which the approaching operation and the separating operation of the supplying sheet 521 relative to the surface of the developing roller 51 by the suspension shaft 523, a cross-sectional shape of the suspension shaft 523 in the XZ plane is not limited to those shown in FIGS. 29 and 30. For example, the cross-sectional shape may also be a rectangular shape, an egg-like shape, or the cross-sectional shape such as that of the rotation assisting member 572 described using FIG. 24. Further, the constitution in which the approaching operation and the separating operation of the supplying sheet 521 relative to the surface of the developing roller 51 are controlled by the suspension shaft 523 is not limited to the constitution in which the suspension shaft 523 is rotated. For example, such a constitution may also be a constitution in which the suspension shaft 523 is slid by a mechanism using the urging shaft 574 described using FIG. 26 or the slide assisting member 575 described using FIG. 27, or the like. Further, when a constitution in which the supplying mechanism 52 can be controlled so as to urge the toner toward the surface of the developing roller 51 during the developing period is employed, an arbitrary constitution may be used instead of the suspension shaft 523. For example, the state of the supplying sheet may also be controlled by using a reciprocable actuator, a balloon-like member changeable in volume by inflow and outflow of air. Further, the state of the supplying sheet 521 may also be controlled by direct inflow/outflow of air into/from the rear surface-side region 53d.

Thus, the supplying mechanism 52 may include the supporting member (suspension shaft) 523 for supporting the supplying member 521 between the first portion (fixing portion) 521a and the second portion (bonding portion) 521b with respect to the second direction (direction crossing the rotational axis direction of the developer carrying member 51). Further, the supplying mechanism 52 may also include the operable supporting member 523, and the driving portion 176 operates the supporting member 523, whereby the state of the supplying member may be capable of being changed to the first state and the second state. Further, the supporting member 523 may be rotatable about the rotational axis along the first direction (direction along the rotational axis direction of the developer carrying member 51).

### Supplying Sheet Sealing Member

Further, the suspension shaft 523 is not limited to those provided in positions separated from the inner wall of the developing container 53 s shown in FIGS. 28 to 30.

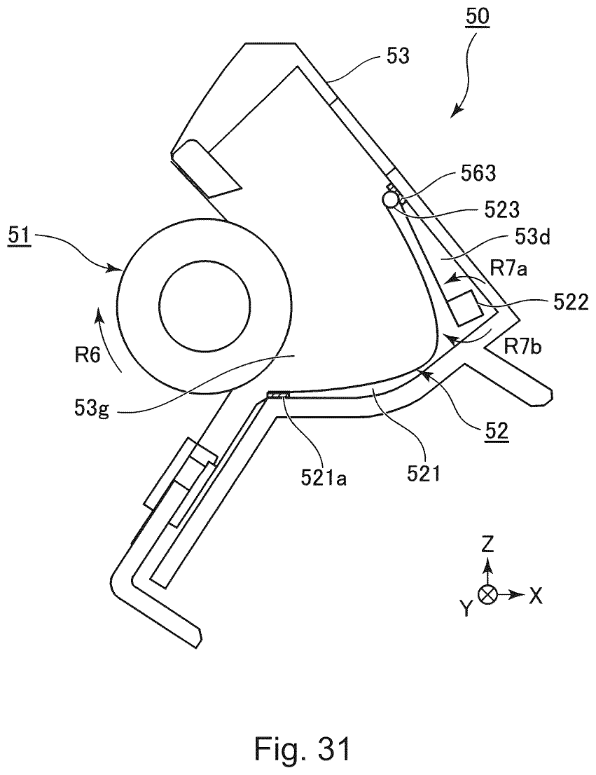

FIG. 31 is a schematic sectional view of another example of the developing unit 50 in this embodiment. In a constitution shown in FIG. 31, the suspension shaft 523 is provided in the neighborhood of the inner wall of the developing container 53. The suspension shaft 523 in the constitution shown in FIG. 31 is similar to the suspension shaft 523 in the constitution shown in FIG. 28. Further, the inner wall of the developing container 53 is provided with a supplying sheet sealing member 563. The supplying sheet sealing member 563 includes a base layer formed with a flexible sponge, and an adhesive layer, and the adhesive layer is bonded to the inner wall of the developing container 53, so that the supplying sheet sealing member 563 is fixed to the inner wall of the developing container 53. The supplying sheet 521 is nipped by this supplying sheet sealing member 563 and the suspension shaft 523. By this, a gap between the supplying sheet 521 and the inner wall of the developing container 53 is closed, so that it is possible to suppress that the toner goes around to the rear surface-side region 53d. Further, also in this case, a degree of flexure of the supplying sheet 521 can be adjusted by rotating the holding shaft 522.

Incidentally, as in the constitution of FIG. 31, in the case of the constitution in which the toner is suppressed from going around to the rear surface-side region 53d by the supplying sheet sealing member 563, as described using FIG. 9, there is no need to consider that the toner gone around to the rear surface-side region 53g is processed by rotating the rotary main body 90. That is, the developing unit 50 having the constitution as shown in FIG. 31 can be used, as described in the following, also in an image forming apparatus 1 having a basic constitution different from the basic constitution of the image forming apparatus 1 of the rotary development type as shown in FIG. 1.

### Another Example of Image Forming Apparatus 1

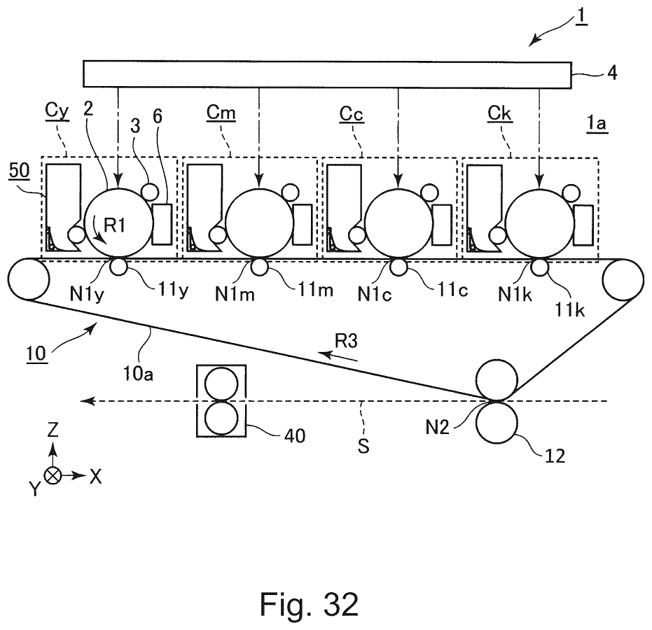

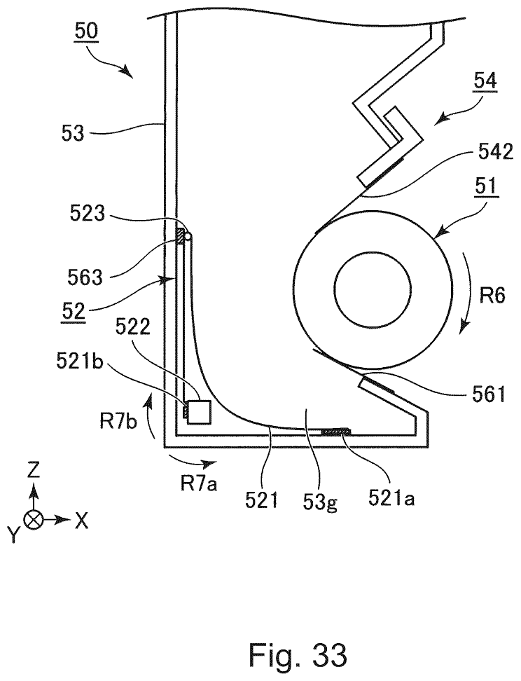

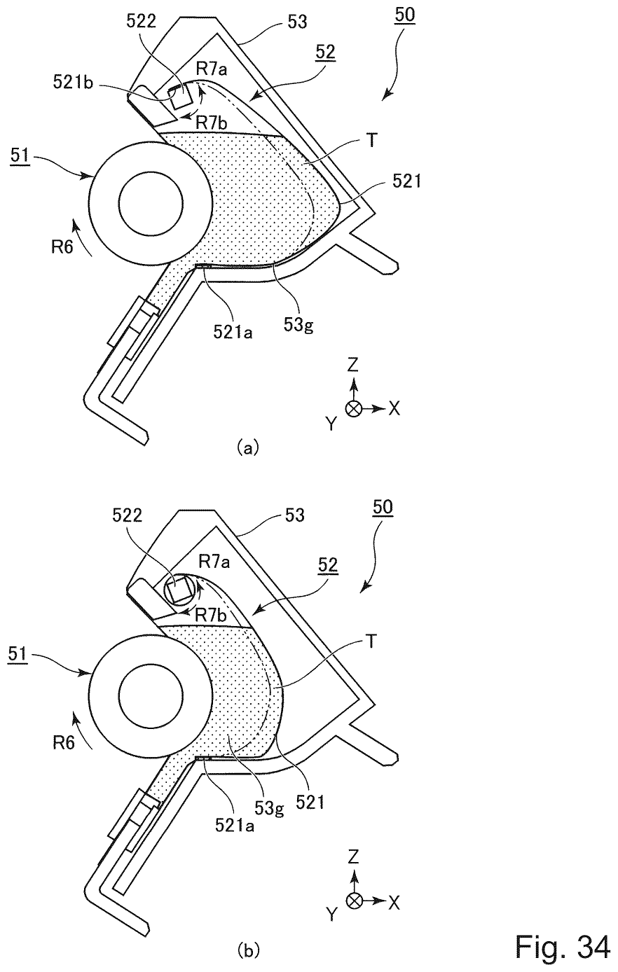

FIG. 32 is a schematic sectional view of another example of the image forming apparatus 1. Further, FIG. 33 is a schematic sectional view of a developing unit 50 used in the image forming apparatus 1 shown in FIG. 32.

The image forming apparatus 1 shown in FIG. 32 is a tandem-type color laser printer which is capable of forming a full-color image on a sheet S by using an electrophotographic type and which employs an intermediary transfer type. This image forming apparatus 1 includes a plurality of process cartridges Cy, Cm, Cc, and Ck, a scanner 4, an intermediary transfer unit 10, a secondary transfer roller 12, a fixing device 40, and the like. Each of the process cartridges Cy, Cm, Cc, and Ck includes a photosensitive drum 2, a charging roller 3, a developing unit 50, and a photosensitive drum cleaning unit 6. The process cartridges Cy, Cm, Cc, and Ck are integrally detachably mountable to an image forming apparatus main assembly 1a. The process cartridges Cy, Cm, Cc, and Ck have the substantially same constitution except that colors of toner accommodated in the associated developing units 50 are different from each other. In the developing units 50 of the process cartridges Cy, Cm, Cc, and Ck for the colors of yellow, magenta, cyan, and black, respectively, the toner of yellow, the toner of magenta, the toner of cyan, and the toner of black are accommodated, respectively. The intermediary transfer unit 10 includes an intermediary transfer belt 10a, primary transfer rollers 11y, 11m, 11c, and 11k provided correspondingly to the associated photosensitive drums 2, respectively, and the like. The primary transfer rollers 11y, 11m, 11c, and 11k from primary transfer nips N1y, N1m, N1c, and N1k, respectively. Further, the secondary transfer roller 12 forms a secondary transfer nip N2. In this image forming apparatus 1, toner images of the respective colors formed on the photosensitive drums 2 in the process cartridges Cy, Cm, Cc, and Ck are primarily transferred so as to be successively superposed onto the intermediary transfer belt 10a in the primary transfer nips N1. The toner images formed on the intermediary transfer belt 10a are secondarily transferred onto the sheet S in the secondary transfer nip N2, and are fixed on the sheet S by the fixing device 40.

Further, as shown in FIG. 33, the developing unit 50 provided in the image forming apparatus 1 shown in FIG. 32 has a constitution similar to the constitution of the developing unit 50 shown in FIG. 31. A supplying mechanism 52 provided to this developing unit (FIG. 33) is such that a fixing portion 521a of a supplying sheet 521 is fixed to an inner wall of a developing container 53 and a bonding portion 521b is bonded to the holding shaft 522 and that a surface between the fixing portion 521a and the bonding portion 521b is supported by a suspension shaft 523. Further, the supplying sheet 521 is nipped by a supplying sheet sealing member 563 provided to the inner wall of the developing container 53 and by the suspension shaft 523.

Also, in such a constitution, the holding shaft 522 is rotated in the arrow R7a direction, whereby the toner existing in a supplying region 53g can be urged toward a surface of a developing roller 51. Accordingly, the toner can be stably supplied to the surface of the developing roller 51 while alleviating a change in performance of the toner accommodated in the developing unit 50.

Incidentally, the constitution of the image forming apparatus 1 capable of using the developing unit 50 having a constitution as shown in FIG. 31 is not limited to the constitutions shown in FIGS. 1 and 32. For example, the developing unit 50 having the constitution as shown in FIG. 31 can also be used in an image forming apparatus using a developing unit 50 of a scoop-up type described later in embodiment 6 appearing hereinafter or in an image forming apparatus for a black monochromatic color in which magnetic toner is used.

### Embodiment 4

Next, another embodiment of the present disclosure will be described. In the embodiments 1 to 3, the constitutions each in which the holding shaft 522 comes and goes between the first phase d1 and the second phase d2 which are particular phases and thus the supplying sheet 521 comes and goes between the first state and the second state was described. On the other hand, the holding shaft 522 not only comes and goes between the particular phases but also may be capable of winding up the supplying sheet 521 as desired. By this, for example, depending on an amount of the toner accommodated in the developing container 53 or the like, it becomes possible to change the phases between which the holding shaft 522 comes and goes. In this embodiment, although description will be made on the assumption that the present disclosure is applied to an image forming apparatus 1 having a basic constitution similar to the basic constitution of the image forming apparatus 1 of the embodiment 1, the present disclosure is also applicable to the image forming apparatus 1 having the constitution shown in FIG. 32 described in the embodiment 3.

### Another Example of Control of Holding Shaft

Parts (a) and (b) of FIG. 34 are schematic sectional views of an example of a developing unit 50 in this embodiment. Part (a) of FIG. 34 shows a state in which an amount of the toner accommodated in the developing container 53 is relatively large, and part (b) of FIG. 34 shows a state in which the amount of the toner accommodated in the developing container 53 is decreased from the state shown in part (a) of FIG. 34.

In the state shown in part (a) of FIG. 34 in which the amount of the toner is large, in the image forming operation, the phase of the holding shaft 522 is controlled so that the supplying sheet 521 comes and goes between the first state indicated by a solid line and the second state indicated by a chain double-dashed line. Thereafter, the image forming operation is repetitively performed, so that when the toner in the developing container 53 is decreased, a developer (toner) surface of the toner in the developing container 53 becomes low in height in a state of the supplying sheet 521 shown in part (a) of FIG. 34. That is, an area in which a (toner) receiving surface 51a of the developing roller 51 contacts the toner is decreased.

On the other hand, as shown in part (b) of FIG. 34, by rotating the holding shaft 522 in the arrow R7a direction by a predetermined amount, the supplying sheet 521 is wound about the holding shaft 522 by a predetermined amount, whereby a volume of the supplying region 53g can be decreased. By this, even in the case where the toner accommodated in the developing container 53 is decreased, the developer surface of the toner in the developing container 53 can be maintained in a sufficiently high state, so that it is possible to suppress that an opportunity of contact of the toner with the surface of the developing roller 51 is decreased.

Then, as shown in part (b) of FIG. 34, a state in which the supplying sheet 521 is wound by a predetermined amount by rotating the holding shaft 522 is set as a reference of the phase of the holding shaft 522 when the phase of the holding shaft 522 is controlled in the image forming operation. That is, in the state shown in part (b) of FIG. 34, the phase of the holding shaft 522 is controlled in the image forming operation so that the supplying sheet 521 comes and goes between a third state (reference state) indicated by a solid line and a fourth state indicated by a chain double-dashed line. The third state of the supplying sheet 521 is a state in which the flexure is relatively large in the case where the supplying sheet 521 is wound up around the holding shaft 522 by a predetermined amount, and the fourth state of the supplying sheet 521 is a state in which the flexure is relatively small in the winding-up case. Further, in this case, the phase of the holding shaft 522 in which the supplying sheet 521 is in the third state is a third phase (holding shaft third position), and the phase of the holding shaft 522 in which the supplying sheet 521 is in the fourth state is a fourth phase (holding shaft fourth position).

By employing such a constitution, when the amount of the toner accommodated in the developing container 53 is changed, a predetermined height of the developer surface of the toner in the developing container 53, i.e., a contact opportunity of the toner with the surface of the developing roller 51 can be maintained. In addition, the supplying mechanism 52 can be controlled so as to urge the toner toward the surface of the developing roller 51 during the developing period.

Incidentally, as a means for discriminating the amount of the toner accommodated in the developing container 53, it is possible to use an available arbitrary means. For example, in the controller 150, a time (pixel number) in which the photosensitive drum 2 is irradiated with laser light during the image formation, and information on a count result thereof is stored in a storing portion (memory (not shown) or the like mounted to the developing unit 50).

Then, in the controller 150, on the basis of this information (integrated value of the pixel number or the like), the amount (remaining toner amount, toner use amount) of the toner in the developing container 53 can be discriminated. Further, a type in which the developing container 53 is provided with a light receiving window through which light passes and the amount of the toner in the developing container 53 is discriminated on the basis of a degree of transmission of the light emitted toward this light receiving window may also be used. Further, a type in which the inner wall of the developing container 53 is provided with an electroconductive sheet material and the amount of the toner in the developing container 53 is discriminated on the basis of a value of a current flowing through between this sheet material and the developing roller 51 may also be used. Further, the amount of the toner in the developing container 53 may also be discriminated on the basis of a density of a predetermined test pattern transferred onto the intermediary transfer belt 10a. For example, a density sensor for detecting the amount of the toner transferred on the intermediary transfer belt 10a is provided to the intermediary transfer unit 10 or the like. Further, for example, as described using part (b) of FIG. 18, the predetermined test pattern is formed in a state in which the approaching operation of the supplying sheet 521 to the surface of the developing roller 51 is not performed. Then, on the basis of whether or not the density of the test pattern transferred on the intermediary transfer belt 10a satisfies a predetermined condition, the amount of the toner in the developing container 53 can be discriminated. That is, in the case where the amount of the toner accommodated in the developing container 53 is decreased and the opportunity of the contact of the toner with the surface of the developing roller 51 is decreased as described above, the white void as shown in (b3) of FIG. 18 becomes liable to occur in the test pattern. By detecting this white void by the density sensor, the amount of the toner in the developing container 53 can be discriminated. The controller 150 is capable of performing a setting and control of the operation of the holding shaft on the basis of a detection result by a detecting means for detecting the amount of the toner accommodated in the developing container 53 as described above.

Further, in the state shown in part (b) of FIG. 34, a mechanism for causing the holding shaft 522 not to be returned to the state shown in part (a) of FIG. 34 by the urging spring 593 may be provided to the developing unit 50. For example, a constitution in which the supplying member gear 591 is provided with a claw-like member such as a stopper and rotation of the holding shaft 522 is stopped by the claw-like member so that the holding shaft 522 is not rotated in a predetermined amount or more in the arrow R7b direction. Further, for example, control may also be carried out using an electromagnetic clutch so that the holding shaft 522 is not rotated in a predetermined amount or more in the arrow R7b direction. By employing such a constitution, for example, in the case where the toner is supplied to the developing container 53, the electromagnetic clutch can be controlled so as to permit rotation of the holding shaft 522 in the arrow R7b direction by exceeding the above-described predetermined amount. By this, the state of the supplying sheet 521 can be returned to the state in which the supplying sheet 521 is not wound up around the holding shaft 522 as shown in part (a) of FIG. 34.

Further, a phase difference (for example, a difference between the first phase d1 and the second phase d2) of the holding shaft 522 changed during the image formation may be changed depending on the amount of the toner accommodated in the developing container 53. For example, in view of a lowering in flowability or the like due to deterioration of the toner caused by repetitive use of the developing unit 50, it is possible to carry out control so that the phase difference becomes larger in the case where the amount of the toner in the developing container 53 is small than in the case where the amount of the toner in the developing container 53 is large. Further, a change amount (for example, an inclination in the case where the phase is changed linearly from the first phase d1 to the second phase d2) of the phase with respect to the time may be changed depending on the amount of the toner accommodated in the developing container 53. For example, in view of a factor similar to the above-described factors, it is possible to carry out control so that the change amount of the phase with respect to the time becomes larger in the case where the amount of the toner in the developing container 53 is small than in the case where the amount of the toner in the developing container 53 is large. By this, control for urging the toner to the surface of the developing roller 51 can be appropriately carried out depending on the amount of the toner accommodated in the developing container 53 in some cases. Incidentally, at least one of a reference of the phases of the holding shaft 522 between which the holding shaft 522 comes and goes, a phase difference between the phases, and the change amount of the phase with respect to the time which are as described above can be changed depending on the amount of the toner accommodated in the developing container 53.

Further, until now, description was made as to that the setting of the reference of the phases between which the holding shaft 522 comes and goes is made, but the setting may also be made depending on another condition.

For example, as described above, the flowability of the toner lowers in some instances in the case where the developing unit 50 was repetitively used or in the case where the image forming apparatus 1 was used in a low-temperature environment, or in the like case. For that reason, the reference of the phases between which the holding shaft 522 comes and goes may also be set depending on a change in cumulative use amount of the developing unit 50 or a change in use environment of the image forming apparatus 1, such as a temperature/humidity environment. The same applies to the above-described phase difference between the phases of the holding shaft 522 and the above-described change amount of the phase with respect to time. The setting can be made on the basis of the information stored in the memory provided to the developing unit 50, a detection result of a temperature/humidity sensor, which are as described above.

### Another Example of Developing Unit in Accordance with this Embodiment

Also, in this embodiment, as described in the embodiment 2, the constitution of the supplying mechanism 52 and the drive constitution of the supplying mechanism 52 can be appropriately selected. For example, also in this embodiment, the developing unit 50 may also employ a constitution in which the holding shaft 522 is swung or a constitution in which the holding shaft 522 is slid.

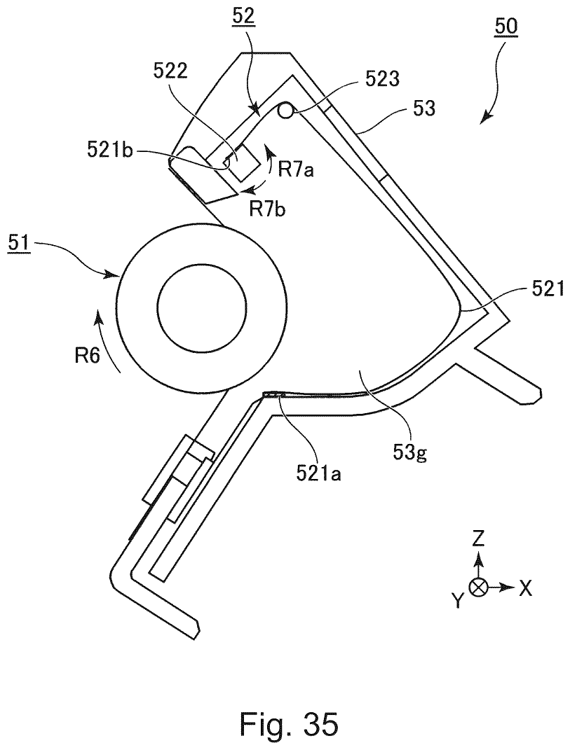

Further, also in this embodiment, as described in the embodiment 3, the supplying mechanism 52 may be constituted by including the suspension shaft 523. FIG. 35 is a schematic sectional view of another example of the developing unit 50 in this embodiment. A supplying mechanism 52 provided in this developing unit 50 has a constitution similar to the constitution shown in FIG. 34, but includes a suspension shaft 523. The suspension shaft 523 in the constitution shown in FIG. 35 is similar to the suspension shaft 523 in the constitution shown in FIG. 28. Incidentally, in the constitution shown in FIG. 35, the suspension shaft 523 is provided so as to contact a surface of the supplying sheet 521 opposing the supplying region 53g. Thus, the surface of the supplying sheet 521 to which the suspension shaft 523 is contacted can be appropriately set depending on the constitution of the supplying mechanism 52.

Further, as described in the embodiment 3, the state of the supplying sheet 521 during the image formation may be controlled by the suspension shaft 523 or may also be controlled by an actuator or a balloon-like member. In that case, as described using FIG. 30, the fixing portion 521a and the bonding portion 521b of the supplying sheet 521 may be fixed to the inner wall of the developing container 53.

Further, also in the case where the reference to phases between which the holding shaft 522 comes and goes, the phase difference between the phases, and the change amount of the phase with respect to the time are changed depending on the amount of the toner in the developing container 53, or the like, which are described above, the control may be carried out by the balloon-like member or the like.

### Constitution in which Supplying Sheet Also Functioning as Pre-Use Sealing Member

Further, the developing unit 50 may also employ a constitution in which the supplying sheet 521 also functions as a pre-use sealing member for sealing the toner in the developing container 53 before use of the developing unit 50 is started (during non-use).

Parts (a) and (b) of FIG. 36 are schematic sectional views of another example of the developing unit 50 in this embodiment. Part (a) of FIG. 36 shows the developing unit 50 in a state before use of the developing unit 50 is started, and part (b) of FIG. 36 shows the developing unit 50 in a state in which the developing unit 50 is usable for image formation after initial setting control described later is ended.

The developing unit 50 shown in FIG. 36 has a constitution similar to the constitution of the developing unit 50 shown in FIG. 35, but is different from the constitution shown in FIG. 35 in length between the fixing portion 521a and the bonding portion 521b of the supplying sheet 521 and in that the supplying sheet 521 also functions as the pre-use sealing member.

As shown in part (a) of FIG. 36 in a state before the use of the developing unit 50 is started, the supplying sheet 521 is disposed along an inner wall of the developing container 53 from the fixing portion 521a fixed to the inner wall of the developing container 53 and is extended around the suspension shaft 523 and the holding shaft 522, and thereafter passes through the neighborhood of the developing roller 51. Then, the supplying sheet 521 is extended to a surface in the neighborhood of the fixing portion 521a and thereafter is folded back in a folding-back portion and extended to the holding shaft 522, and is bonded to the holding shaft 522 in the bonding portion 521b. Further, the supplying sheet 521 is bonded to the surface thereof in the neighborhood of the fixing end portion 521a in an adhesive portion (third portion) 521e provided in the above-described fold-back portion. Thus, in the adhesive portion 521e, a part and another part of the supplying sheet 521 are bonded (i.e., these parts of the supplying member are fixed together), so that a fulling region 53e which is a space enclosed by the supplying sheet 521 is formed. Further, the toner T is filled in thisi. By this, in a sealing portion 521d where the supplying sheet 521 is doubled by being folded back between the adhesive portion 521e and the holding shaft 522, the toner can be sealed in the developing container 53.

Here, adhesive strength between the part and another part of the supplying sheet 521 (i.e., between sheets) in the adhesive portion 521e is set weaker than adhesive strength between the supplying sheet 521 and the inner wall of the developing container 53 in the fixing portion 521a. Therefore, in the initial setting control of the developing unit 50, the supplying sheet 521 is wound up by the holding shaft 522 by rotating the holding shaft 522 in the arrow R7a direction, whereby the adhesive portion 521e can be peeled (fixing can be released). Thereafter, of the supplying sheet 521, a portion used as the sealing portion 521d is wound up by the holding shaft 522, whereby the toner is capable of being supplied to the developing roller 51 as shown in part (b) of FIG. 36. For example, the controller 150 is capable of detecting that the developing unit 50 is in a non-use state (new article), on the basis of use history information or the like stored in the storing portion (a memory (not shown) or the like mounted to the developing unit 50). Then, in the case where the controller 150 detects that the developing unit 50 is in the non-use state (new article), the controller 150 is capable of carrying out control so as to execute the initial setting control.

Thus, a constitution in which before the use of the developing device 50, two parts of the supplying member 521 are fixed together in the third portion (adhesive portion) 521e between the first portion (fixing portion) 521a and the second portion 521b with respect to the second direction (direction crossing the rotational axis direction of the developer carrying member 51) and the toner is accommodated in the region enclosed by the supplying member 521 and in which when the use of the developing device 50 is started, the controller controls the driving portion 176 so that the toner accommodated in the above-described enclosed region is capable of being supplied to the developer carrying member 51 by releasing the fixing in the third portion 521e by winding-up of the supplying member 521 with the holding member 522 may be employed.

Even in such a constitution, it is possible to control the supplying mechanism 52 so as to urge the toner toward the surface of the developing roller 51 during the developing period. For that reason, a member for sealing the toner and a member for supplying the toner to the developing roller 51 can be realized by a single member.

### Further Another Example of Developing Unit in Accordance with this Embodiment

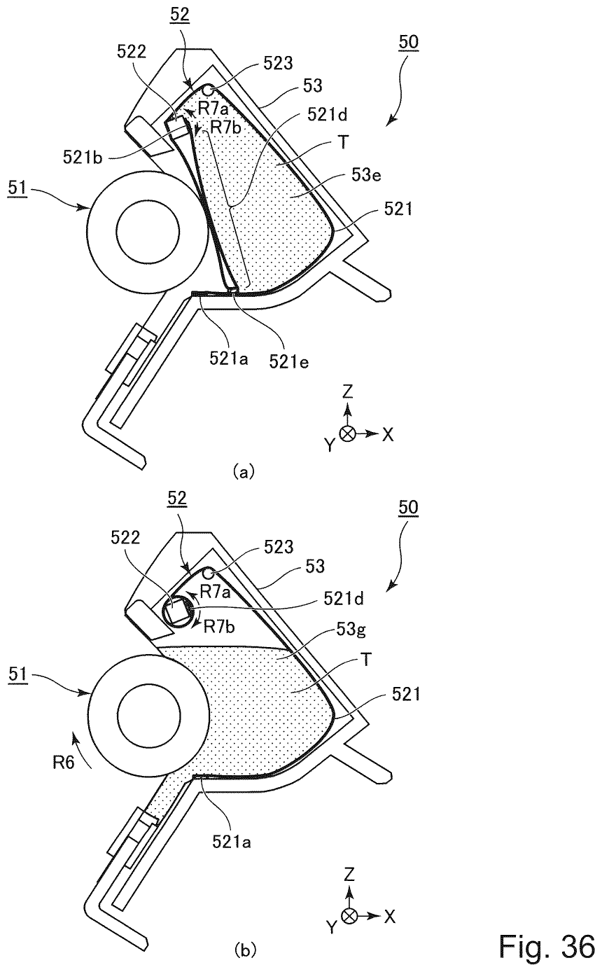

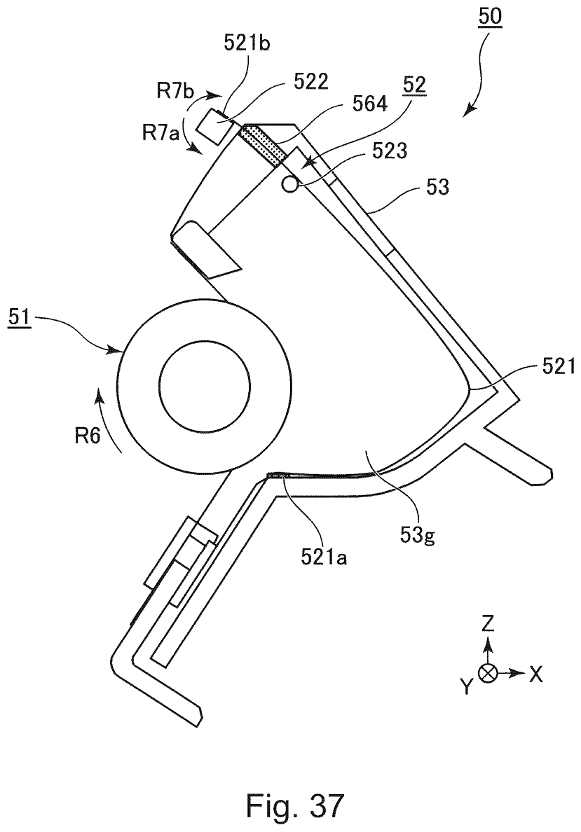

FIG. 37 is a schematic sectional view of a further another example of the developing unit 50 in this embodiment. As shown in FIG. 37, a holding shaft 522 may be provided outside a developing container 53. In that case, the developing container 53 is provided with a sealing valve 564, and the supplying sheet 521 may be nipped by this sealing valve 564. By this, it is possible to suppress that the toner in the developing container 53 is leaked out to an outside of the developing container 53. By such a constitution, an inside space of the developing container 53 becomes wide correspondingly to a volume occupied by the holding shaft 522, so that the toner can be filled in a large amount.

### Embodiment 5

Next, another embodiment of the present disclosure will be described. In the embodiments 1 to 4, the constitution in which the supplying mechanism 52 provided with the flexible supplying sheet 521 as the supplying portion was described. On the other hand, the developing unit 50 may have a constitution provided with a supplying member having predetermined rigidity such that the supplying member is not deformed substantially during an operation.

Part (a) of FIG. 38 is a schematic sectional view of an example of a developing unit 50 in this embodiment, and part (b) of FIG. 38 is a schematic sectional view of another example of the developing unit 50 in this embodiment. The developing unit 50 shown in each of parts (a) and (b) of FIG. 38 includes a supplying plate 524. The supplying plate 524 has the rigidity such that the supplying plate 524 is not deformed substantially during the operation. In this embodiment, the supplying plate 524 is constituted by a plate-like member formed of a polystyrene resin. However, a material of the supplying plate 524 is not limited, but may also be another resin material, a metal material such as SUS, or the like. The supplying plate 524 is disposed so that a longitudinal direction thereof extends along the Y axis direction. A length of the supplying plate 524 in the longitudinal direction is set to a length over a substantially entire area of a region inside the developing container 53 with respect to the Y axis direction.

The supplying plate 524 is swingably supported by the developing container 53 in a swing shaft 5241 extending in the Y axis direction provided in one end portion with respect to a widthwise direction substantially perpendicular to the longitudinal direction thereof. In this embodiment, the supplying plate 524 is disposed swingably in an arrow R11a direction and an arrow R11b direction about the swing shaft 5241 supported by the developing container 53. Here, in a constitution shown in part (a) of FIG. 38, the swing shaft 5241 is provided in an end portion of the supplying plate 524 on a lower side with respect to the vertical direction (Z axis negative side). On the other hand, in a constitution shown in part (b) of FIG. 38, the swing shaft 5241 is provided in an end portion of the supplying plate 524 on an upper side with respect to the vertical direction (Z axis positive side). Incidentally, in each of the figures, the arrow R11a direction shows a movement direction in which at least a part of the supplying plate 524 approaches the surface of the developing roller 51. Further, in each of the figures, the arrow R11b direction shows a movement direction in which at least a part of the supplying plate 524 is separated from the surface of the developing roller 51.

Further, in the constitution shown in part (a) of FIG. 38, inside the developing container 53, an urging shaft 576 as a moving member contactable to the supplying plate 524. This urging shaft 576 is a cam member having a constitution similar to the constitution of the urging shaft 574 described using FIG. 26. However, in the constitution shown in part (a) of FIG. 38, the urging shaft 576 is inverted horizontally (left and right in the XZ plane relative to the urging shaft 574 described using FIG. 26. This urging shaft 576 is rotatable in an arrow R12 direction (clockwise direction) about a rotation shaft 576C extending in the Y axis direction by transmitting a driving force by an urging shaft driving gear (not shown). The urging shaft 576 is rotated in the arrow R12 direction, so that the supplying plate 524 is gradually swung (rotated) in the arrow R11a direction. Further, the supplying plate 524 is brought near to the surface of the developing roller 51 as indicated by a chain double-dashed line in the figure and thereafter the urging shaft 576 is rotated in the arrow R12 direction so that the supplying plate 524 is in a state in which the supplying plate 524 is temporarily separated from the urging shaft 576. Further, by gravitation acting in the Z axis negative direction, the supplying plate 524 is swung (rotated) in the arrow R11b.

On the other hand, in the constitution shown in part (b) of FIG. 38, in the developing unit 50, an urging spring (not shown) as an urging member for urging the supplying plate 524 in the arrow R11b direction. Further, inside the developing container 53, an urging shaft 577 as a moving member contactable to the supplying plate 524. This urging shaft 577 is a cam member having a constitution similar to the constitution of the suspension shaft 523 described using FIG. 30. This urging shaft 577 is rotatable in an arrow R12 direction (clockwise direction) about a rotation shaft 577C extending in the Y axis direction by transmitting a driving force by an urging shaft driving gear (not shown). The urging shaft 577 is rotated in the arrow R13 direction, so that the supplying plate 524 is gradually swung (rotated) in the arrow R11a direction. Further, the supplying plate 524 is brought near to the surface of the developing roller 51 as indicated by a chain double-dashed line in the figure and thereafter the urging shaft 576 is rotated in the arrow R13 direction so that the supplying plate 524 urged by the urging spring is swung (rotated) in the arrow R11b.

Thus, the driving portion includes the moving member 756 (or 577) disposed inside the developing container 53 so as to be contactable to the supplying member 521, and the moving member 756 (or 577) is operated so as to be contacted to the supplying member 524, whereby the state of the supplying member 524 may also be capable of being changed to the first state and the second state.

Even in such a constitution, the supplying plate 524 can be controlled so that the toner is urged toward the surface of the developing roller 51 during the developing period. In the constitutions of parts (a) and (b) of FIG. 38, the supplying plate 524 comes and goes between a state (first state, supplying plate first position) indicated by a solid line in the figures and a state (second state, supplying plate second position) indicated by a chain double-dashed line in the figures. By this, the toner in the supplying region 53g can be urged toward the surface of the developing roller 51.

Incidentally, also in the constitution shown in part (a) of FIG. 38, similarly as in the constitution shown in part (b) of FIG. 38, an urging member for urging the supplying plate 524 in the arrow R11b direction.

Further, the supplying plate 524 is provided with a bent portion 524a bent so as to be projected toward a side opposite from the developing roller 51. By this, a surface of the supplying plate 524 has a shape following a peripheral surface of the developing roller 51, so that the toner in the supplying region 53g becomes easy to be urged toward the developing roller 51. Incidentally, the supplying plate 524 may also be provided in a plurality of positions. Further, the supplying plate 524 may have a shape bent so as to form an arc which is convex on a side opposite from the surface of the developing roller 51.

Further, in the constitution shown in part (a) of FIG. 38, a rotation preventing projection 536 is provided on an inner wall of the developing container 53 on each of opposite sides with respect to the Y axis direction. This rotation preventing projection 536 is disposed so as to be contactable to the supplying plate 524, so that the supplying plate 524 is prevented from unintentionally falling toward the developing roller 51 side.

Further, there is no need to provide a hole portion to the supplying plate 524 in this embodiment. The supplying plate 524 has a constitution in which the toner in the supplying region 53g is urged toward the surface of the developing roller 51. For that reason, in the case where the supplying plate 524 is provided with the hole portion, the toner in the supplying region 53g passes through the hole portion toward the rear surface-side region 53d. Accordingly, it is desirable that the supplying plate 524 is not provided with the hole portion. However, if the toner can be sufficiently urged toward the surface of the developing roller 51, the supplying plate 524 may be provided with a slit or the like.

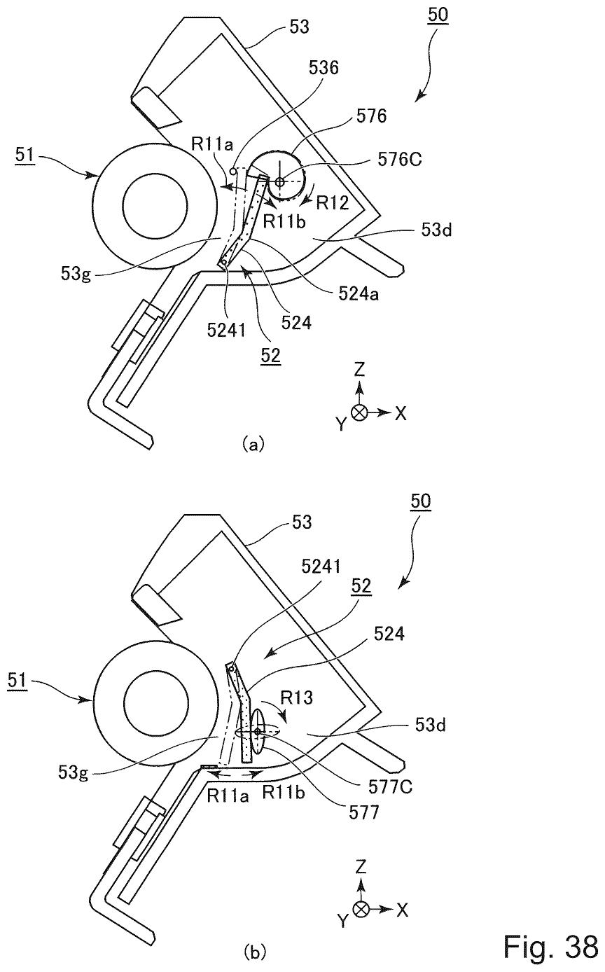

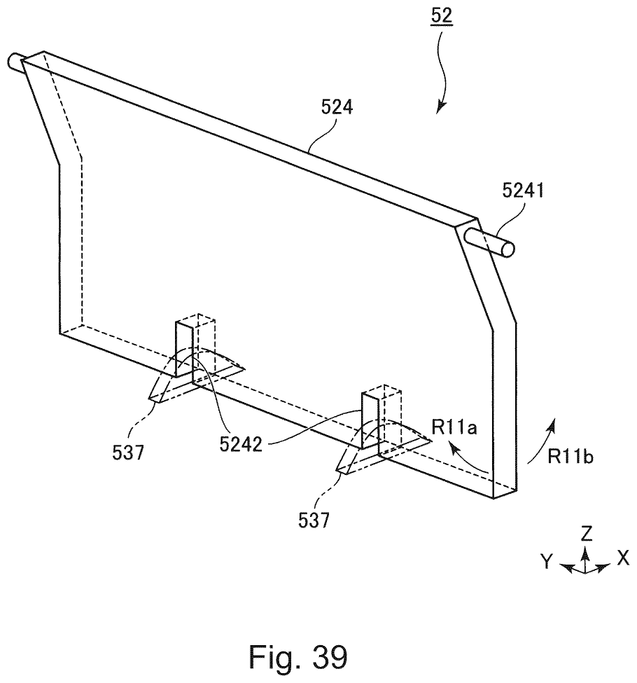

FIG. 39 is a schematic perspective view of another example of a swing (supplying) plate 524. This swing plate 524 is provided with a swing shaft 5241 in an end portion thereof on an upper side with respect to the vertical direction (Z axis positive side) similarly as in the constitution shown in part (b) of FIG. 38. Further, this supplying plate 524 is provided with positioning slits in an end portion thereof on a lower side with respect to the vertical direction (Z axis negative side). In this case, the developing container 53 is provided with positioning projected portions 537 engageable with the positioning slits 5242 of the swing (supplying) plate 524. Further, by the positioning projected portions 537 and the associated positioning slits 5242, a position of the supplying plate 524 with respect to the Y axis direction is defined. Even in such a constitution, the supplying plate 524 is swung in the arrow R11a direction, whereby the toner can be urged toward the surface of the developing roller 51.

Further, as the urging shafts 576 and 577, the paddle-like urging shaft as shown in FIG. 23 may be used. Further, as a means for urging the supplying plate 524, the actuator or the balloon-like member as described in the embodiment 3 may be used.

Thus, the supplying plate 524 is controlled so as to urge the toner toward the surface of the developing roller 51 during the developing period, whereby the toner can be stably supplied to the developing roller 51, so that it is possible to suppress an occurrence of the image defect such as the white void or the density non-uniformity. Further, in the case where a long-term use of the developing unit 50 is assumed, compared with the case where the supplying sheet 521 is used, in the case where the supplying plate 524 is used, it can be expected that a performance can be maintained for a longer term.

### Embodiment 6

Next, another embodiment of the present disclosure will be described. In this embodiment, the case where the present disclosure is applied to an image forming apparatus 1 (image forming apparatus 1 using a developing unit 50 of a scooping type) having a basic constitution different from the basic constitution of the image forming apparatus 1 in the embodiment 1 will be described.

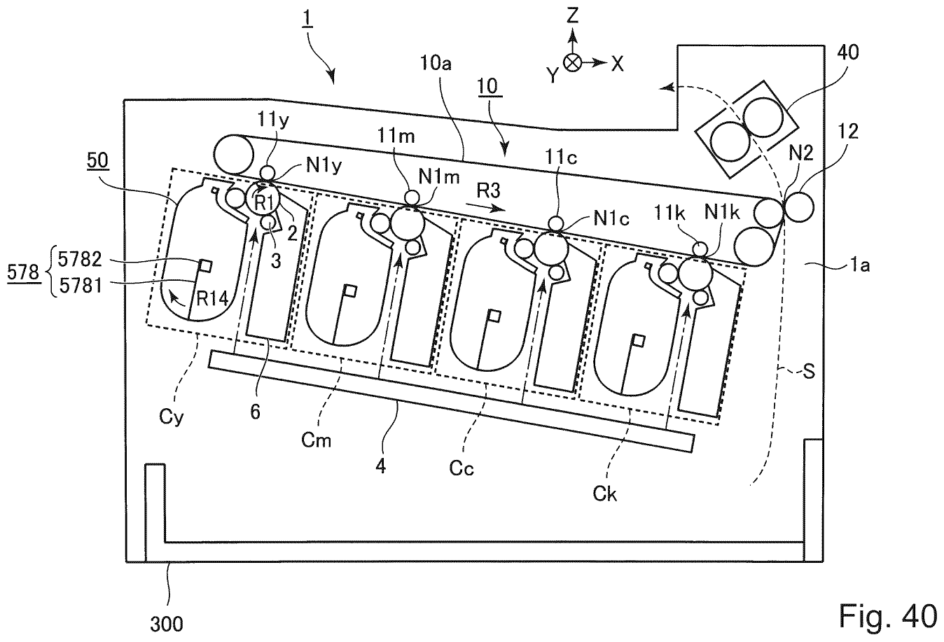

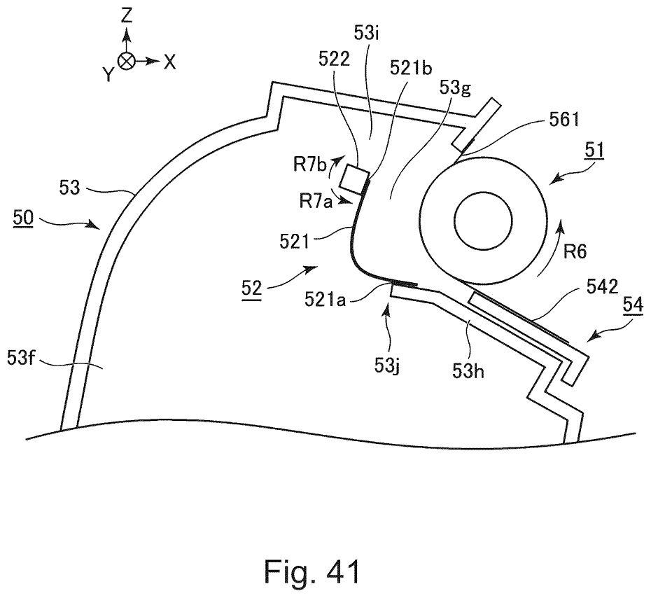

FIG. 40 is a schematic sectional view of another example of the image forming apparatus 1 in which the developing unit 50 of the scooping type. Further, FIG. 41 is a schematic sectional view of the developing unit 50 of the scooping type, in which a part thereof is enlarged.

The image forming apparatus 1 shown in FIG. 40 is a tandem-type color laser printer which is capable of forming a full-color image on a sheet S by using an electrophotographic type, which employs an intermediary transfer type, and which uses the developing unit 50 of the scooping type. This image forming apparatus 1 includes a plurality of process cartridges Cy, Cm, Cc, and Ck, a scanner 4, an intermediary transfer unit 10, a secondary transfer roller 12, a fixing device 40, and the like. Each of the process cartridges Cy, Cm, Cc, and Ck includes a photosensitive drum 2, a charging roller 3, a developing unit 50, and a photosensitive drum cleaning unit 6. The process cartridges Cy, Cm, Cc, and Ck are integrally detachably mountable to an image forming apparatus main assembly 1a. The process cartridges Cy, Cm, Cc, and Ck have the substantially same constitution except that colors of toner accommodated in the associated developing units 50 are different from each other. In the developing units 50 of the process cartridges Cy, Cm, Cc, and Ck for the colors of yellow, magenta, cyan, and black, respectively, the toner of yellow, the toner of magenta, the toner of cyan, and the toner of black are accommodated, respectively. The intermediary transfer unit 10 includes an intermediary transfer belt 10a, primary transfer rollers 11y, 11m, 11c, and 11k provided correspondingly to the associated photosensitive drums 2, respectively, and the like. The primary transfer rollers 11y, 11m, 11c, and 11k from primary transfer nips N1y, N1m, N1c, and N1k, respectively. Further, the secondary transfer roller 12 forms a secondary transfer nip N2.

As shown in FIGS. 40 and 41, in this embodiment, inside the developing container 53 of the developing unit 50, a toner chamber 53f which is a space on the lower side with respect to the vertical direction (Z axis negative side) and the supplying region 53g which is a space on the upper side with respect to the vertical direction (Z axis positive side) are formed. Further, the toner is accommodated in the toner chamber 53f, and the toner is supplied form this toner chamber (first chamber) 53f toward the supplying region (second chamber) 53g in a scooping manner. Thus, the developing unit 50 in this embodiment is a developing unit 50 of the scooping type.

Inside the toner chamber 53f, a stirring member 578 is provided. The stirring member 578 is constituted by including a stirring sheet 5781 having flexibility and contacting the inner wall of the developing container 53 forming the toner chamber 53f and including a stirring shaft 5782 rotatable in an arrow R14 direction (clockwise direction). The toner chamber 53f and the supplying region 53g are partitioned by a partitioning portion 53j. In this embodiment, the partitioning portion 53j is constituted by a partition wall portion 53h constituted by a part of the developing container 53 and a supplying mechanism 52. That is, in this embodiment, the supplying mechanism 52 is such that a fixing portion 521a of the supplying sheet 521 is fixed to the partition wall portion 53h and that a bonding portion 521b is bonded to a holding shaft 522. Further, the toner chamber 53f and the supplying region 53g communicate with each other through a communicating portion 53i formed by the holding shaft 522 and the inner wall of the developing container 53. The stirring member 578 is rotated in the arrow R14 direction, whereby the toner in the toner chamber 53f is raised (jumped up) by the stirring sheet 5781, so that the toner is conveyed toward the supplying region 53g through the communicating portion 53i. The supplying mechanism 52 in this embodiment has a constitution similar to the constitution of the supplying mechanism 52 in the embodiment 1. By rotating the holding shaft 522 in the arrow R7a direction, whereby the toner existing in the supplying region 53g can be urged toward the surface of the developing roller 51.

By such a constitution, in the developing unit 50 of the scooping type, with a relatively simple constitution, the toner existing in the supplying region 53g can be urged toward the surface of the developing roller 51. Accordingly, the toner can be stably supplied to the developing roller 51, so that it is possible to suppress the occurrence of the image defect such as the white void or the density non-uniformity.

Incidentally, in this embodiment, a timing when the toner is conveyed from the toner chamber 53f to the supplying region 53g by the stirring member 578 may be set to a timing other than the developing period. By this, a possibility of the occurrence of the density non-uniformity can be further reduced.

### Other Embodiments

In the above, the present disclosure was described in accordance with specific embodiments, but the present disclosure is not limited to the above-described embodiments.

The supplying roller used in the developing device once takes the toner in the sponge layer, and the sponge layer discharges the inside toner by being compressed in the contact portion with the developing roller and thus supplies the toner to the developing roller. On the other hand, in many instances the supplying roller also has a function of scraping off the toner carried on the surface of the developing roller by a cell wall surface forming the sponge layer thereof. Thus, by scraping off the toner carried on the surface of the developing roller, it is possible to suppress charge-up or the like caused by repetitive frictional slide of the toner, carried on the surface of the developing roller, with the regulating member. To the developing units described in the above-described embodiments, a means for scraping off the toner from the developing roller can be provided as desired. Based on the above-described embodiments, for example, the following constitution can be employed. With respect to the rotational direction of the developing roller 51, on a side downstream of a contact portion between the sealing sheet 561 and the developing roller 51 and upstream of a contact portion between the regulating blade 54 and the developing roller 51, a scraping member for scraping off the toner from the developing roller 51 in contact with the developing roller 51 can be contacted. Such a scraping member may only be provided so as to appropriately perform the supply of the toner toward the developing roller 51 described in the above-described embodiments. Further, conventionally, various techniques for removing the toner from the developer carrying member in the developing device using, for example, magnetic toner have been proposed. In the case of the developing device using the magnetic toner, a constitution in which the toner is supplied to the developer carrying member by using a magnetic force is employed, and therefore, the supplying roller provided to the developing device using the magnetic toner is not required. It can be said that of means for removing the toner on the developer carrying member in such a developing device using the magnetic toner, the means capable of being applied for removing the magnetic toner from the developing roller is suitable for use in the developing units described in the above-described embodiments. For that reason, in the developing units described in the above-described embodiments, such a means may also be appropriately selected and used.

According to the present disclosure, it becomes possible to supply the toner stably to the surface of the developer carrying member without providing the supplying roller to the developing device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-224599, filed on Dec. 19, 2024, which is hereby incorporated by reference herein in its entirety.

What is claimed is:

1. An image forming apparatus comprising:
a rotatable image bearing member configured to bear a toner image;
a developing device configured to form the toner image on a surface of the image bearing member, the developing device including a developing container for accommodating toner and including a rotatable developer carrying member which forms a developing portion in contact with the surface of the image bearing member and which is for conveying the toner, accommodated in the developing container, toward the image bearing member while carrying the toner;
a supplying mechanism including a supplying member which is changeable in state between a first state and a second state in which at least a part of the supplying member is closer to the surface of the developer carrying member than in the first state and which urges the toner, accommodated in the developing container, toward the surface of the developer carrying member by being changed from the first state to the second state;
a driving portion capable of operating the supplying mechanism so as to change the state of the supplying member to the first state and the second state; and
a controller configured to control the driving portion,
wherein a timing when a leading end of an image forming region, in which a toner image for one page is formable, on the image bearing member with respect to a rotational direction of the image bearing member reaches the developing portion is defined as a first timing,
a timing having a predetermined relationship with a timing when a trailing end of the image forming region with respect to the rotational direction of the image bearing member finishes passing through the developing portion is defined as a second timing, and
a period between the first timing and the second timing is defined as a predetermined period, and
wherein the controller controls the driving portion
so that an operation of the supplying mechanism for changing the state of the supplying member in a direction from the first state toward the second state in at least a part of a period of the predetermined period is performed, and
so that the operation of the supplying mechanism for changing the state of the supplying member in a direction from the second state toward the first state in the predetermined period is not performed.

2. The image forming apparatus according to claim 1, wherein the second timing is the timing when the trailing end of the image forming region with respect to the rotational direction finishes passing through the developing portion.

3. The image forming apparatus according to claim 1, wherein the developing device includes a regulating member which forms a contact portion in contact with the surface of the image bearing member and which is for regulating an amount of the toner carried on the developer carrying member, and
wherein the second timing is a timing before the timing when the trailing end of the image forming region with respect to the rotational direction finishes passing through the developing portion, by a time taken for movement of the surface of the image bearing member from the contact portion to the developing portion.

4. The image forming apparatus according to claim 1, wherein the image forming region is defined as a first image forming region,
the predetermined period is defined as a first period, and
a period between the first timing and the second timing for a second image forming region, in which a toner image for one page subsequent to the first image forming region is capable of being formed, on the image bearing member is defined as a second period, and
wherein the controller controls the driving portion so that an operation of the supplying mechanism for changing the state of the supplying member from the second state toward the first state after the first period and before the second period.

5. The image forming apparatus according to claim 1, wherein the supplying member is constituted by a flexible sheet which is provided so that a first direction thereof extends along a rotational axis direction of the developer carrying member and which is held in a first portion thereof on one end portion side thereof and a second portion thereof on the other end portion side thereof with respect to a second direction crossing the first direction,
wherein the supplying mechanism includes a holding member holding the second portion of the supplying member and rotatable about a rotational axis along the first direction, and
wherein the driving portion is capable of changing the state of the supplying member to the first state and the second state by rotating the holding member.

6. The image forming apparatus according to claim 5, wherein before use of the developing device is started, the supplying member is partially fixed in a third portion between the first portion and the second portion with respect to the second direction, and the toner is accommodated in a region enclosed by the supplying member, and
wherein the controller controls the driving portion so that the toner accommodated in the region enclosed by the supplying member is capable of being supplied to the developer carrying member by releasing fixing of the supplying member in the third portion by winding up the supplying member with the holding member when the use of the developing device is started.

7. The image forming apparatus according to claim 1, wherein the supplying member is constituted by a flexible sheet which is provided so that a first direction thereof extends along a rotational axis direction of the developer carrying member and which is held in a first portion thereof on one end portion side thereof and a second portion thereof on the other end portion side thereof with respect to a second direction crossing the first direction,
wherein the supplying mechanism includes a holding member holding the second portion of the supplying member and slidable along a direction crossing the first direction, and
wherein the driving portion is capable of changing the state of the supplying member to the first state and the second state by sliding the holding member.

8. The image forming apparatus according to claim 5, wherein the supplying mechanism includes a supporting member for supporting the supplying member between the first portion and the second portion with respect to the second direction.

9. The image forming apparatus according to claim 1, wherein the supplying member is constituted by a flexible sheet which is provided so that a first direction thereof extends along a rotational axis direction of the developer carrying member and which is held in a first portion thereof on one end portion side thereof and a second portion thereof on the other end portion side thereof with respect to a second direction crossing the first direction,
wherein the supplying mechanism includes an operable supporting member for supporting the supplying member between the first portion and the second portion with respect to the second direction, and
wherein the driving portion is capable of changing the state of the supplying member to the first state and the second state by operating the supporting member.

10. The image forming apparatus according to claim 9, wherein the supporting member is rotatable about a rotational axis along the first direction or is slidable along a direction crossing the first direction.

11. The image forming apparatus according to claim 5, wherein the supplying member is changeable in state to the first state in which the supplying member has flexure with respect to the second direction and the second state in which a degree of the flexure is smaller than in the first state.

12. The image forming apparatus according to claim 1, wherein the driving portion includes a movable member provided so as to be contactable to the supplying member inside the developing container, and
wherein the driving portion is capable of changing the state of the supplying member to the first state and the second state by operating the movable member so as to be contacted to the supplying member.

13. The image forming apparatus according to claim 1, wherein by the supplying member, a first region in which the developer carrying member is accommodated and a second region in which the developer carrying member is not accommodated are formed inside the developing container, and
wherein the image forming apparatus comprises moving means configured to enable movement of the toner between the first region and the second region.

14. The image forming apparatus according to claim 13, further comprising a rotary capable of rotating the developing device, and
wherein the moving means enables the movement of the toner between the first region and the second region by rotating the rotary.

15. A developing device comprising:
a developing container configured to accommodate toner;
a rotatable developer carrying member configured to carry the toner accommodated in the developing container;
a flexible sheet which is provided so that a first direction thereof extends along a rotational axis direction of the developer carrying member and which is held in a first portion thereof on one end portion side thereof and a second portion thereof on the other end portion side thereof with respect to a second direction crossing the first direction; and
a holding member configured to hold the second portion of the sheet and rotatable about a rotational axis along the first direction,
wherein the sheet is changeable in state between a first state and a second state in which at least a part thereof is closer to the surface of the developer carrying member than in the first state by rotation of the holding member, and
wherein the sheet urges the toner, accommodated in the developing container, toward the surface of the developer carrying member by being changed in state from the first state to the second state.

16. The developing device according to claim 15, wherein before use of the developing device is started, the sheet is partially fixed in a third portion between the first portion and the second portion with respect to the second direction, and the toner is accommodated in a region enclosed by the sheet, and
wherein the toner accommodated in the region enclosed by the sheet is capable of being supplied to the developer carrying member by releasing fixing of the sheet in the third portion by winding up the sheet with the holding member when the use of the developing device is started.

17. A developing device comprising:
a developing container configured to accommodate toner;
a rotatable developer carrying member configured to carry the toner accommodated in the developing container;
a flexible sheet which is provided so that a first direction thereof extends along a rotational axis direction of the developer carrying member and which is held in a first portion thereof on one end portion side thereof and a second portion thereof on the other end portion side thereof with respect to a second direction crossing the first direction; and
a holding member configured to hold the second portion of the sheet and slidable along a direction crossing the first direction,
wherein the sheet is changeable in state between a first state and a second state in which at least a part thereof is closer to the surface of the developer carrying member than in the first state by sliding of the holding member, and
wherein the sheet urges the toner, accommodated in the developing container, toward the surface of the developer carrying member by being changed in state from the first state to the second state.

18. The developing device according to claim 15, further comprising a supporting member configured to support the sheet between the first portion and the second portion with respect to the second direction.

19. The developing device according to claim 17, further comprising a supporting member configured to support the sheet between the first portion and the second portion with respect to the second direction.

20. A developing device comprising:
a developing container configured to accommodate toner;
a rotatable developer carrying member configured to carry the toner accommodated in the developing container;
a flexible sheet which is provided so that a first direction thereof extends along a rotational axis direction of the developer carrying member and which is held in a first portion thereof on one end portion side thereof and a second portion thereof on thereof with respect to a second direction crossing the first direction; and
an operable supporting member configured to support the sheet between the first portion and the second portion with respect to the second direction,
wherein the sheet is changeable in state between a first state and a second state in which at least a part thereof is closer to the surface of the developer carrying member than in the first state by operation of the supporting member, and
wherein the sheet urges the toner, accommodated in the developing container, toward the surface of the developer carrying member by being changed in state from the first state to the second state.

21. The developing device according to claim 20, wherein the supporting member is rotatable about a rotational axis along the first direction or is slidable along a direction crossing the first direction.

22. The developing device according to claim 15, wherein the sheet is changeable in state to the first state in which the sheet has flexure with respect to the second direction and the second state in which a degree of the flexure is smaller than in the first state.

23. The developing device according to claim 17, wherein the sheet is changeable in state to the first state in which the sheet has flexure with respect to the second direction and the second state in which a degree of the flexure is smaller than in the first state.

24. The developing device according to claim 20, wherein the sheet is changeable in state to the first state in which the sheet has flexure with respect to the second direction and the second state in which a degree of the flexure is smaller than in the first state.

25. A developing device comprising:
a developing container configured to accommodate toner;
a rotatable developer carrying member configured to carry the toner accommodated in the developing container;
a supplying member capable of urging the toner, accommodated in the developing container, toward a surface of the developer carrying member; and
a movable member provided so as to be contactable to the supplying member inside the developing container,
wherein the supplying member is changeable in state between a first state and a second state in which at least a part thereof is closer to the surface of the developer carrying member than in the first state by contact of the movable member, and
wherein the supplying member urges the toner, accommodated in the developing container, toward the surface of the developer carrying member by being changed in state from the first state to the second state.
